(19) United States
(12) Patent Application Publication
(10) Pub. No.: US 2025/0250394 A1
(43) Pub. Date: Aug. 7, 2025

(54) DIELECTRIC POLYMER MATERIALS WITH COLORATION AND DEVICES USING THEM

(71) Applicant: Flexterra, Inc., Skokie, IL (US)

(72) Inventors: Shaofeng Lu, Skokie, IL (US); Antonio Facchetti, Skokie, IL (US); Zhihua Chen, Skokie, IL (US); Yu Xia, Skokie, IL (US); Mark Seger, Skokie, IL (US); Shiuan-Iou Lin, Zhubei City (TW); Jing-Yun Chen, Zhubei City (TW); Liang-Je Lai, Zhubei City (TW); Hsiu-Chun Wu, Zhubei City (TW)

(21) Appl. No.: 18/686,478

(22) PCT Filed: Apr. 21, 2022
(86) PCT No.: PCT/US2022/025837

§ 371 Date: Feb. 26, 2024

Related U.S. Application Data
(60) Provisional application No. 63/238,378, filed on Aug. 30, 2021.

(51) Int. Cl. C08G 75/23; C08J 5/18; C08K 5/00; G02F 1/1333

(52) U.S. Cl. CPC C08G 75/23; C08J 5/18; C08K 5/0041; G02F 1/133305; C08J 2381/06

(57) ABSTRACT

The present disclosure relates generally to colored dielectric polymer materials, methods of making them and uses thereof. In particular, the application concerns a colored dielectric polymer material comprising a crosslinked polymer and a dye dispersed in the crosslinked polymer.

### CROSS-REFERENCE TO RELATED APPLICATIONS

This application claims the benefit of priority of U.S. Provisional Application No. 63/238,378, filed Aug. 30, 2021, and incorporated herein by reference in its entirety.

### BACKGROUND OF THE DISCLOSURE

### Field

The present disclosure relates to colored dielectric polymer materials, specifically to dielectric polymer materials having dyes therein, and films thereof, and associated devices and methods of making.

### Technical Background

Development of the next generation of electronic devices is based on organic materials, flexible substrates and low-cost solution processing. An important material component in many organic electronic devices is a polymeric dielectric material. Such materials can serve a variety of purposes in devices, for example, as the gate insulator material in a thin-film transistor or to isolate two electrical contacts in capacitors and in display pixel elements. The polymer dielectric layer can be formed on either the gate contact (for bottom-gate transistor structures) or the semiconductor layer (for top-gate transistor structures) by depositing a solution of an electrically insulating (i.e., dielectric) polymer via solution phase process such as spin-coating or printing. To create a robust, insoluble dielectric material, a crosslinking step usually is required. Crosslinked dielectric films can be prepared, for example, by irradiation, chemical initiators, thermal treatment or combination thereof.

Liquid crystal displays of different types have different specific needs for the materials providing the coloration of the pixels. However, they typically require the use of colored films (e.g., nominally colored red, yellow, blue, green or black) located in the proximity of layers of liquid crystal cells. Further, conventional fabrication protocols of LCD elements require harsh deposition and annealing conditions that can degrade organic materials and particularly those providing the coloration (dyes).

Colored dielectric films (e.g., colored red, yellow, blue, green, or black) are widely used as color films in various active-matrix pixel devices that are used to display images. These devices typically include an electronic component, the active matrix transistor, and a light source component, which could be part of the device or instead could originate from elsewhere (e.g., as ambient light). Light manipulation in each pixel for defining the image can be carried out using any of a variety of types of transmissive or reflective-type light technologies such as electrophoretic (EP), electrowetting (EW) liquid crystal (LC), and inorganic or organic light emitting diode (LED). A variety of transistor pixel control units are suitable for use, such as vapor-phase processed amorphous/polysilicon silicon transistors (a-/psSi TFTs), vapor-phase processed indium-gallium-zinc oxide (IGZO) transistors (IGZO-TFTs), or solution-processed organic transistors (OTFTs). The transistor pixel control units and the solution-processed color films are usually fabricated in separated steps, often on different substrates, due to issues with process incompatibility, such as poor resistance of the colored film materials to photolithographic steps needed to define the different components and colorfastness of colored film materials to the deposition of conducting oxide layers.

Additional improvements in colored materials are necessary to enable advances in color display technologies.

### SUMMARY

The inventors have determined that crosslinking of dielectric polymers with organic dyes in situ can provide especial benefits, especially with respect to color stability during further device processing, e.g., during deposition of the transparent indium-tin oxide films typically used in such devices. The present inventors have developed synthesis methods that enable the introduction of dye molecules into such crosslinked polymers. Advantageously, such materials can be formed into thin films while maintaining excellent dielectric and coloration properties, enabling the construction of next generation displays, especially when in contact with indium-tin oxide films.

Accordingly, in one aspect, the present disclosure provides a colored dielectric polymer material comprising a crosslinked polymer and a dye dispersed in the crosslinked polymer. The crosslinked polymer comprises a crosslinking product of crosslinkable composition including a first polymer having bis(phenylene)sulfone residues and/or bisphenol A residues.

In various desirable aspects of the disclosure, the colored dielectric polymer material is in contact with a transparent conducting oxide film, such as an indium-tin oxide film.

In various desirable aspects of the disclosure, the crosslinked polymer comprises a crosslinking product of crosslinkable composition including a first polymer of one or more of structures (I), (II), and (III), each having bis(phenylene)sulfone residues and/or bisphenol A residues.

For example, in various embodiments of the disclosure, the first polymer comprises bis(phenylene)sulfone residues, e.g., has repeating units of structural formula (I)

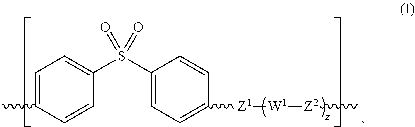

wherein
z is 0 or 1;
each W¹ is independently —Ar[—Y—Ar]_{q}—, wherein:
   Ar, at each occurrence, is independently a divalent C₆₋₁₈ arylene group;
   Y, at each occurrence, is independently selected from the group consisting of —O—, —S—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
   q is selected from the group consisting of 0, 1, 2, 3, 4, 5, 6, 7, 8, 9 and 10; and
each Z¹ and Z² is independently selected from the group consisting of —O—, —S—, —Se—, —NR⁴—, —C(O)O—, —OC(O)—, NR⁴—C(O)—, —C(O)—NR⁴—, O—(CHR⁵CHR⁵—O)ₐ—, and —O—CHR⁵CHR⁵—Si(R⁶)₂—CHR⁵CHR⁵—O—, wherein a is 1-5 and each R⁴, R⁵, and R⁶ is independently H or methyl,
   wherein the first polymer has a weight-average molecular weight (M_{w}) ranging from about 1,000 to about 200,000.

In various embodiments of the disclosure, the first polymer comprises bisphenol A residues, e.g., has repeating units of structural formula (II)

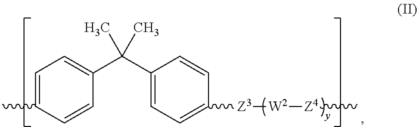

wherein
y is 0 or 1;
each W² is independently —Ar[—Y—Ar]_{q}—, wherein:
   Ar, at each occurrence, is independently a divalent C₆₋₁₈ arylene group;
   Y, at each occurrence, is independently selected from the group consisting of —O—, —S—, —S(O)₂—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
   q is selected from the group consisting of 0, 1, 2, 3, 4, 5, 6, 7, 8, 9 and 10; and
each Z³ and Z⁴ is independently selected from the group consisting of —O—, —S—, —Se—, —NR⁴—, —C(O)O—, —OC(O)—, NR⁴—C(O)—, —C(O)—NR⁴—, O—(CHR⁵CHR⁵—O)ₐ—, and —O—CHR⁵CHR⁵—Si(R⁶)₂—CHR⁵CHR⁵—O—, wherein a is 1-5 and each R⁴, R⁵, and R⁶ is independently H or methyl,
   wherein the first polymer has a weight-average molecular weight (M_{w}) ranging from about 1,000 to about 200,000.

In various embodiments of the disclosure, the first polymer has repeating units comprising bis(phenylene)sulfone residues and/or bisphenol A residues, e.g., has structural formula (III)

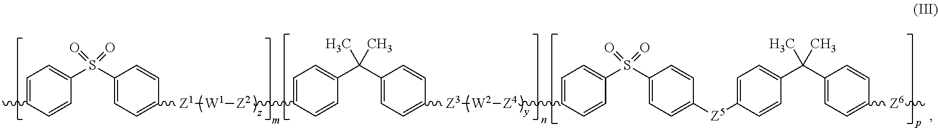

wherein
z is 0 or 1;
each W¹ is independently —Ar[—Y—Ar]_{q}—, wherein:
   Ar, at each occurrence, is independently a divalent C₆₋₁₈ arylene group;
   Y, at each occurrence, is independently selected from the group consisting of —O—, —S—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
   q is selected from the group consisting of 0, 1, 2, 3, 4, 5, 6, 7, 8, 9 and 10; and
each Z¹ and Z² is independently selected from the group consisting of —O—, —S—, —Se—, —NR⁴—, —C(O)O—, —OC(O)—, NR⁴—C(O)—, —C(O)—NR⁴—, O—(CHR⁵CHR⁵—O)ₐ—, and —O—CHR⁵CHR⁵—Si(R⁶)₂—CHR⁵CHR⁵—O—, wherein a is 1-5 and each R⁴, R⁵, and R⁶ is independently H or methyl,
provided that W¹ is not a bisphenol A residue;
each W² is independently —Ar[—Y—Ar]_{q}—, wherein:
   Ar, at each occurrence, is independently a divalent C₆₋₁₈ arylene group;
   Y, at each occurrence, is independently selected from the group consisting of —O—, —S—, —S(O)₂—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
   q is selected from the group consisting of 0, 1, 2, 3, 4, 5, 6, 7, 8, 9 and 10; and
each Z³ and Z⁴ is independently selected from the group consisting of —O—, —S—, —Se—, —NR⁴—, —C(O)O—, —OC(O)—, NR⁴—C(O)—, —C(O)—NR⁴—, O—(CHR⁵CHR⁵—O)ₐ—, and —O—CHR⁵CHR⁵—Si(R⁶)₂—CHR⁵CHR⁵—O—, wherein a is 1-5 and each R⁴, R⁵, and R⁶ is independently H or methyl; and
each Z⁵ and Z⁶ is independently selected from the group consisting of —O—, —S—, —Se—, —NR⁴—, —C(O)O—, —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl,
   wherein the first polymer has a weight-average molecular weight (M_{w}) ranging from about 1,000 to about 200,000. In certain such embodiments, m+n+p is 1.

In another aspect, the present disclosure provides for a device comprising the colored dielectric polymer material as otherwise described herein in contact with a transparent conducting oxide film.

In another aspect, the present disclosure provides for a method of making a device as otherwise described herein, comprising forming a film of the colored dielectric polymer material, depositing a transparent conducting oxide electrode thereon, and annealing at a temperature of at least 200° C. for a time of at least 10 minutes (e.g., in the range of 10 minutes to 24 hours).

Other aspects of the disclosure will be apparent to those skilled in the art in view of the description that follows.

### BRIEF DESCRIPTION OF THE DRAWINGS

FIG. 1A is a schematic cross sectional view of a liquid crystal cell according to an example embodiment.

FIG. 1B is a schematic cross sectional view of a display device according to an example embodiment.

FIG. 2 displays UV-Vis spectra of thin films (Film TFR-19, TFR-101, TFR-103, TFR-107, TFR-109) having the same red dye Dye-161 dispersed in different crosslinked polymers according to various example embodiments.

FIG. 3 displays UV-Vis spectra of thin films (Film TFR-101, TFR-102, TFR-105, TFR-106) having the same red dye Dye-161 in crosslinked polymers based on the same first polymer (polyphenylenesulfone) but with different additives, according to various example embodiments.

FIG. 4 displays UV-Vis spectra of thin films (Film TFY-101, TFR-19, TFG-101, TFB-102) having different color dyes (Dye-115, Dye-161, Dye-149, Solvent black 27, respectively) in same crosslinked polymer, according to various example embodiments.

FIG. 5A displays a UV-Vis spectrum of a typical patterned film (Film TFR-19) before and after AZ photolithographic process (PLP); and FIG. 5B is a picture of a hole-patterned TFR-19 film with hole dimensions ˜6 μm, according to various example embodiments.

FIG. 6 displays a UV-Vis spectrum of a typical crosslinked thin films (Film TFY-101), before and after thermal annealing according to an example embodiment.

FIG. 7 displays UV-Vis spectra of a typical crosslinked thin film (Film TFR-19) before and after ITO fabrication process according to an example embodiment.

FIG. 8 displays UV-Vis spectra of a typical crosslinked thin films (Film TFB-14) before and after solar light exposure (SLE) according to example embodiments.

FIG. 9 displays the leakage current measured from a typical crosslinked thin film (Film TFR-19), according to an example embodiment.

### DETAILED DESCRIPTION

The present inventors have noted an especial problem in the integration of colored polymeric layers into color liquid crystal displays. Typical materials are difficult to form into thin films and pattern. The present inventors have developed compositions that allow the incorporation of dye molecules into crosslinked dielectric polymers. These colored dielectric polymer materials can then be advantageously cast into thin films and processed via photolithography and crosslinking into devices while maintaining excellent film stability and color stability. Further, the materials advantageously resist degradation throughout subsequent processing steps, such as oxide sputtering, photolithography, and/or annealing.

Specifically, the present inventors have noted that polymers including bis(phenylene)sulfone units, bisphenol A units, or both can fragment to form radicals under UV radiation, then such radicals can be used in crosslinking processes, for example, with crosslinkers such as polyfunctional (meth)acrylates and polyfunctional maleimides.

Accordingly, in various desirable aspects of the disclosure, the crosslinked polymer comprises a crosslinking product of crosslinkable composition including a first polymer having bis(phenylene)sulfone residues and/or bisphenol A residues.

In various embodiments as otherwise described herein, the first polymer has a weight-average molecular weight (M_{w}) ranging from about 1,000 g/mol to about 200,000 g/mol.

For example, in various embodiments of the disclosure, the first polymer has bis(phenylene)sulfone residues, i.e., residues having the structure -(Ph)-S(O)₂—(Ph)-. The present inventors have noted that such residues can fragment to form -Ph· radicals and ·S(O)₂— radicals, which can react to form crosslinks, e.g., with a polyfunctional crosslinker.

In such embodiments, the first polymer desirably has a substantial concentration of bis(phenylene)sulfone residues. For example, in various embodiments, the first polymer has a concentration of bis(phenylene)sulfone residues of at least 5 wt %, e.g., at least 10 wt %. In various embodiments, the first polymer has a concentration of bis(phenylene)sulfone residues of at least 20 wt %, e.g., at least 35 wt %. The person of ordinary skill in the art can, based on the disclosure herein, provide a concentration of bis(phenylene)sulfone residues to provide a desired degree of crosslinking in combination with other desirable material properties.

In various embodiments, the first polymer has repeating units of structural formula (I)

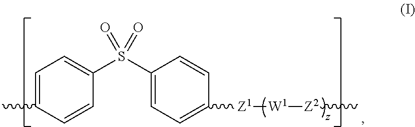

wherein
z is 0 or 1;
each W¹ is independently —Ar[—Y—Ar]_{q}—, wherein:
   Ar, at each occurrence, is independently a divalent C₆₋₁₈ arylene group;
   Y, at each occurrence, is independently selected from the group consisting of —O—, —S—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
   q is selected from the group consisting of 0, 1, 2, 3, 4, 5, 6, 7, 8, 9 and 10; and
each Z¹ and Z² is independently selected from the group consisting of —O—, —S—, —Se—, —NR⁴—, —CH₂—O—, —O—CH₂—, —C(O)O—, —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl,
   wherein the first polymer has a weight-average molecular weight (M_{w}) ranging from about 1,000 to about 200,000.

In various embodiments as otherwise described herein, z is 1. In other embodiments, z is 0.

In various embodiments as otherwise described herein, each Z¹ and Z² is 0 or S. In some such embodiments, each Z¹ and Z² is 0.

In various embodiments as otherwise described herein, z is 0 and Z¹ is —O— or —O—(CHR⁵CHR⁵—O)ₐ—.

In various embodiments as otherwise described herein, z is 0 and Z¹ is —O— or —O—CHR⁵CHR⁵—Si(R⁶)₂—CHR⁵CHR⁵—O—. In certain such embodiments, each R⁵ is H and each R⁶ is methyl.

In various embodiments as otherwise described herein, z is 1 and Z¹ is —O—CH₂— and Z² is —CH₂—O—.

In the materials of formula (I), each Ar can be any arylene group of 6-18 carbons, including heteroarylene groups. For example, in certain embodiments, each Ar is independently phenylene (e.g., 1,4-phenylene, 1,3-phenylene, 1,2-phenylene), naphthylene (e.g., 1,4-naphthylene), an oxadiazolylene (e.g., 1,3,4-oxadiazol-2,5-yl), a 1,3-dihydro-2H-benzo[d]imidazol-2-onediyl (e.g., 1,3-dihydro-2H-benzo[d]imidazol-2-one-1,3-diyl), an lisoindoline-1,3-dionediyl (e.g., lisoindoline-1,3-dione-2,5-diyl. The Ar groups can be optionally substituted, for example, by one or more substituents selected from methyl, ethyl, trifluoromethyl and fluoro.

In the materials of formula (I), each Y can be a variety of substituents as described above. In various embodiments as otherwise described herein, each Y is independently —O—, a covalent bond, or —(CR¹R²)ᵣ—.

In various embodiments as otherwise described herein, each r is independently 1, 2, 3, or 4. In various embodiments, each r is 1. For example, in various embodiments, each Y is —C(CH₃)₂— or —C(CF₃)₂—.

In various embodiments as otherwise described herein, each q is 0. In other embodiments, each q is 1, 2 or 3, e.g., 1.

Examples of bis(phenylene)sulfone-containing first polymers include those including a repeating unit selected from

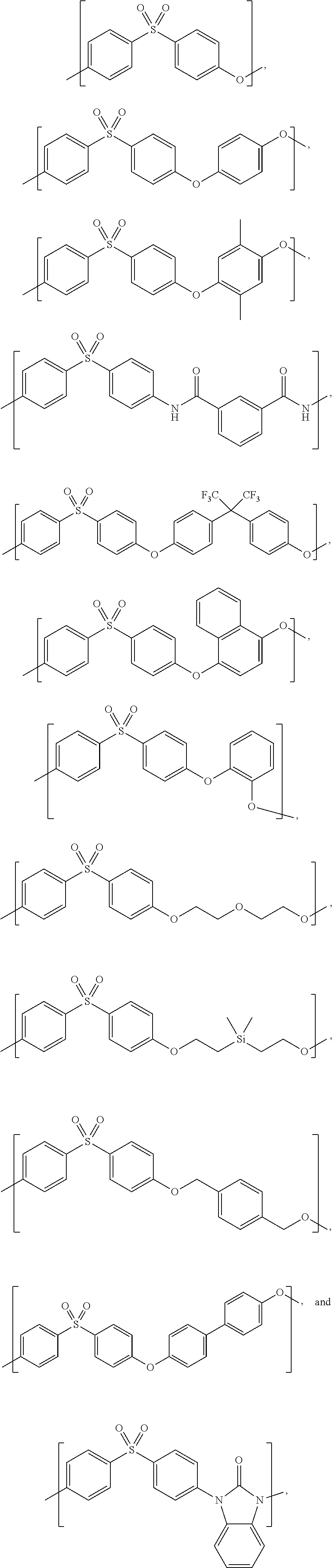

Other suitable bis(phenylene)sulfone-containing first polymers are described below with respect to polymers containing both bis(phenylene)sulfone and bisphenol A residues.

In various embodiments as otherwise described herein, the first polymer has bisphenol A residues, i.e., residues having the structure -(Ph)-C(CH₃)₂—(Ph)-. The present inventors have noted that such residues can fragment to form —C(CH₃)(CH₂)· radicals, which can react to form crosslinks, e.g., with a polyfunctional crosslinker.

In such embodiments, the first polymer desirably has a substantial concentration of bisphenol A residues. For example, in various embodiments, the first polymer has a concentration of bisphenol A residues of at least 5 wt %, e.g., at least 10 wt %. In various embodiments, the first polymer has a concentration of bisphenol A residues of at least 20 wt %, e.g., at least 35 wt %. The person of ordinary skill in the art can, based on the disclosure herein, provide a concentration of bisphenol A residues to provide a desired degree of crosslinking in combination with other desirable material properties.

In various embodiments, the first polymer has repeating units of structural formula (II)

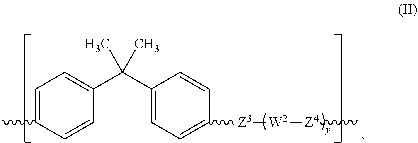

wherein
y is 0 or 1;
each W² is independently —Ar[—Y—Ar]_{q}—, wherein:
   Ar, at each occurrence, is independently a divalent C₆₋₁₈ arylene group;
   Y, at each occurrence, is independently selected from the group consisting of —O—, —S—, —S(O)₂—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
   q is selected from the group consisting of 0, 1, 2, 3, 4, 5, 6, 7, 8, 9 and 10; and
each Z³ and Z⁴ is independently selected from the group consisting of —O—, —S—, —Se—, —NR⁴—, —C(O)O—, —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl,
   wherein the first polymer has a weight-average molecular weight (M_{w}) ranging from about 1,000 to about 200,000.

In various embodiments as otherwise described herein, y is 1. In other embodiments, y is 0.

In various embodiments as otherwise described herein, each Z³ and Z⁴ is 0 or S. In some such embodiments, each Z³ and Z⁴ is 0.

In various embodiments as otherwise described herein, y is 0 and Z³ is —O— or —O—(CHR⁵CHR⁵—O)ₐ—.

In various embodiments as otherwise described herein, y is 0 and Z³ is —O— or —O—CHR⁵CHR⁵—Si(R⁶)₂—CHR⁵CHR⁵—O—. In certain such embodiments, each R⁵ is H and each R⁶ is methyl.

In various embodiments as otherwise described herein, y is 1 and Z³ is —OC(O)— or —NR⁴C(O)— and Z⁴ is —C(O)O— or —C(O)NR⁴—.

In various embodiments as otherwise described herein, y is 1 and Z³ is —O—CH₂— and Z⁴ is —CH₂—O—.

In the materials of formula (II), each Ar can be any arylene group of 6-18 carbons, including heteroarylene groups. For example, in certain embodiments, each Ar is independently phenylene (e.g., 1,4-phenylene, 1,3-phenylene, 1,2-phenylene), napthylene (e.g., 1,4-naphthylene), an oxadiazolylene (e.g., 1,3,4-oxadiazol-2,5-yl), a 1,3-dihydro-2H-benzo[d]imidazol-2-onediyl (e.g., 1,3-dihydro-2H-benzo[d]imidazol-2-one-1,3-diyl), or an lisoindoline-1,3-dionediyl (e.g., lisoindoline-1,3-dione-2,5-diyl. The Ar groups can be optionally substituted, for example, by one or more substituents selected from methyl, ethyl, trifluoromethyl and fluoro.

In the materials of formula (II), each Y can be a variety of substituents as described above. In various embodiments as otherwise described herein, each Y is independently —O—, a covalent bond, or —(CR¹R²)ᵣ—.

In various embodiments as otherwise described herein, each r is independently 1, 2, 3, or 4. In various embodiments, each r is 1. For example, in various embodiments, each Y is —C(CH₃)₂— or —C(CF₃)₂—.

In various embodiments as otherwise described herein, each q is 0. In other embodiments, each q is 1, 2 or 3, e.g., 1.

Examples of bisphenol A residue-containing first polymers include those including a repeating unit selected from

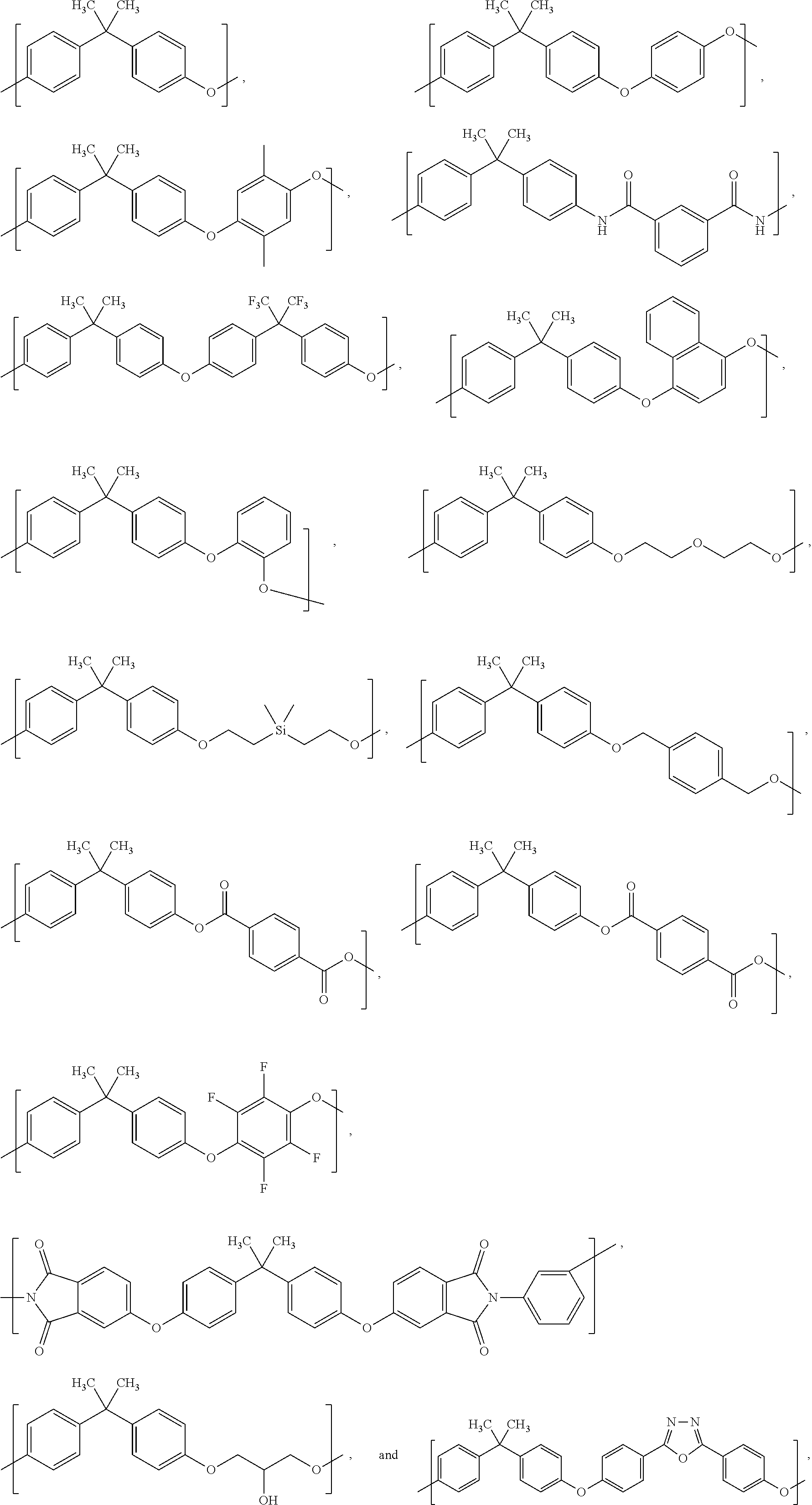

Other suitable bisphenol A residue-containing first polymers are described below with respect to polymers containing both bis(phenylene)sulfone and bisphenol A residues.

In various embodiments as otherwise described herein, the first polymer has repeating units comprising both bis(phenylene)sulfone residues and bisphenol A residues. For example, in some such embodiments, the first polymer has a concentration of bis(phenylene)sulfone residues of at least 5 wt %, e.g., at least 10 wt %, and a concentration of bisphenol A residues of at least 5 wt %, e.g., at least 10 wt %. In some such embodiments, first polymer has a concentration of bis(phenylene)sulfone residues of at least 20 wt %, e.g., at least 35 wt %, and a concentration of bisphenol A residues of at least 20 wt %, e.g., at least 35 wt %.

For example, in various embodiments, the first polymer includes both residues of formula (I) as defined in any manner above and residues of formula (II) as defined in any manner above.

For example, in various embodiments the first polymer has structural formula (III)

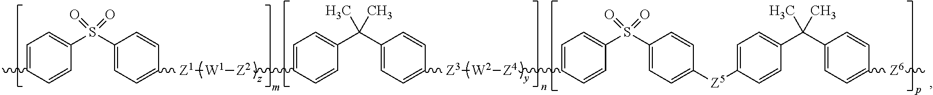

wherein
z is 0 or 1;
each W¹ is independently —Ar[—Y—Ar]_{q}—, wherein:
   Ar, at each occurrence, is independently a divalent C₆₋₁₈ arylene group;
   Y, at each occurrence, is independently selected from the group consisting of —O—, —S—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
   q is selected from the group consisting of 0, 1, 2, 3, 4, 5, 6, 7, 8, 9 and 10; and
each Z¹ and Z² is independently selected from the group consisting of —O—, —S—, —Se—, —NR⁴— —CH₂—O—, —O—CH₂—, —C(O)O—, —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl,
provided that W¹ is not a bisphenol A residue;
y is 0 or 1;
each W² is independently —Ar[—Y—Ar]_{q}—, wherein:
   Ar, at each occurrence, is independently a divalent C₆₋₁₈ arylene group;
   Y, at each occurrence, is independently selected from the group consisting of —O—, —S—, —S(O)₂—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
   q is selected from the group consisting of 0, 1, 2, 3, 4, 5, 6, 7, 8, 9 and 10; and
each Z³ and Z⁴ is independently selected from the group consisting of —O—, —S—, —Se—, —NR⁴—, —C(O)O—, —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl,
each Z⁵ and Z⁶ is independently selected from the group consisting of —O—, —S—, —Se—, —NR⁴—, —C(O)O—, —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl,
   wherein the first polymer has a weight-average molecular weight (M_{w}) ranging from about 1,000 to about 200,000.

In various such embodiments, m+n+p is 1. In other embodiments, the sum of m+n+p is less than 1, but the residues shown in the formula make up at least 75 wt % of the first polymer, e.g., at least 90 wt %, or at least 95 wt %.

The variables Z¹, Z², Z³, Z⁴, W¹, W², y and z, and any subvariables thereof, can be as defined in any manner above.

In various embodiments, the first polymer has repeating units of structural formula (IV):

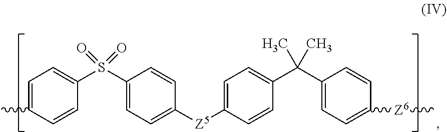

in which Z⁵ and Z⁶ are as described with respect to formula (III).

In various embodiments as otherwise described herein, each Z⁵ and Z⁶ is O or S. In some such embodiments, each Z⁵ and Z⁶ is O.

In various preferred embodiments polymers including both bis(phenylene)sulfone residues and bisphenol A residues have a repeating unit of structure

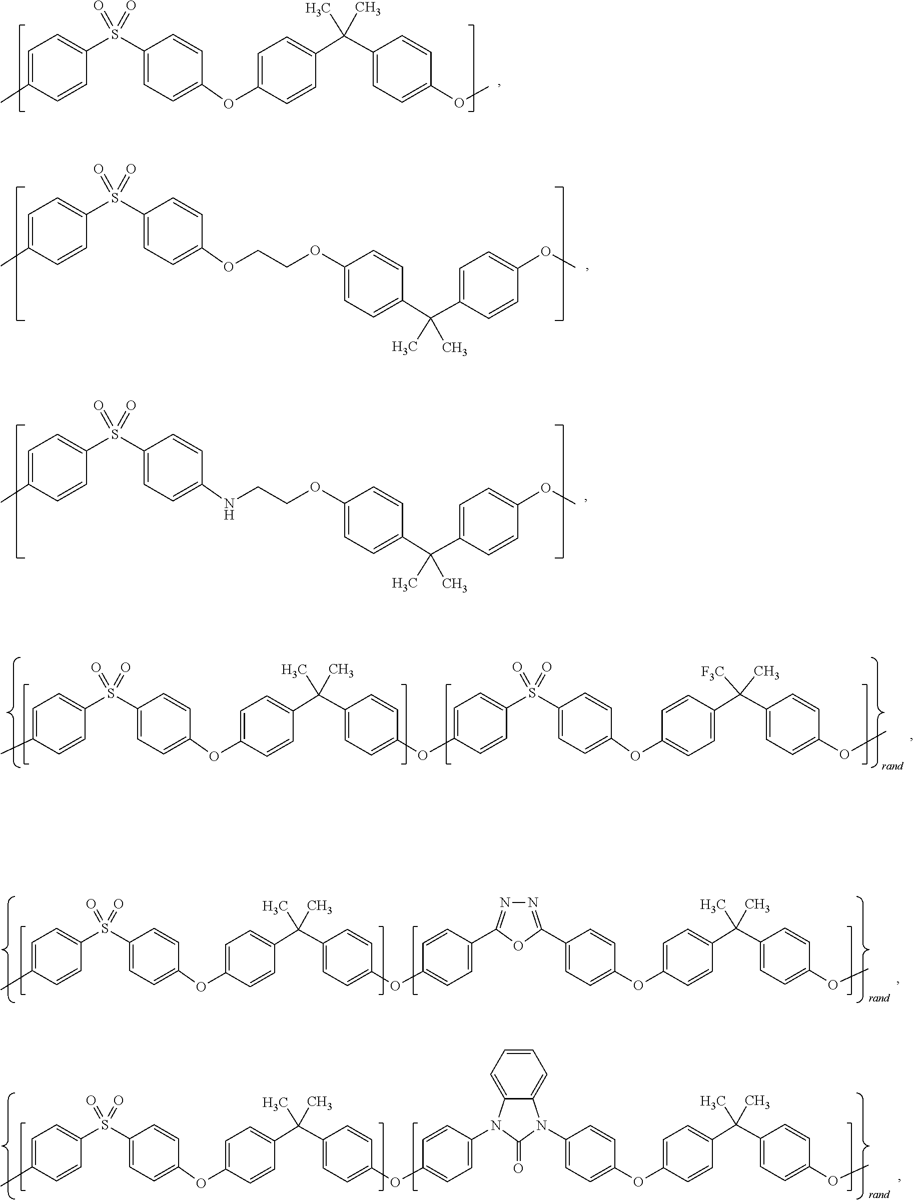

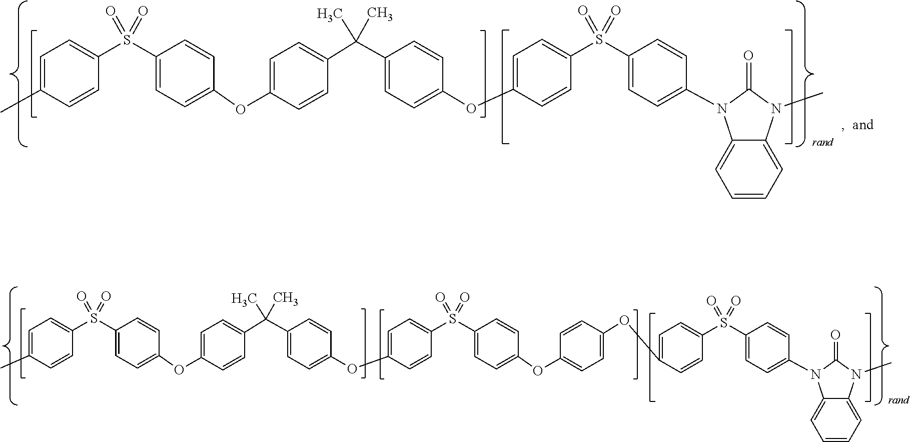

The first polymers used in the colored dielectric polymer materials of the disclosure are commercially available or can be synthesized using polymerization protocols known in the art, particularly those deriving from reaction involving 4,4′-dihalophenyl sulfone (halogen=F and Cl) (See: e.g., Kousuke Tsuchiya et al. Polymer Journal 2015, 47, 353-354; Zhi-Hao Gong et. al. Macromolecules 2000, 33, 8527-8533)) and/or bisphenol A [chemical name is 4,4′-(propane-2,2-diyl)diphenol)](See: e.g., Kiyoshi Endo & Takashi Yamade, Polymer Journal 2008, 40, 212-216 and Pradip Kumar Dutta Journal of Macromolecular Science, Part A 1995, 32, 467-475). Other polymerization methodologies are reported in Block Copolymers: Overview and Critical Survey, Allen Noshay and James E. McGrath Editors, Elsevier 2013.

Without wishing to bound to any particular theory the crosslinking mechanism involving the first polymers of this teaching can involve radical species produced, independently, by the dimethymethelene [—C(CH₃)₂-](See: H. Yamagishi et al. Journal of Membrane Science 1995, 105, 237-247) and sulphonyl [—S(═O)₂-](See: Reactive and Functional Polymers 2019, 136, 104-113) groups.

In various desirable embodiments, the first polymer is crosslinked with a polyfunctional crosslinker that has multiple sites reactive with radical species. For example, in various embodiments, the polymer is crosslinked with a crosslinker selected from polyfunctional (meth)acrylates, polyfunctional maleimides and polyfunctional epoxides.

In various embodiments, crosslinking of the first polymer according to the present teachings can be promoted by incorporating an epoxide crosslinker such as a polymers described in U.S. patent application Ser. No. 13/742,867, having repeating units including:

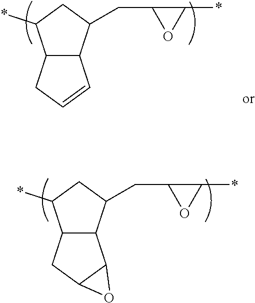

or a diglycidyl ether polymer such as:

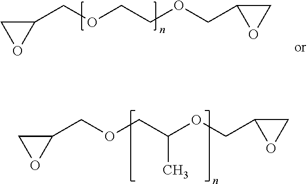

and/or a small molecule crosslinker such as:

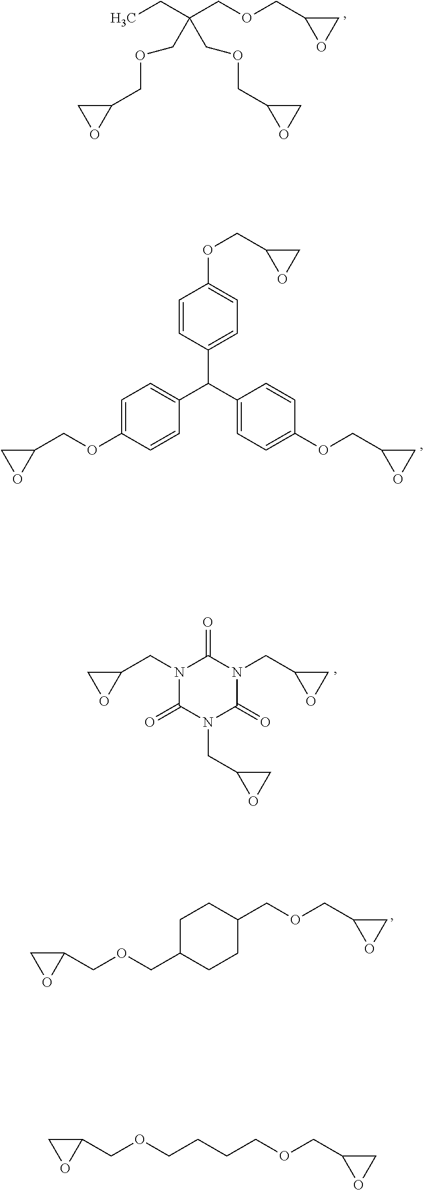 [SMILES: CCC(COCC1CO1)(COCC1CO1)COCC1CO1 ; c1cc(C(c2ccc(OCC3CO3)cc2)c2ccc(OCC3CO3)cc2)ccc1OCC1CO1 ; O=c1n(CC2CO2)c(=O)n(CC2CO2)c(=O)n1CC1CO1 ; C1CC(COCC2CO2)CCC1COCC1CO1 ; C(CCOCC1CO1)COCC1CO1]

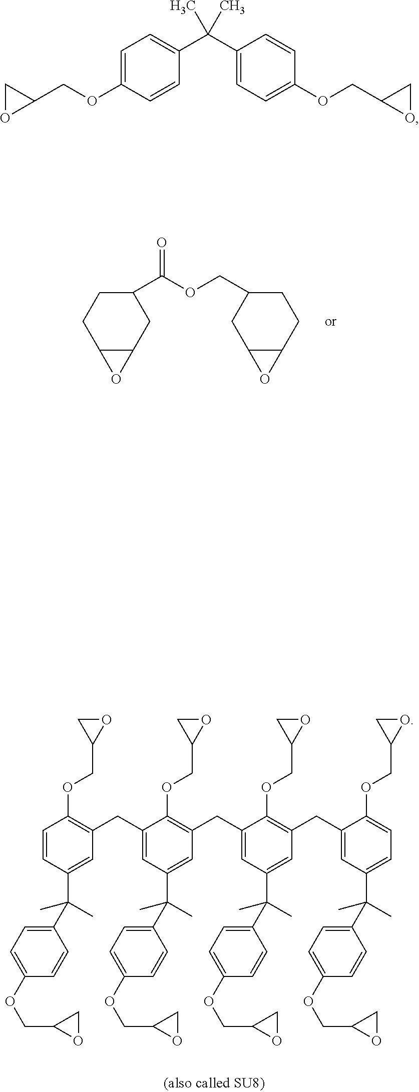 [SMILES: CC(C)(c1ccc(OCC2CO2)cc1)c1ccc(OCC2CO2)cc1 ; O=C(OCC1CCC2OC2C1)C1CCC2OC2C1 ; CC(C)(c1ccc(OCC2CO2)cc1)c1ccc(OCC2CO2)c(Cc2cc(C(C)(C)c3ccc(OCC4CO4)cc3)cc(Cc3cc(C(C)(C)c4ccc(OCC5CO5)cc4)cc(Cc4cc(C(C)(C)c5ccc(OCC6CO6)cc5)ccc4OCC4CO4)c3OCC3CO3)c2OCC2CO2)c1]

In other embodiments, crosslinking of the first polymer according to the present teachings can be promoted by incorporating other crosslinkable components such as small molecule (meth)acrylates

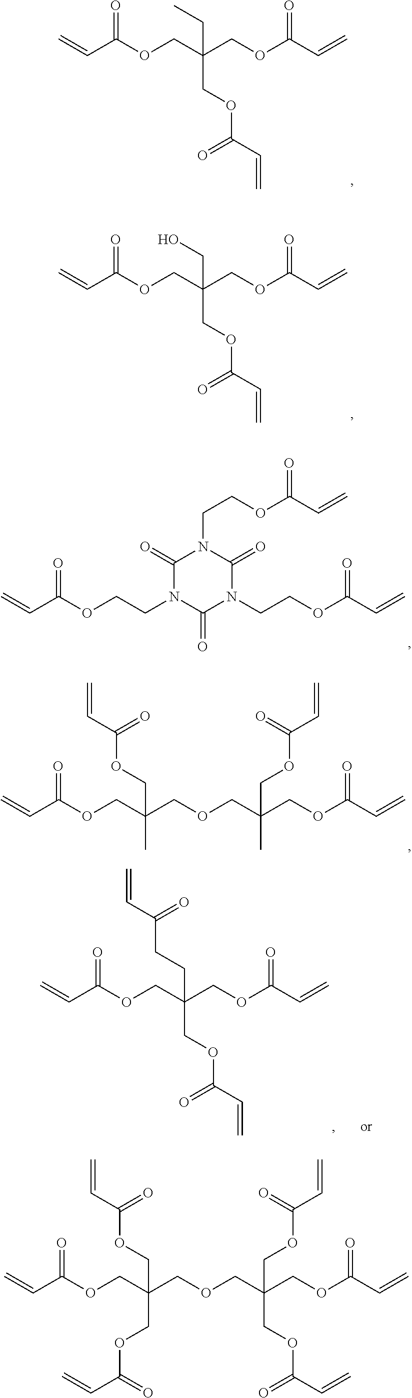

and/or small molecule maleimides

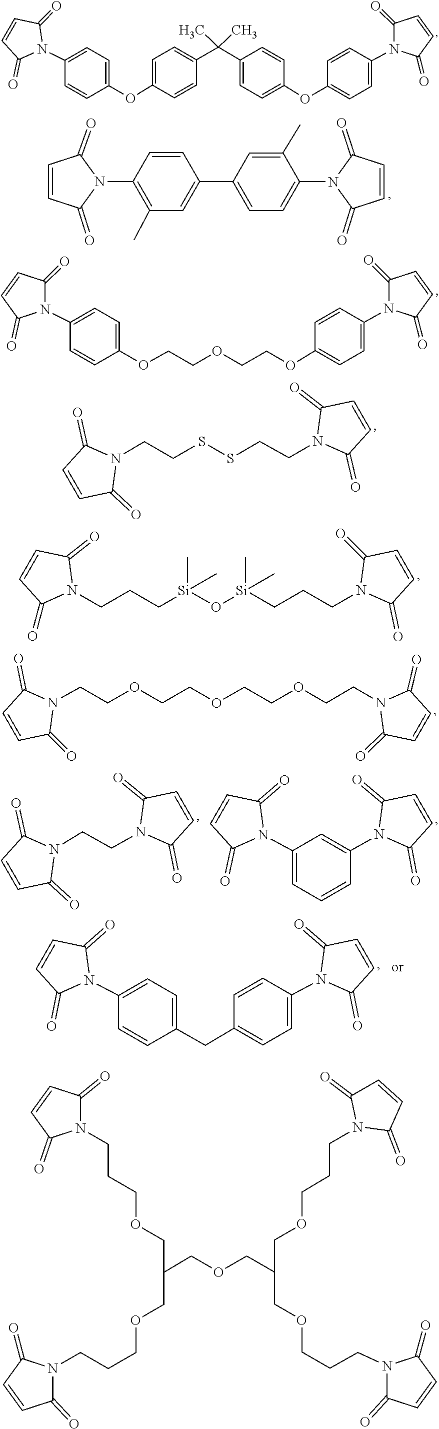

In addition to the crosslinkers, the crosslinking chemistry can involve initiators and/or additional crosslinking agents to enhance the crosslinking density of the present polymers. Examples of initiators can include radical initiators such as azobisisobutyronitrile (AIBN), photoacid generators (PAGs) such as triphenylsulfonium triflate, radical photoinitiators such as diphenyl(2,4,6-trimethylbenzoyl)phosphine oxide (TPO), or photosensitizers such as benzophenone and 1-chloro-4-propoxy-9H-thioxanthen-9-one. Some commercially available PAGs are:

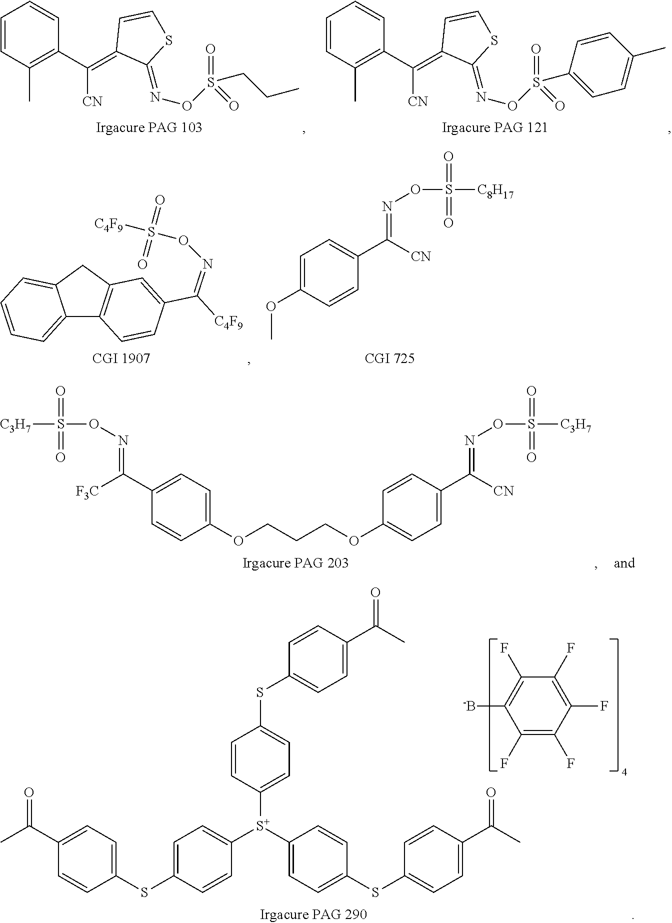

In general, the crosslinked polymers described herein possess a relatively low dielectric constant to reduce capacitive coupling between the electrodes in the device. Accordingly, in various embodiments as otherwise described herein, the crosslinked polymer has dielectric constant of no more than 8, e.g., no more than 7, or no more than 6, no more than 5, or no more than 4, or no more than 3, at 1 MHz. For example, in various embodiments, the crosslinked polymer has a dielectric constant in the range of 2 to 8, e.g., in the range of 2 to 7, or 2 to 6, or 2 to 5, or 2.5 to 8, or 2.5 to 7, or 2.5 to 6, or 2.5 to 5, or 3 to 8, or 3 to 7, or 3 to 6, or 3 to 5), at 1 MHz. In particular embodiments, the crosslinked polymer has a dielectric constant in the range of 2-6, e.g., 2-5, or 2-4, or 2-3 at 1 MHz. For example, in various embodiments as otherwise described herein, the crosslinked polymer has a dielectric constant in the range of 1.1 to 5.0.

### Dyes

The colored dielectric polymer material of the present disclosure includes a dye dispersed in the crosslinked polymer. The dye desirably has substantial absorption in the visible range of the spectrum, so as to present as colored to a human observer. A wide variety of suitable dyes may be selected. In certain embodiments as otherwise described herein, the dye is provided as one or more dyes selected from perylene diimide dyes, naphthalene diimide dyes, naphthalene monoimide dyes, perylene dyes, anthraquinone dyes, quinone dyes, phenazine dyes, azo dyes, triarylmethane dyes, transition metal coordination complex dyes, cyanine dyes, phenoxazine dyes, indole dyes, xanthene dyes, coumarin dyes, nitro dyes, indene dyes, porphyrin dyes, and phthalocyanine dyes. The person of ordinary skill in the art will understand that a variety of other types of dyes can be used. Multiple dyes can be used to tune color. Especially suitable dyes have a molar absorptivity of at least 8,000 M⁻¹cm⁻¹ at least one wavelength within the 380-750 nm wavelength range. In various desirable embodiments, a dye unit has an absorbance maximum in the range of 380-1000 nm. When the dye is not a black dye, it also has substantial transmittance (e.g., molar absorptivity of no more than 500 M⁻¹cm⁻¹) at one or more other wavelengths within the 380-750 nm wavelength range.

In various embodiments as otherwise described herein, the dye includes an ionic dye. Examples of suitable ionic dyes include Dye 757, Dye-6G, and Dye Bu26, as well as many other dyes of the table below.

In various particular embodiments, the dye is a perylene diimide dye, a naphthalene diimide dye, a naphthalene monoimide dye, a perylene dye, an anthraquinone dye, a quinone dye, a phenazine dye, an azo dye, or a metal complex dye. As will be appreciated by the person of ordinary skill in the art, certain dyes may simultaneously belong to more than one dye category.

Particular examples of suitable dyes include those of Table 1, below. The structures provided are based on best information, the common names control.

TABLE 1

| Common | |
|---|---|
| Name | Nominal Structure |
| Disperse red 60 | 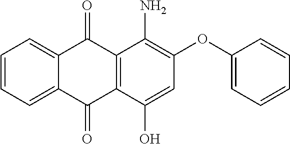 [SMILES: Nc1c(Oc2ccccc2)cc(O)c2c1C(=O)c1ccccc1C2=O] |
| Sudan Red 7B | 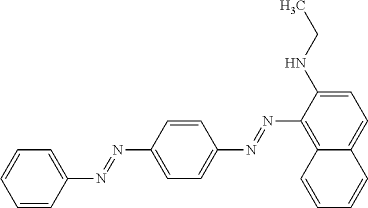 [SMILES: CCNc1ccc2ccccc2c1/N=N/c1ccc(/N=N/c2ccccc2)cc1] |
| Disperse red 11 | 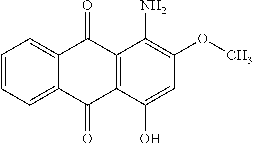 [SMILES: COc1cc(O)c2c(c1N)C(=O)c1ccccc1C2=O] |
| Sudan 3 | 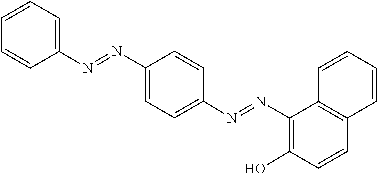 [SMILES: Oc1ccc2ccccc2c1/N=N/c1ccc(/N=N/c2ccccc2)cc1] |
| Disperse red 1 | 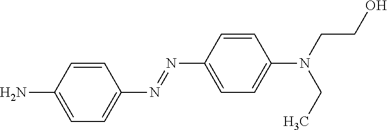 [SMILES: CCN(CCO)c1ccc(/N=N/c2ccc(N)cc2)cc1] |
| Sudan 1 | 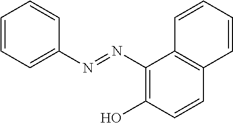 [SMILES: Oc1ccc2ccccc2c1/N=N/c1ccccc1] |
| Disperse red 72 | 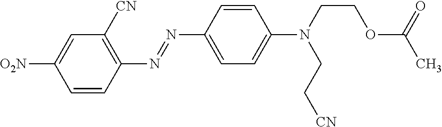 [SMILES: CC(=O)OCCN(CCC#N)c1ccc(/N=N/c2ccc([N+](=O)[O-])cc2C#N)cc1] |
| Sudan red G | 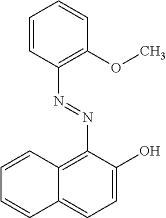 [SMILES: COc1ccccc1/N=N/c1c(O)ccc2ccccc12] |
| Disperse red 9 | 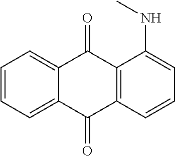 [SMILES: CNc1cccc2c1C(=O)c1ccccc1C2=O] |
| Mordant Red 11 | 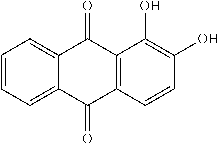 [SMILES: O=C1c2ccccc2C(=O)c2c1ccc(O)c2O] |
| Acid Red 27 | 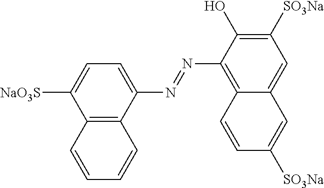 |
| Basic Red 9 | 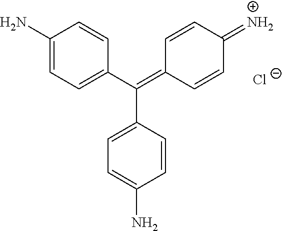 [SMILES: Nc1ccc(C(=C2C=CC(=[NH2+])C=C2)c2ccc(N)cc2)cc1 ; [Cl-]] |
| Acid Red 18 | 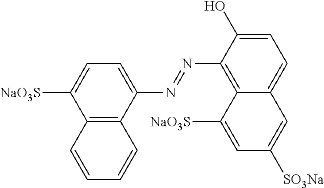 |
| Basic Red 14 | 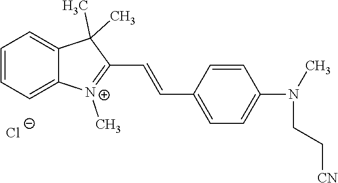 [SMILES: CN(CCC#N)c1ccc(/C=C/C2=[N+](C)c3ccccc3C2(C)C)cc1 ; [Cl-]] |
| Acid red 266 | 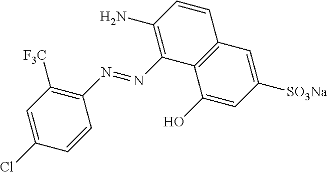 |
| Solvent red 26 | 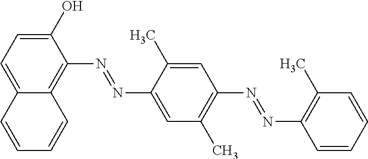 [SMILES: Cc1ccccc1/N=N/c1cc(C)c(/N=N/c2c(O)ccc3ccccc23)cc1C] |
| Nile red | 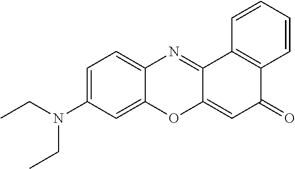 [SMILES: CCN(CC)c1ccc2nc3c4ccccc4c(=O)cc-3oc2c1] |
| Vat red 10 | 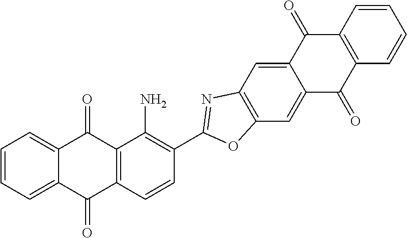 [SMILES: Nc1c(-c2nc3cc4c(cc3o2)C(=O)c2ccccc2C4=O)ccc2c1C(=O)c1ccccc1C2=O] |
| Toludine red | 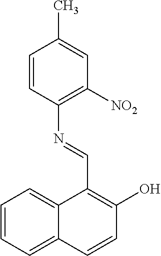 [SMILES: Cc1ccc(/N=C/c2c(O)ccc3ccccc23)c([N+](=O)[O-])c1] |
| Vat red 13 | 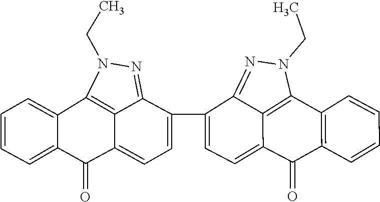 |
| Direct red 80 | 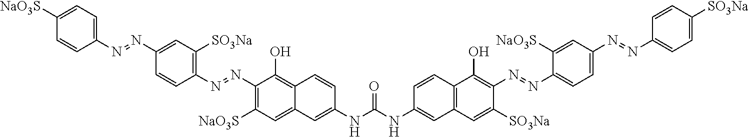 |
| Tartrazine | 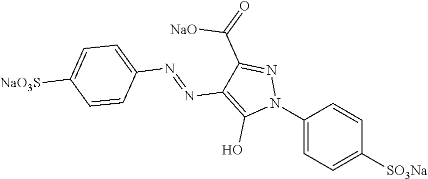 |
| Direct yellow 4 | 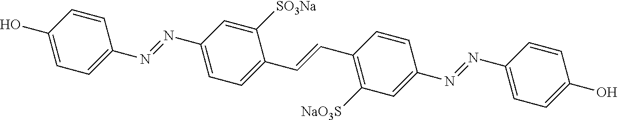 |
| Reactive yellow 4 | 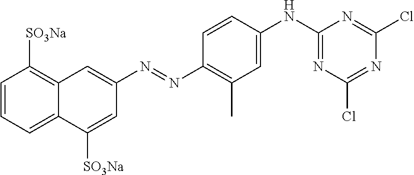 |
| Direct yellow 27 | 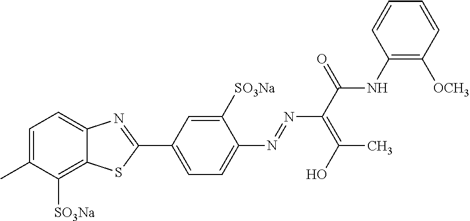 |
| Vat yellow 4 | 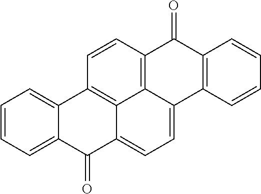 [SMILES: O=C1c2ccccc2-c2ccc3c4c(ccc1c24)-c1ccccc1C3=O] |
| Solvent yellow 94 | 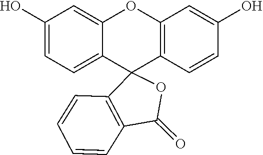 [SMILES: O=C1OC2(c3ccc(O)cc3Oc3cc(O)ccc32)c2ccccc21] |
| Vat yellow 1 | 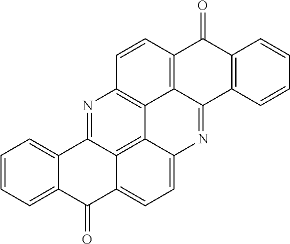 [SMILES: O=c1c2ccccc2c2nc3ccc4c(=O)c5ccccc5c5nc6ccc1c2c6c3c45] |
| Solvent yellow 44 | 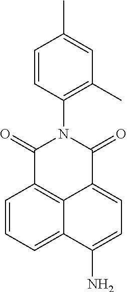 [SMILES: Cc1ccc(N2C(=O)c3cccc4c(N)ccc(c34)C2=O)c(C)c1] |
| C.I. Vat yellow 5 | 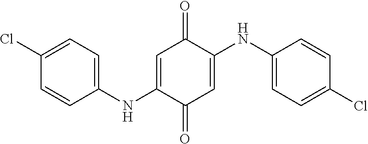 [SMILES: O=C1C=C(Nc2ccc(Cl)cc2)C(=O)C=C1Nc1ccc(Cl)cc1] |
| Solvent yellow 43 | 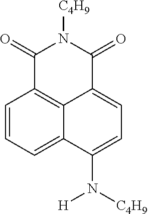 |
| Solvent yellow 33 | 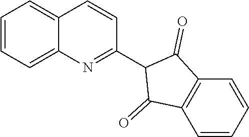 [SMILES: O=C1c2ccccc2C(=O)C1c1ccc2ccccc2n1] |
| Disperse yellow 42 | 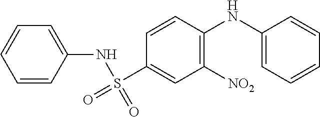 [SMILES: O=[N+]([O-])c1cc(S(=O)(=O)Nc2ccccc2)ccc1Nc1ccccc1] |
| Solvent yellow 124 | 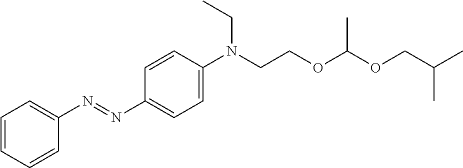 [SMILES: CCN(CCOC(C)OCC(C)C)c1ccc(/N=N/c2ccccc2)cc1] |
| Disperse yellow 31 | 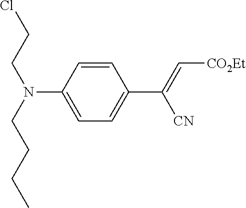 [SMILES: CCCCN(CCCl)c1ccc(/C(C#N)=C/C(=O)OCC)cc1] |
| Disperse yellow 26 | 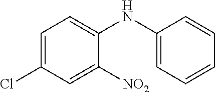 [SMILES: O=[N+]([O-])c1cc(Cl)ccc1Nc1ccccc1] |
| C.I. Basic Yellow 28 | 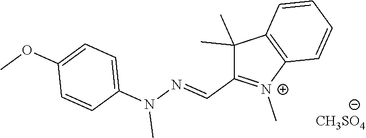 |
| Tartrazine | 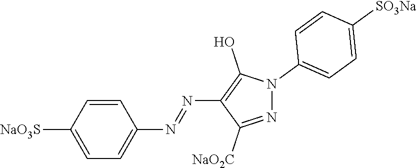 |
| Coumarin 153 | 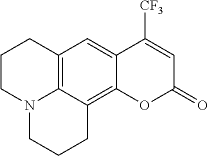 [SMILES: O=c1cc(C(F)(F)F)c2cc3c4c(c2o1)CCCN4CCC3] |
| Coumarin 30 | 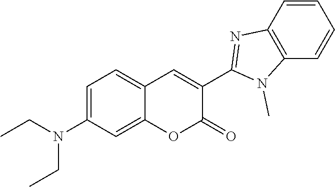 [SMILES: CCN(CC)c1ccc2cc(-c3nc4ccccc4n3C)c(=O)oc2c1] |
| Coumarin 102 | 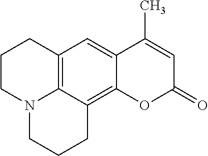 [SMILES: Cc1cc(=O)oc2c3c4c(cc12)CCCN4CCC3] |
| Coumarin 6 | 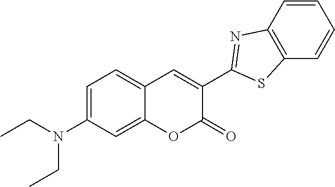 [SMILES: CCN(CC)c1ccc2cc(-c3nc4ccccc4s3)c(=O)oc2c1] |
| Malachite Green | 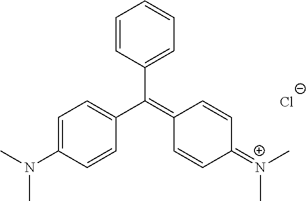 |
| Acid green 25 | 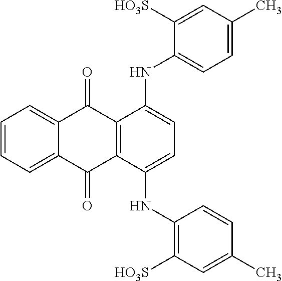 [SMILES: Cc1ccc(Nc2ccc(Nc3ccc(C)cc3S(=O)(=O)O)c3c2C(=O)c2ccccc2C3=O)c(S(=O)(=O)O)c1] |
| Solvent green 3 | 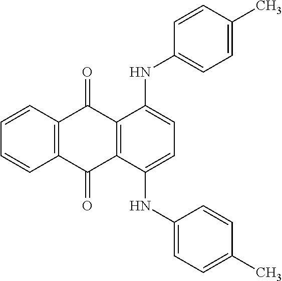 [SMILES: Cc1ccc(Nc2ccc(Nc3ccc(C)cc3)c3c2C(=O)c2ccccc2C3=O)cc1] |
| Naphthol Green B | 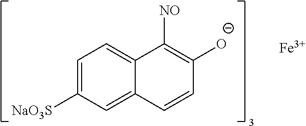 |
| Solvent green 28 | 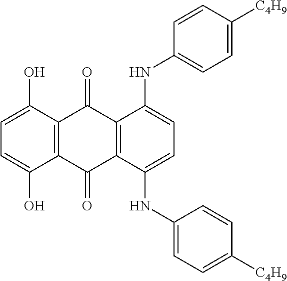 |
| Solvent green 5 | 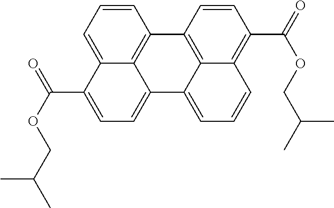 [SMILES: CC(C)COC(=O)c1ccc2c3cccc4c(C(=O)OCC(C)C)ccc(c5cccc1c52)c43] |
| Vat green 12 | 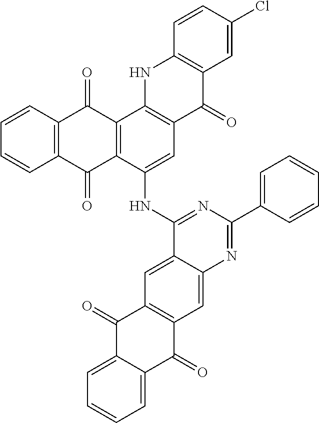 [SMILES: O=C1c2ccccc2C(=O)c2cc3c(Nc4cc5c(=O)c6cc(Cl)ccc6[nH]c5c5c4C(=O)c4ccccc4C5=O)nc(-c4ccccc4)nc3cc21] |
| Cardiogreen | 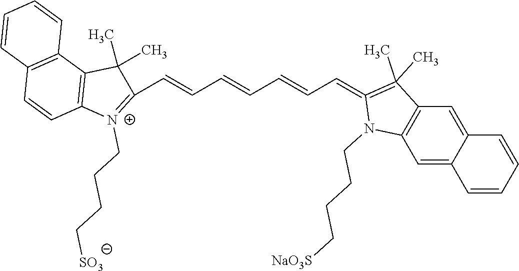 |
| Vat green 1 | 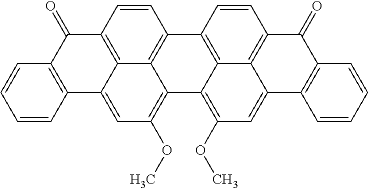 [SMILES: COc1cc2c3c(ccc4c5ccc6c7c(cc(OC)c(c1c34)c75)-c1ccccc1C6=O)C(=O)c1ccccc1-2] |
| Vat green 3 | 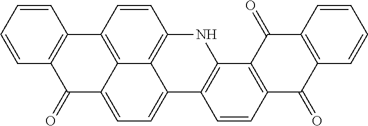 [SMILES: O=C1c2ccccc2C(=O)c2c1ccc1c2[nH]c2ccc3c4ccccc4c(=O)c4ccc1c2c43] |
| Vat green 9 | 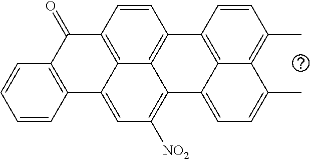 [SMILES: Cc1ccc2c3ccc4c5c(cc([N+](=O)[O-])c(c6ccc(C)c1c26)c53)-c1ccccc1C4=O] |
| Direct green 26 | 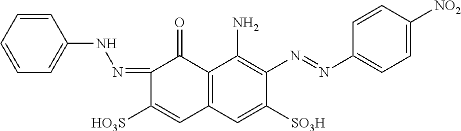 [SMILES: Nc1c(/N=N/c2ccc([N+](=O)[O-])cc2)c(S(=O)(=O)O)cc2c1C(=O)/C(=N\Nc1ccccc1)C(S(=O)(=O)O)=C2] |
| Acid green 50 | 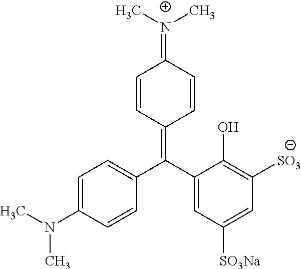 |
| Disperse green 9 | 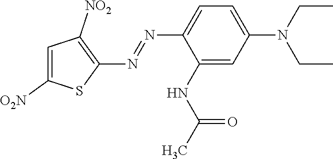 [SMILES: CCN(CC)c1ccc(/N=N/c2sc([N+](=O)[O-])cc2[N+](=O)[O-])c(NC(C)=O)c1] |
| Direct green 28 | 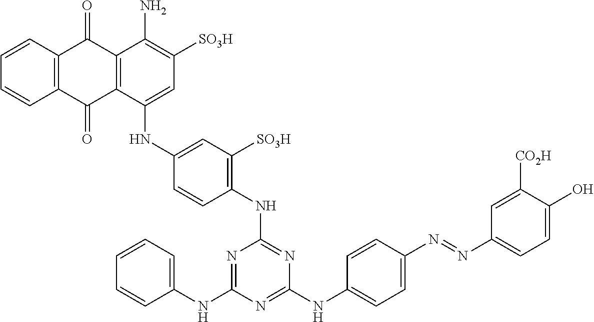 [SMILES: Nc1c(S(=O)(=O)O)cc(Nc2ccc(Nc3nc(Nc4ccccc4)nc(Nc4ccc(/N=N/c5ccc(O)c(C(=O)O)c5)cc4)n3)c(S(=O)(=O)O)c2)c2c1C(=O)c1ccccc1C2=O] |
| Vat green 11 | 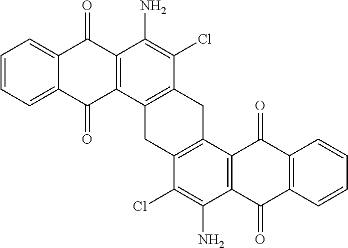 [SMILES: Nc1c(Cl)c2c(c3c1C(=O)c1ccccc1C3=O)Cc1c(Cl)c(N)c3c(c1C2)C(=O)c1ccccc1C3=O] |
| Food black 1 | 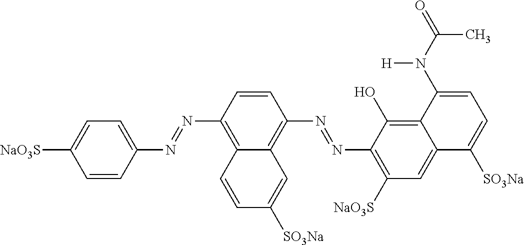 |
| Mordant Black 25 | 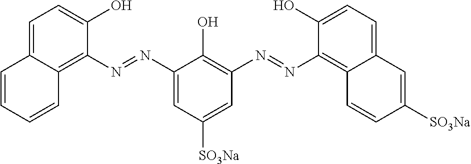 |
| Mordant Black 11 | 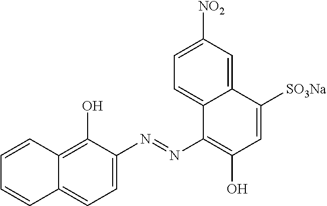 |
| Acid Black 48 | 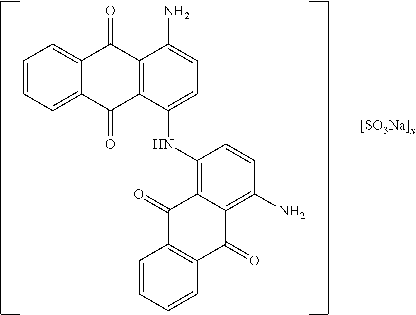 |
| Reactive Black 5 | 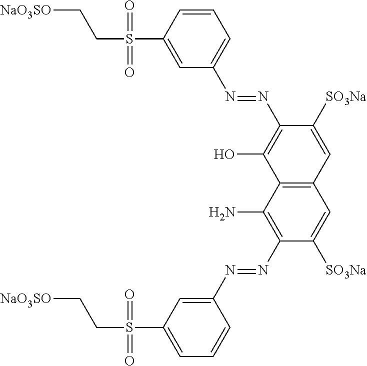 |
| Reactive Black 8 | 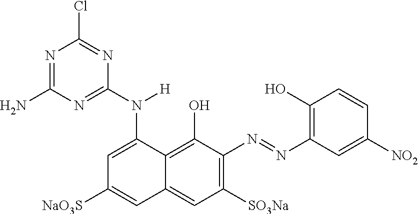 |
| Vat Black 29 | 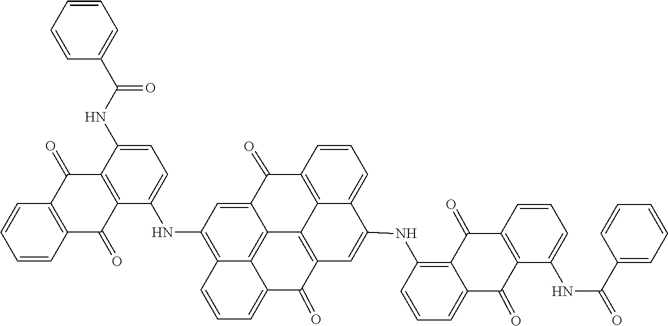 [SMILES: O=C(Nc1cccc2c1C(=O)c1cccc(Nc3cc4c5c6c3cccc6c(=O)c3cc(Nc6ccc(NC(=O)c7ccccc7)c7c6C(=O)c6ccccc6C7=O)c6cccc(c4=O)c6c3-5)c1C2=O)c1ccccc1] |
| Direct Black 19 | 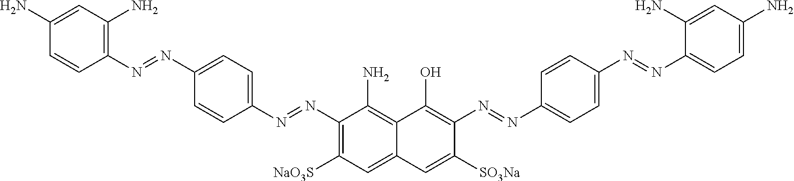 |
| Solvent Black 3 | 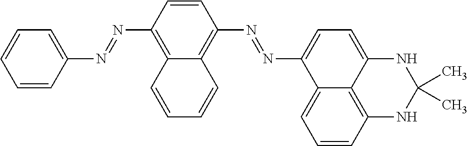 [SMILES: CC1(C)Nc2cccc3c(/N=N/c4ccc(/N=N/c5ccccc5)c5ccccc45)ccc(c23)N1] |
| Vat Black 27 | 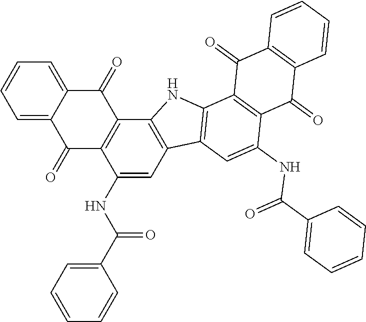 [SMILES: O=C(Nc1cc2c3cc(NC(=O)c4ccccc4)c4c(=O)c5ccccc5c(=O)c4c3[nH]c2c2c(=O)c3ccccc3c(=O)c12)c1ccccc1] |
| Vat Black 25 | 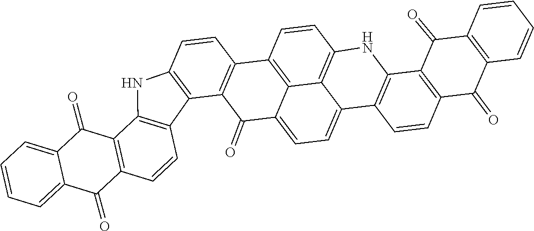 [SMILES: O=C1c2ccccc2C(=O)c2c1ccc1c2[nH]c2ccc3c4ccc5[nH]c6c7c(ccc6c5c4c(=O)c4ccc1c2c43)C(=O)c1ccccc1C7=O] |
| Direct Black 36 | 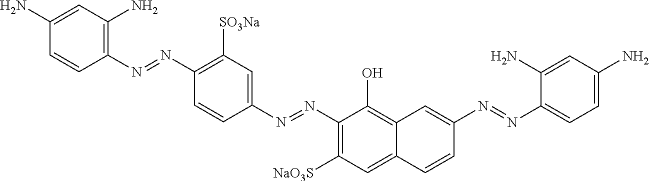 |
| Solvent Black 27 | 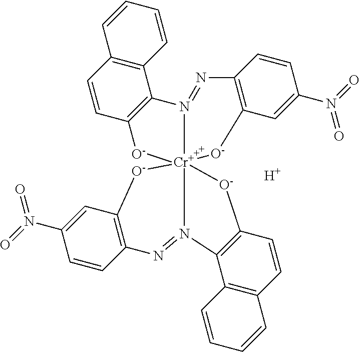 |
| Disperse Black 4 | 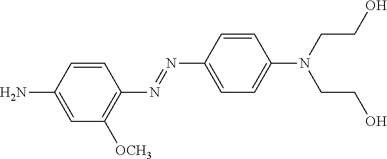 [SMILES: COc1cc(N)ccc1/N=N/c1ccc(N(CCO)CCO)cc1] |
| Disperse Black 9 | 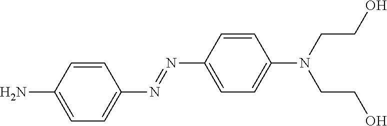 [SMILES: Nc1ccc(/N=N/c2ccc(N(CCO)CCO)cc2)cc1] |
| Acid Black 1 | 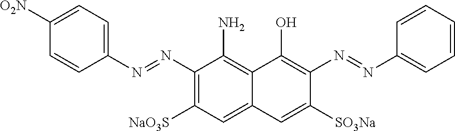 |
| Direct Black 195 | 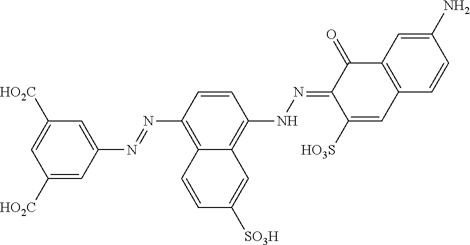 [SMILES: Nc1ccc2c(c1)C(=O)/C(=N/Nc1ccc(/N=N/c3cc(C(=O)O)cc(C(=O)O)c3)c3ccc(S(=O)(=O)O)cc13)C(S(=O)(=O)O)=C2] |
| Acid Black 180 | 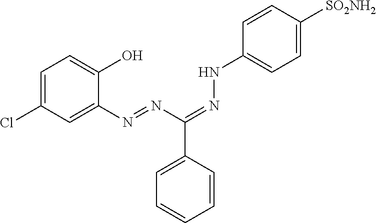 [SMILES: NS(=O)(=O)c1ccc(N/N=C(\N=N\c2cc(Cl)ccc2O)c2ccccc2)cc1] |
| Mordant black 9 | 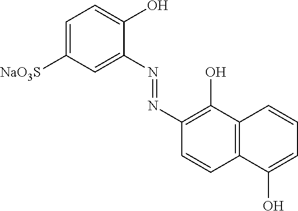 |
| Reactive Black 31 | 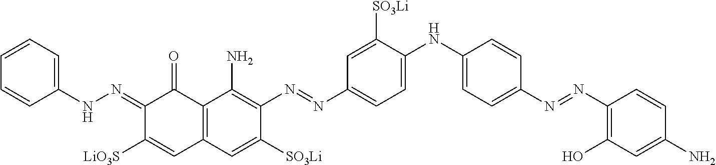 |
| Nigrosin | 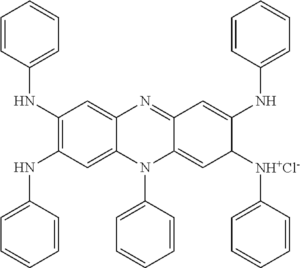 |
| Dye 757 | 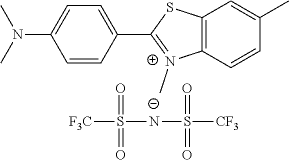 |
| Dye 6G | 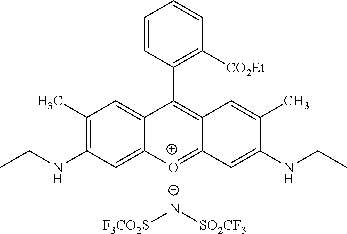 |
| Dye B26 | 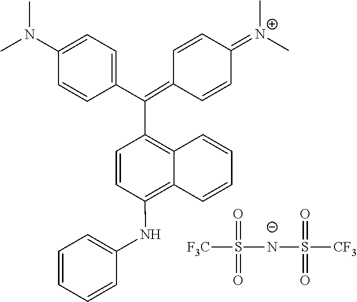 |

The amount of dye introduced into the polymer may be adjusted according to chemical compatibility and the color saturation needs. Accordingly, in various embodiments as otherwise described herein, the dye is present in the colored dielectric polymer material in an amount of at least 1 wt %, e.g., at least 3 wt %, at least 10 wt %, or at least 50 wt %. For example, in various embodiments as otherwise described herein, the dye is present in the polymer in an amount in the range of 1-80 wt % e.g., 1-80 wt %, or 1-50 wt %, or 1-20 wt %, or 3-80 wt %, or 3-50 wt %, or 3-20 wt %, or 3-10 wt %, or 5-80 wt %, or 5-50 wt %, or 5-30 wt %, or 5-20 wt %, or 10-80 wt %, or 10-50 wt %, or 20-80 wt %, or 20-50 wt %.

### Colored Dielectric Polymer Materials

In various embodiments (e.g., embodiments that present a non-black color), the colored dielectric polymeric material as otherwise described herein advantageously allows a certain amount of light to pass through the material in a desired visible wavelength range. Accordingly, in various embodiments, the colored dielectric polymer material is provided as a body (e.g., a film) having a transmittance maximum intensity of at least 50% (e.g., at least 75%, at least 90%) at one or more wavelengths in the range of 380-450 nm (violet); 450-495 nm (blue); 495-570 nm (green); 570-590 nm (yellow); 590-620 nm (orange); or 620-750 nm (red). And in various such embodiments, the body of colored dielectric polymer material has a transmittance minimum intensity of no more than 20% (e.g., no more than 10%, no more than 5%) at one or more wavelengths in the range of 380-450 nm (violet); 450-495 nm (blue); 495-570 nm (green); 570-590 nm (yellow); 590-620 nm (orange); or 620-750 nm (red). In various such embodiments, the body is no more than 1 mm in thickness, e.g., no more than 100 microns, no more than 50 microns, or even no more than 10 microns in thickness. For example, in various such embodiments, the body has a thickness in the range of 0.05-100 microns, e.g., 0.05-50 microns, or 0.05-10 microns, or 0.05-5 microns, or 0.05-2 microns, or 0.05-1 micron, or 0.1-100 microns, or 0.1-50 microns, or 0.1-10 microns, or 0.1-5 microns, or 0.1-2 microns, or 0.1-1 micron, or 0.2-100 microns, or 0.2-50 microns, or 0.2-10 microns, or 0.2-5 microns, or 0.2-2 microns, or 0.2-1 micron. As the person of ordinary skill in the art, high transmittance in one part of the visible spectrum and low transmittance in another part of the visible spectrum will provide a perceived non-black color to the material.

In other embodiments, it may be advantageous for only small amounts of visible light to transmit through the colored dielectric polymer materials of the disclosure. For example, when the colored dielectric polymer material is black. Accordingly, in certain embodiments as otherwise described herein, the material is in the form of a body (e.g., a film) having a total transmittance of light in wavelength range 380-750 nm of no more than 20%, for example, no more than 10%, no more than 5%, or even no more than 1%. In various such embodiments, the body is no more than 1 mm in thickness, e.g., no more than 100 microns, no more than 50 microns, or even no more than 10 microns in thickness. For example, in various such embodiments, the body has a thickness in the range of 0.05-100 microns, e.g., 0.05-50 microns, or 0.05-10 microns, or 0.05-5 microns, or 0.05-2 microns, or 0.05-1 micron, or 0.1-100 microns, or 0.1-50 microns, or 0.1-10 microns, or 0.1-5 microns, or 0.1-2 microns, or 0.1-1 micron, or 0.2-100 microns, or 0.2-50 microns, or 0.2-10 microns, or 0.2-5 microns, or 0.2-2 microns, or 0.2-1 micron.

In particular embodiments, the colored dielectric polymer materials may be fabricated as thin films for use in devices. Accordingly, for adequate coloration in a thin film, the selected dye may be chosen to strongly absorb particular wavelengths. In certain embodiments as otherwise described herein, the dye has a peak molar absorptivity of at least 8,000 M⁻¹cm⁻¹.

Polymers comprising pigments are well known in the art. As apparent to the person of ordinary skill in the art, pigments are provided as insoluble substances or particles, as compared to a dye that is solvent-soluble and thus more homogeneously dispersed in the colored dielectric polymer material. The present inventors note that the particulate nature of pigments can cause undesirable scattering. In various embodiments as described herein, the colored dielectric polymer material does not comprise a pigment.

A key advantage of the technology described by the present disclosure is the ability to fabricate exceptionally thin films of the materials described herein. Films of the colored dielectric polymer materials can be provided at a variety of thicknesses, including those described above. In certain embodiments as otherwise described herein, a colored dielectric polymer material is present as a film having a thickness of no more than 4 μm (e.g., no more than 3.5 μm, or no more than 3 μm, or no more than 2.5 μm, or no more than 2 μm, or no more than 1.5 μm). In certain embodiments, the colored dielectric polymer material film has a thickness of at least 50 nm (e.g., at least 100 nm, at least 200 nm, or at least 500 nm).

Additionally, in various desirable embodiments the colored dielectric polymer material maintains desirable dielectric properties. One measure of a dielectric quality is the breakdown voltage (i.e., at a given electric field). Accordingly, in certain embodiments as otherwise described herein, the colored dielectric polymer material has a breakdown voltage of at least 50 V at 2 MV/cm (e.g., at least 60 V, or 70 V, or 80 V, or 90 V, or 100 V). Leakage current is another measure of dielectric quality; in various embodiments as otherwise described herein, the colored dielectric polymer material (e.g., in the form of a film having a thickness as described herein) has a leakage current density of no more than 1×10⁻⁸ A/cm² at an electric field of 1.0 MV/cm.

Another desired property of a colored dielectric polymer material is a relatively low dielectric constant to reduce capacitive coupling between the electrodes in the device. Accordingly, in various embodiments as otherwise described herein, the colored dielectric polymer material has dielectric constant of no more than 8, e.g., no more than 7, or no more than 6, or no more than 5, or no more than 4, or no more than 3, at 1 MHz. For example, in various embodiments, the colored dielectric polymer material has a dielectric constant in the range of 2 to 8, e.g., in the range of 2 to 7, or 2 to 6, or 2 to 5, or 2 to 4, or 2.5 to 8, or 2.5 to 7, or 2.5 to 6, or 2.5 to 5, or 3 to 8, or 3 to 7, or 3 to 6, or 3 to 5, at 1 MHz. In particular embodiments, the colored dielectric polymer material has a dielectric constant in the range of 2-6, e.g., 2-5, or 2-4, or 2-3 at 1 MHz.

The colored dielectric polymer material may be prepared according to methods known to the person of ordinary skill in the art, especially as described in International Patent Application Publication no. 2013/119717 and International Patent Application Publication no. 2010/057984. The dye can be dissolved in a solution of crosslinkable composition, which can then be cast into a film or other body. The film may be prepared through spin-coating, slit-coating, slot-die, or blade coating, among other techniques such as gravure, flexographic, or inkjet printing. Conventional negative or positive photolithographic techniques can be used to provide patterned radiation to crosslink the base polymers to provide the crosslinked material. Radiation, heat, or combination of both can be used to crosslink the film which then can be patterned using conventional photoresists.

Specifically, the crosslinkable composition can be photocrosslinked by light exposure, for example, at a wavelength of about 250 nm to about 500 nm. Photocrosslinking can be carried out by flood exposure (i.e., without filter) or by exposure to irradiation at selective wavelengths, for example, in the H (404.7 nm), G (435.8 nm) or I (365.4 nm) line of the spectrum. One of the advantages of these polymers can be the possible use of longer wavelengths (e.g., >350 nm) for photocuring. Accordingly, an advantage of preparing a dielectric material using these polymers can be that the formulations (which include the present polymers) from which the dielectric material is prepared can be free of ionic photo-initiators (which are known to compromise the dielectric strength of a material i.e., leading to high leakage), particularly, free of acid photo-initiators which can generate acidic moieties that will act as charge traps. For example, in some embodiments, formulations for preparing dielectric materials according to the present teachings can be free of various photoinitiators commonly found in existing photocurable compositions (e.g., existing photocrosslinkable dielectric materials or photoresist materials) including ionic photoacid generators such as tris(4-(4-acetyl-phenylthio)phenyl)sulfonium tetrakis(pentafluorophenyl)borate (IRGACURE 290, BASF) and tris[4-[(4-acetylphenyl)thio]phenyl]sulfonium tris[(trifluoromethyl)sulfonyl]methanide (GSID26-1, BASF) and non-ionic photoacid generators such as 2-methyl-α-[2-[[(propylsulfonyl)oxy]imino]-3(2H)-thienylidene]benzeneacetonitrile (IRGACURE 103, BASF), 2-methyl-.alpha.-[2-[[[(4-methylphenyl)sulfonyl]oxy]imino]-3(2H)-thienylidene]benzeneacetonitrile (IRGACURE 121, BASF). However, in other cases such photoinitiators can be employed.

In using the present polymers to prepare a colored dielectric polymer material (e.g., in the form of a film), it often is desirable to ensure that the dielectric material achieves a sufficient degree of crosslinking, such that subsequent device processing conditions will not jeopardize the properties of the dielectric material. A colored dielectric polymer material in film form can be considered “sufficiently crosslinked” if, after the crosslinking step, the thickness of the film does not decrease by more than about 10% when contacted for 5 minutes with the solvent used to prepare the film (the “mother solvent”). In addition or alternatively, a colored dielectric polymer material can be considered “sufficiently crosslinked” if, after the crosslinking step, the leakage current does not increase by more than about 5 times at 2 MV/cm after the crosslinked dielectric film has been contact with the mother solvent for 5 minutes.

Subsequent to crosslinking, the colored dielectric polymer material of the present teachings can be subject to further patterning and process steps, by which additional layers, including additional dielectric, semiconductor and/or conducting layers, can be formed on top of the dielectric material.

The transparent conduct oxide electrode as otherwise described herein may be prepared according to methods known to the person of ordinary skill in the art. For example, in certain embodiments, the transparent conducting oxide electrode is deposited on the colored dielectric polymer material film through spluttering followed by annealing.

Advantageously, in various embodiments the colored dielectric polymer material as otherwise described herein resists degradation due to the sputtering and/or annealing steps during deposition of a transparent conducting oxide. Accordingly, in certain embodiments as otherwise described herein, the intensity of the maximum transmittance of the colored dielectric polymer material after sputtering and annealing is within 20% of the intensity of the maximum transmittance prior to sputtering and annealing, and/or the intensity of the maximum absorbance in an absorbing region in the visible spectrum is within 20% of the intensity of the maximum absorbance prior to sputtering and annealing. In addition, the breakdown voltage and leakage current of the colored dielectric polymer material film is not significantly affected by sputtering and annealing of conductive oxide films. For example, in certain embodiments, the breakdown voltage is within 20% of the breakdown voltage prior to sputtering and annealing. In certain embodiments as otherwise described herein, the leakage current of the colored dielectric polymer material is within 20% of the leakage current prior to sputtering and annealing.

In various desirable aspects the colored dielectric polymer material of the disclosure is in contact with a transparent conducting oxide film, such as an indium-tin oxide film. As noted above and described below, the present inventors have determined that the colored dielectric polymer materials described herein can be especially stable, even under the rigorous conditions used to process transparent conducting oxides, and under other conditions used in patterning and processing of thin-film devices.

Thus, in another aspect, the present disclosure provides for a device incorporating a colored dielectric polymeric material as described herein. In various such embodiments as otherwise described herein, the device comprises the colored dielectric polymer material in contact with a transparent conducting oxide.

Transparent conducting oxides are generally known in the art. For example, the transparent conducting oxide may be indium tin oxide (ITO), zinc tin oxide (ZTO), cadmium tin oxide, (CTO), or fluoride-doped tin oxide (FTO).

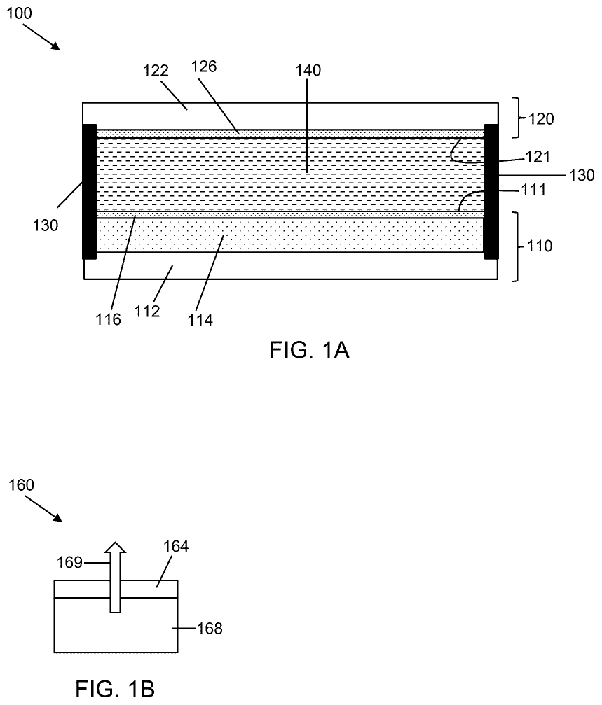

One example of a device is a liquid crystal cell as shown cross-sectional schematic view in FIG. 1A. Here, the liquid crystal cell 100 includes a first cell plate 110 having a top surface 111. The first cell plate includes a first transparent substrate 112 (e.g., glass); disposed on the first transparent substrate, the colored dielectric polymer material 114; and disposed on the colored dielectric polymer material, a first transparent conducting oxide film 116 (e.g., ITO), the transparent conducting oxide being within 100 nm of the top surface of the first cell plate. In this example, the first transparent conducting oxide film 116 forms the fop surface of the first cell plate, but the person or ordinary skill in the art will appreciate that one or more thin layers of other materials may be provided on the conducting oxide surface. The liquid crystal cell 100 also includes a second cell plate 120 having a top surface 121. The second cell plate includes a second transparent substrate 122 (e.g., glass); disposed on the second transparent substrate, a second transparent conducting oxide film 126 (e.g., ITO), the transparent conducting oxide being within 100 nm of the top surface of the second cell plate. Here, too, one or more thin layers of other materials may be provided on the conducting oxide surface. Moreover, a colored dielectric film can be provided in the second cell plate, in much the same way as in the first cell plate. One or more spacers 130 are disposed between the top surface of the first cell plate and the top surface of the second cell plate, the one or more spacers defining lateral edges of the liquid crystal cell. And a liquid crystal material 140 is disposed in a volume defined by the top surface of the first cell plate, the top surface of the second cell plate, and the one or more spacers.

As the person of ordinary skill in the art will appreciate, optical properties of the liquid crystal material can be adjusted by adjusting a potential between the first and second conductive oxide layers. The optical properties of the liquid crystal can, in turn, determine whether light passes through the system. As the person of ordinary skill in the art will appreciate, in a conventional liquid crystal display the polarization of the liquid crystal can be tuned by the potential applied between the first and second conductive oxide layers, thus controlling the transmittance of the light between two 90° aligned polarizer films. Other liquid crystal display types can be used as well, such as reflective type LCDs.

But the materials described herein can be used in a variety of other devices, for example, to provide colored light (e.g., as from a colored pixel). One embodiment of such a device is shown in schematic view in FIG. 1B. In device 160, a colored dielectric polymer material of the disclosure 164 is operatively coupled to a light source 168, configured to filter light emanating from the light source in a display direction 169. The light source can be, e.g., a relatively large light source, with a number of different colored film sections of colored dielectric polymer material, e.g., as part of a liquid crystal display, or can be configured as a single LED pixel (e.g., a single OLED) pixel, with a LED or OLED source and a section of a colored material of the disclosure. In various embodiments, the device can optionally include conductive oxide layer, as described above, formed on or adjacent the colored dielectric film. The materials described herein can also be adapted to provide a color filter for ambient light with respect to an observer.

In fact, the present disclosure provides for a variety of devices that include a colored dielectric polymer material in contact with a transparent conducting oxide. As demonstrated here, the materials of the disclosure are surprisingly robust to the deposition and annealing conditions used to make such conductive oxides.

In another aspect, the present disclosure provides methods for making a device as otherwise described herein. In certain embodiments, the method comprises: forming a film of the colored dielectric polymer material; depositing a transparent conducting oxide electrode through sputtering adjacent the film of the colored dielectric polymer material (e.g., on the film); and annealing at a temperature of at least 200° C. (e.g., at least 220° C.) for a time in the range of 10 minutes to 24 hours.

Photolithography is a process for patterning electronic components. Accordingly, in certain embodiments as otherwise described herein, the method of making a device further comprises a photolithography process. In particular embodiments, the photolithography process comprising: applying a photoresist layer; irradiation through a patterned photo mask, developing the patterned photoresist layer, dry-etching the exposed underneath film and stripping the remaining photoresist layer (positive photolithography process). Alternatively, the photolithography process can be accomplished by directly exposing the organic film under irradiation through a patterned photo mask, and develop the un-crosslinked film with an organic solvent (negative photolithography process). Either photolithography process can, in certain embodiments result in a pattern with a resolution of no more than 10 μm (e.g., no more than 8 μm), and wherein the intensity of the maximum transmittance changes by no more than 20% following the photolithography process.

### Definitions

Terms used herein may be preceded and/or followed by a single dash, “—”, or a double dash, “═”, to indicate the bond order of the bond between the named substituent and its parent moiety; a single dash indicates a single bond and a double dash indicates a double bond or a pair of single bonds in the case of a spiro-substituent. In the absence of a single or double dash it is understood that a single bond is formed between the substituent and its parent moiety; further, substituents are intended to be read “left to right” with reference to the chemical structure referred to unless a dash indicates otherwise. For example, arylalkyl, arylalkyl-, and -alkylaryl indicate the same functionality.

For simplicity, chemical moieties are defined and referred to throughout primarily as univalent chemical moieties (e.g., alkyl, aryl, etc.) or divalent chemical moieties (e.g., alkylene, alkenylene). Nevertheless, such terms are also used to convey corresponding multivalent moieties under the appropriate structural circumstances clear to those skilled in the art. For example, while an “alkyl” moiety can refer to a monovalent radical (e.g., CH₃—CH₂—), in some circumstances a bivalent linking moiety can be “alkyl,” in which case those skilled in the art will understand the alkyl to be a divalent radical (e.g., —CH₂—CH₂—), which is equivalent to the term “alkylene.” (Similarly, in circumstances in which a divalent moiety is required and is stated as being “aryl,” those skilled in the art will understand that the term “aryl” refers to the corresponding divalent moiety, arylene). All atoms are understood to have their normal number of valences for bond formation (i.e., 4 for carbon, 3 for N, 2 for O, and 2, 4, or 6 for S, depending on the oxidation state of the S). Nitrogens in the presently disclosed compounds can be hypervalent, e.g., an N-oxide or tetrasubstituted ammonium salt. On occasion a moiety may be defined, for example, as —B-(A)ₐ, wherein a is 0 or 1. In such instances, when a is 0 the moiety is —B and when a is 1 the moiety is —B-A.

As used herein, a “polymer” or “polymeric compound” refers to a molecule (e.g., a macromolecule) including a plurality of repeating units connected by covalent chemical bonds. A polymer can be represented by the general formula:

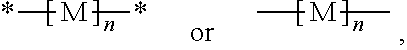

wherein M is the repeating unit or monomer, and n is the number of M's in the polymer. The polymer or polymeric compound can have only one type of repeating unit as well as two or more types of different repeating units. In the former case, the polymer can be referred to as a homopolymer. In the latter case, the term “copolymer” or “copolymeric compound” can be used instead, especially when the polymer includes chemically significantly different repeating units. The polymer or polymeric compound can be linear or branched. Branched polymers can include dendritic polymers, such as dendronized polymers, hyperbranched polymers, brush polymers, and the like. Unless specified otherwise, the assembly of the repeating units in the copolymer can be head to tail, head to head, or tail to tail. In addition, unless specified otherwise, the copolymer can be a random copolymer, an alternating copolymer, or a block copolymer. In some embodiments, formulae similar to the one below can be used to represent a copolymer, and such formula should be interpreted to embrace a copolymer having any repeating pattern consisting of x⁰% of M¹, y⁰% of M², and z⁰% of M³, where M¹, M², and M³ are different repeating units:

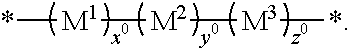

That is, the order and orientation of M¹, M², and M³ are not intended to be specific, and the formula is intended to encompass alternating, random, and block copolymers of M¹, M², and M³.

As used herein, a “pendant group” or “side group” is part of a repeating unit of a polymer and refers to a moiety that is attached covalently to the backbone of the polymer. As used herein, a “photopolymer” refers to a polymer that can be cured, for example, crosslinked by exposure to light, often using light in the ultraviolet region of the spectrum, or other types of radiation.

As used herein, “solution-processable” refers to polymers, materials, or composition that can be used in various solution-phase processes including spin-coating, printing (e.g., inkjet printing, screen printing, pad printing, offset printing, gravure printing, flexographic printing, lithographic printing, mass-printing and the like), spray coating, electrospray coating, drop casting, slot-die coating, dip coating, and blade coating. “Solution processable” also includes dispersion of polymers, materials, or compositions as long as they can be processes by the processes mentioned above.

As used herein, “halo” or “halogen” refers to fluoro, choro, bromo, or iodo. As used herein, “oxo” refers to a double-bonded oxygen (i.e., ═O).

As used herein, “alkyl” refers to a straight-chain or branched saturated hydrocarbon group. Examples of alkyl groups include methyl, ethyl, propoyl (e.g., n-propyl or iso-propyl), butyl (e.g., n-butyl, iso-butyl, sec-butyl, tert-butyl), pentyl groups (e.g., n-pentyl, iso-pentyl, neopentyl), hexyl groups, and the like. In various embodiments, an alkyl group can have 1 to 40 carbon atoms (i.e., C₁₋₄₀ alkyl group), for example, 1-20 carbon atoms (i.e., C₁₋₂₀ alkyl group). In some embodiments, an alkyl group can have 1 to 6 carbon atoms, and can be referred to as a “lower alkyl group.” Examples of lower alkyl groups include methyl, ethyl, propyl (e.g., n-propyl and iso-propyl), butyl (e.g., n-butyl, iso-butyl, sec-butyl, tert-butyl), pentyl groups (e.g., n-pentyl, iso-pentyl, neopentyl), and hexyl groups. In some embodiments, alkyl groups can be substituted as otherwise described herein.

As used herein, “haloalkyl” refers to an alkyl group having one or more halogen substituents. At various embodiments, a haloalkyl group can have 1 to 40 carbon atoms (i.e., C₁₋₄₀ haloalkyl group), for example, 1 to 20 carbon atoms (i.e., C₁₋₂₀ haloalkyl group). Examples of haloalkyl groups include CF₃, C₂F₅, CHF₂, CH₂F, CC1₃, CHC1₂, CH₂C1, C2Cl5, and the like. Perhaloalkyl groups, i.e., alkyl groups where all of the hydrogen atoms are replaced with halogen atoms (e.g., CF₃ and C₂F₅), are included within the definition of “haloalkyl.” For example, a C₁₋₄₀ haloalkyl group can have the formula —C_{z}H_{2z+1-t}X⁰t, where X⁰, at each occurrence, is F, Cl, Br or I, z is an integer in the range of 1 to 40, and t is an integer in the range of 1 to 81, provided that t is less than or equal to 2z+l. Haloalkyl groups that are not perhaloalkyl groups can be substituted as described herein.

As used herein, “alkoxy” refers to —O-alkyl group. Examples of alkoxy groups include, but are not limited to, methoxy, ethoxy, propoxy (e.g., n-propoxy and isopropoxy), t-butoxy, pentoxyl, hexoxyl groups, and the like. The alkyl group in the —O-alkyl group can be substituted as described herein.

As used herein, “alkylthio” refers to an —S-alkyl group. Examples of alkylthio groups include, but are not limited to, methylthio, ethylthio, propylthio (e.g., n-propylthio and isopropylthio), t-butylthio, pentylthio, hexylthio groups, and the like. The alkyl group in the —S-alkyl group can be substituted as described herein.

As used herein, “alkenyl” refers to a straight-chain or branched alkyl group having one or more carbon-carbon double bonds. Examples of alkenyl groups include ethenyl, propenyl, butenyl, pentenyl, hexenyl, butadienyl, pentadienyl, hexadienyl groups, and the like. The one or more carbon-carbon double bonds can be internal (such as in 2-butene) or terminal (such as in 1-butene). In various embodiments, an alkenyl group can have 2 to 40 carbon atoms (i.e., C₂-4o alkenyl group), for example, 2 to 20 carbon atoms (i.e., C2-20 alkenyl group). In some embodiments, alkenyl groups can be substituted as described herein. An alkenyl group is generally not substituted with another alkenyl group, an alkyl group, or an alkynyl group.

As used herein, “alkynyl” refers to a straight-chain or branched alkyl group having one or more triple carbon-carbon bonds. Examples of alkynyl groups include ethynyl, propynyl, butynyl, pentynyl, hexynyl, and the like. The one or more triple carbon-carbon bonds can be internal (such as in 2-butyne) or terminal (such as in 1-butyne). In various embodiments, an alkynyl group can have 2 to 40 carbon atoms (i.e., C₂₋₄₀ alkynyl group), for example, 2 to 20 carbon atoms (i.e., C₂₋₂₀ alkynyl group). In some embodiments, alkynyl groups can be substituted as described herein. An alkynyl group is generally not substituted with another alkynyl group, an alkyl group, or an alkenyl group.

As used herein, “cyclic” refers to an organic closed-ring group including cycloalkyl groups, aryl groups, cycloheteroalkyl groups, and heteroaryl groups as defined herein.

As used herein, “cycloalkyl” refers to a non-aromatic carbocyclic group including cyclized alkyl, cyclized alkenyl, and cyclized alkynyl groups. In various embodiments, a cycloalkyl group can have 3 to 40 carbon atoms (i.e., C3-40 cycloalkyl group), for example, 3 to 20 carbon atoms. A cycloalkyl group can be monocyclic (e.g., cyclohexyl) or polycyclic (e.g., containing fused, bridged, and/or spiro ring systems), where the carbon atoms are located inside the ring system. Any suitable ring position of the cycloalkyl group can be covalently linked to the defined chemical structure. Examples of cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcaryl, adamantyl, and spiro[4.5]decanyl groups, as well as their homologs, isomers, and the like. In some embodiments, cycloalkyl groups can be substituted as described herein.

As used herein, “heteroatom” refers to an atom of any element other than carbon or hydrogen and includes, for example, nitrogen, oxygen, silicon, sulfur, phosphorus, and selenium.

As used herein, “cycloheteroalkyl” refers to a non-aromatic cycloalkyl group that contains at least one ring heteroatom selected from O, S, Se, N, P, and Si (e.g., O, S, and N), and optionally contains one or more double or triple bonds. A cycloheteroalkyl group can have 3 to 40 ring atoms (i.e., 3-40 membered cycloheteroalkyl group), for example, 3 to 20 ring atoms. One or more N, P, S, or Se atoms (e.g., N or S) in a cycloheteroalkyl ring may be oxidized (e.g., morpholine N-oxide, thiomorpholine S-oxide, thiomorpholine S,S-dioxide). In some embodiments, nitrogen or phosphorus atoms of cycloheteroalkyl groups can bear a substituent, for example, a hydrogen atom, an alkyl group, or other substituents as described herein. Cycloheteroalkyl groups can also contain one or more oxo groups, such as oxopiperidyl, oxooxazolidyl, dioxo-(IH,3H)-pyrimidyl, oxo-2(IH)-pyridyl, and the like. Examples of cycloheteroalkyl groups include, among others, morpholinyl, thiomorpholinyl, pyranyl, imidazolidinyl, imidazolinyl, oxazolidinyl, pyrazolidinyl, pyrazolinyl, pyrrolidinyl, pyrrolinyl, tetrahydrofuranyl, tetrahydrothiophenyl, piperidinyl, piperazinyl, and the like. In some embodiments, cycloheteroalkyl groups can be substituted as described herein.

As used herein, “aryl” refers to an aromatic monocyclic hydrocarbon ring system or a polycyclic ring system in which two or more aromatic hydrocarbon rings are fused (i.e., having a bond in common with) together or at least one aromatic monocyclic hydrocarbon ring is fused to one or more cycloalkyl and/or cycloheteroalkyl rings. An aryl group can have 6 to 40 carbon atoms in its ring system, which can include multiple fused rings. In some embodiments, a polycyclic aryl group can have from 8 to 40 carbon atoms. Any suitable ring position of the aryl group can be covalently linked to the defined chemical structure. Examples of aryl groups having only aromatic carbocyclic ring(s) include phenyl, 1-naphthyl (bicyclic), 2-naphthyl (bicyclic), anthracenyl (tricyclic), phenanthrenyl (tricyclic), and like groups. Examples of polycyclic ring systems in which at least one aromatic carbocyclic ring is fused to one or more cycloalkyl and/or cycloheteroalkyl rings include, among others, benzo derivatives of cyclopentane (i.e., an indanyl group, which is a 5,6-bicyclic cycloalkyl/aromatic ring system), cyclohexane (i.e., a tetrahydronaphthyl group, which is a 6,6-bicyclic cycloalkyl/aromatic ring system), imidazoline (i.e., a benzimidazolinyl group, which is a 5,6-bicyclic cycloheteroalkyl/aromatic ring system), and pyran (i.e., a chromenyl group, which is a 6,6-bicyclic cycloheteroalkyl/aromatic ring system). Other examples of aryl groups include benzodioxanyl, benzodioxolyl, chromanyl, indolinyl groups, and the like. In some embodiments, aryl groups can be substituted as described herein. In some embodiments, an aryl group can have one or more halogen substituents, and can be referred to as a “haloaryl” group. Perhaloaryl groups, i.e., aryl groups where all of the hydrogen atoms are replaced with halogen atoms (e.g., —C₆F₅), are included within the definition of “haloaryl.” In certain embodiments, an aryl group is substituted with another aryl group and can be referred to as a biaryl group. Each of the aryl groups in the biaryl group can be substituted as disclosed herein.

As used herein, “heteroaryl” refers to an aromatic monocyclic ring system containing at least one ring heteroatom selected from oxygen (O), nitrogen (N), sulfur (S), silicon (Si), and selenium (Se) or a polycyclic ring system where at least one of the rings present in the ring system is aromatic and contains at least one ring heteroatom. Polycyclic heteroaryl groups include two or more heteroaryl rings fused together and monocyclic heteroaryl rings fused to one or more aromatic carbocyclic rings, non-aromatic carbocyclic rings, and/or non-aromatic cycloheteroalkyl rings. A heteroaryl group, as a whole, can have, for example, 5 to 40 ring atoms and contain 1-5 ring heteroatoms. The heteroaryl group can be attached to the defined chemical structure at any heteroatom or carbon atom that results in a stable structure. Generally, heteroaryl rings do not contain O—O, S—S, or S—O bond. However, one or more N or S atoms in a heteroaryl group can be oxidized (e.g., pyridine N-oxide, thiophene S-oxide, thiophene S,S-dioxide).

Each of the references disclosed herein is hereby incorporated herein by reference in its entirety for all purposes, and especially for the referenced teachings. The person of ordinary skill in the art will appreciate that the referenced teachings can be applied to the technology of the disclosure, and will appreciate that such teachings are incorporated herein as if explicitly set forth.

### EXAMPLES

The Examples that follow are illustrative of specific embodiments of the methods of the disclosure, and various uses thereof. They are set forth for explanatory purposes only, and are not to be taken as limiting the scope of the disclosure.

Chemical reagent palladium (II) acetate (Pd(OAc)₂), tri-tertbutyl phosphine (t-Bu₃P), sodium tert-butoxide (t-BuONa), potassium carbonate, hexamethylenediamine (4), 4,7,10-trioxa-1,13-tridecanediamine (8), diphenylamine, eugenol (11), 1-chloroanthraquinone (13), 4-tert-butylphenol (28), bisphenol M (23), benzoyl chloride, and thiophenol were purchased from Sigma Aldrich (Milwaukee, Wis., USA) and used as is without additional purification. PHEMA was purchased from Scientific Polymer Products Inc (Ontario, New York, USA). Coumaric acid (44) was purchased from Oakwood Products Inc (Estill, SC, USA). Anhydrous solvent dimethylformamide (DMF), N-methyl-2-pyrrolidone (NMP), and toluene were purchased from Sigma Aldrich (Milwaukee, Wis., USA). Solvent dichloromethane, methanol, hexane, and ethyl acetate were purchased from VWR (Radnor, PA, USA). Compound 6-bromobenzo[de]isochromene-1,3-dione (3), 4-chloro-1,8-naphthalic anhydride (20), and bis(4-(tert-butyl)phenyl)amine (32) were purchased from Ambeed Inc. (Arlington Heights, IL, USA). Reagents 1, 10, 27, and 42 were synthesized according to procedures that were reported in the literature (See (a) Tang, G. et al. J. Phys. Chem. C 2019, 123, 30171-30186; (b). Chao, C. C. et al. J. Org. Chem. 2005, 70, 4323-4331. (c) Schmidt, C. D. et al. Chem. Eur. J. 2011, 17, 5289-5299. (d) Tanaka, H. et al. J. Polym. Sci. Part A-1, 1972, 10, 1729-1743). Conventional Schlenk techniques were used, and reactions were carried out under nitrogen or argon unless otherwise noted. Characterization data are provided in some cases by ¹H NMR, and optical absorption spectroscopy. NMR spectra were recorded on an Inova 500 NMR spectrometer (1H, 500 MHz).

### Example 1: Synthesis of Dye-59

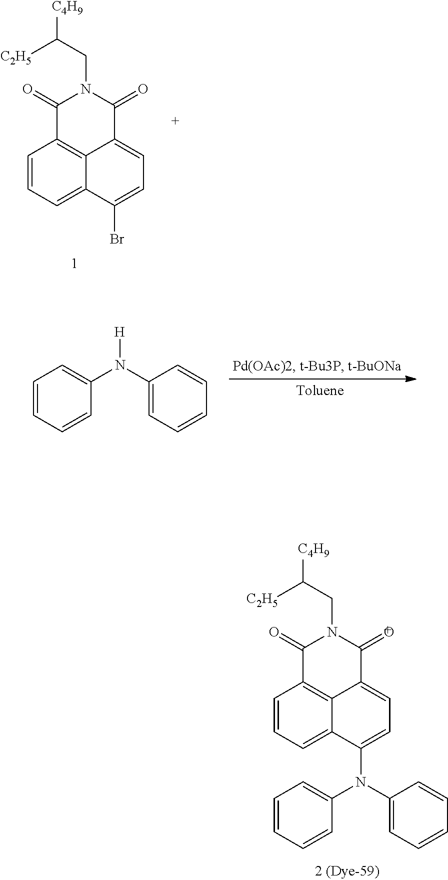

Compound 1 (1.01 g, 2.6 mmol) was added to a solution of diphenylamine (0.53 g, 3.1 mmol), Pd(OAc)₂ (0.12 g, 0.5 mmol), t-Bu₃P (0.21 g, 1.0 mmol) and t-BuONa (1.95 g, 20.0 mmol) in anhydrous toluene (50 mL) under nitrogen. The mixture was stirred at 100° C. overnight then cooled to room temperature, followed by quenching with 1M HCl solution (50 mL). The layers were separated, and the organic layer was washed with 1M HCl (1×50 mL), dried over anhydrous sodium sulfate, and concentrated. Purification by column chromatography using 3:1 dichloromethane/hexane as eluent gave an orange solid as the product (Compound 2, Dye-59) (0.81 g, 65%). ¹H NMR (500 MHz, CDCl₃). δ (ppm): 8.53 (dd, J=7.3, J=1.1 Hz, 1H), 8.50 (d, J=8.0 Hz, 1H), 8.17 (dd, J=8.5, J=1.2 Hz, 1H), 7.50 (m, 1H), 7.38 (d, J=8.1 Hz, 1H), 7.25 (m, 5H), 7.05 (m, 5H), 4.12 (m, 2H), 1.95 (m, 1H), 1.43-1.24 (m, 8H), 0.91 (m, 6H).

### Example 2: Synthesis of Dye-117

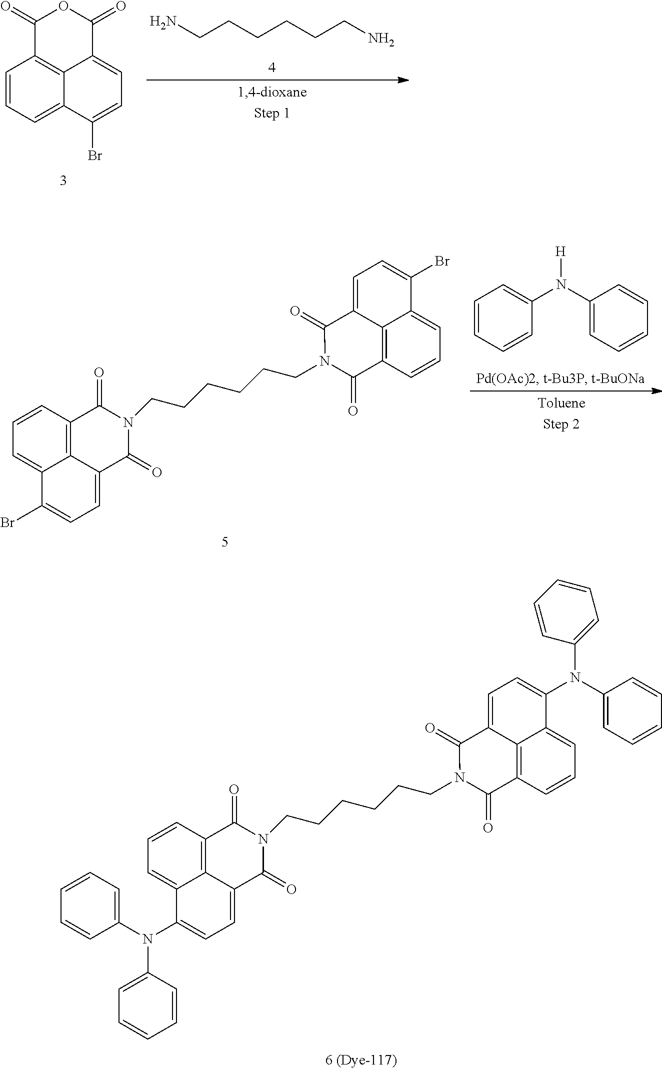

Step 1: Under nitrogen, a mixture of compound 3 (6.82 g, 24.6 mmol), diamine compound 4 (1.43 g, 12.3 mmol) in 1,4-dioxane (50 mL) was stirred at refluxing for about 20 hours. Upon cooling to rt, the precipitates were collected by vacuum filtration, rinsed with 1,4-dioxane and methanol, and dried in vacuum, leading a pale-yellow solid as the product, which was used directly for next step without further purification (Compound 5, 6.85 g, 87.7%). ¹H NMR, (500 MHz, CDCl₃), δ(ppm): 8.63 (dd, J=7.5 Hz, J=1.0 Hz, 2H), 8.56 (dd, J=8.5 Hz, J=1.0 Hz, 2H), 8.39 (d, J=8.0 Hz, 2H), 8.03 (d, J=7.5 Hz, 2H), 7.84 (dd, J=8.5 Hz, J=7.0 Hz, 2H), 4.17 (tr, J=7.5 Hz, 4H), 1.75 (m, br, 4H), 1.50 (m, br, 4H).

Step 2: Under Ar, a mixture of compound 5 (0.54 g, 0.85 mmol), diphenylamine (0.36 g, 2.13 mmol), Pd(OAc)₂ (67.3 mg, 0.30 mmol), t-Bu₃P (96.0 mg, 0.60 mmol), and t-BuONa (1.12 g, 11.7 mmol) in anhydrous toluene (40 mL) was heated to about 120° C. and maintained at this temperature for about 5 hours. Upon cooling to rt, water (˜40 mL) was added, followed by addition of ethyl acetate (˜100 mL). The mixture was stirred and separated. The water layer was extracted with ethyl acetate (˜100 mL). Organic layers were combined, washed with water and brine, dried over anhydrous sodium sulfate, and concentrated in vacuo. The residue was treated with methanol, and the solid product was collected by vacuum filtration, rinsed with methanol, and dried in vacuum, leading to a brownish-yellow solid as the product (Compound 6, Dye-117) (0.3 g, 43.5%). ¹H NMR, (500 MHz, CDCl₃), δ(ppm): 8.47-8.52 (m, br, 4H), 8.16 (d, J=8.5 Hz, 2H), 7.45-7.50 (dd, J=8.5 Hz, J=7.5 Hz, 2H), 7.36 (d, J=8.0 Hz, 2H), 7.23-7.30 (m, br, 10 Hz), 7.00-7.10 (m, br, 10H), 4.18 (tr, J=7.5 Hz, 4H), 1.76 (m, br, 4H), 1.50 (m, br, 4H).

### Example 3: Synthesis of Dye-115

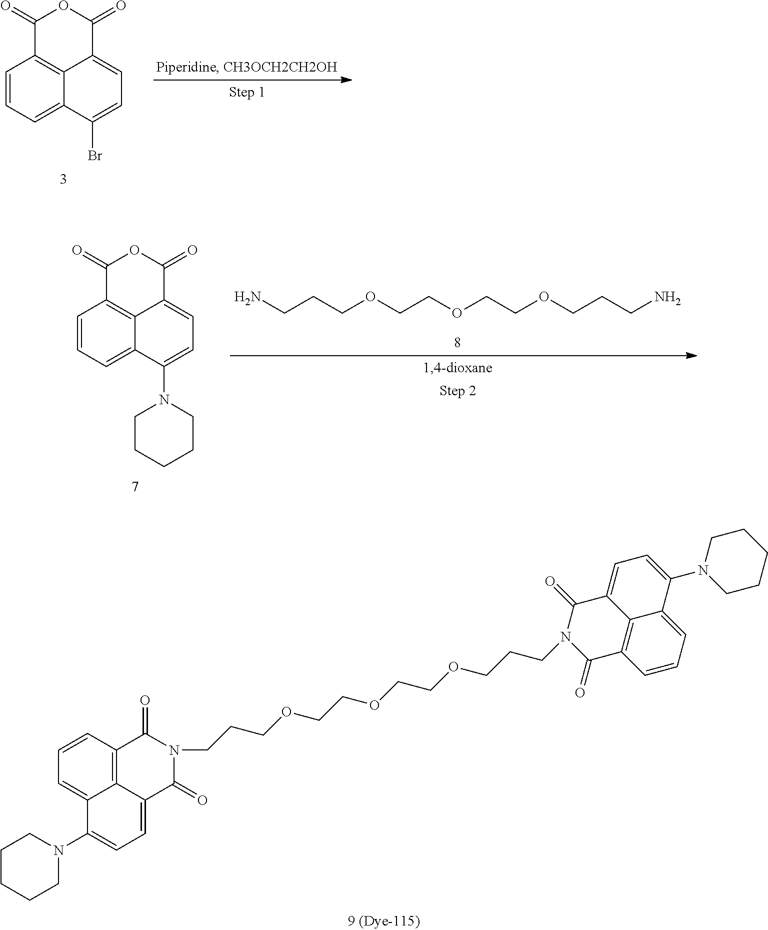 [SMILES: O=C1OC(=O)c2ccc(Br)c3cccc1c23 ; O=C1OC(=O)c2ccc(N3CCCCC3)c3cccc1c23 ; NCCCOCCOCCOCCCN ; O=C1c2cccc3c(N4CCCCC4)ccc(c23)C(=O)N1CCCOCCOCCOCCCN1C(=O)c2cccc3c(N4CCCCC4)ccc(c23)C1=O]

Step 1: A mixture anhydride compound 3 (10.26 g, 37.0 mmol) and piperidine (7.5 mL, 75.9 mmol) in methoxyethanol (80 mL) was stirred under argon for about 7 hours. Upon cooling to rt, the yellow/orange precipitates were collected by vacuum filtration, rinsed with methanol, and dried in vacuum, leading to a yellow/orange solid as the product (7), which was used directly for next step without further purification (8.3 g, 79.7%). ¹H NMR, (500 MHz, CDCl₃), δ(ppm): 8.57 (dd, J=7.5 Hz, J=1.0 Hz, 1H), 8.50 (d, J=8.5 Hz, 1H), 8.42 (dd, J=8.5 Hz, J=1.0 Hz, 1H) 7.71 (dd, J=8.5 Hz, J=7.5 Hz, 1H), 7.20 (d, J=8.5 Hz, 1H), 3.29 (t, J=5.0 Hz, 4H), 1.89 (m, br, 4H), 1.76 (m, br, 2H).

Step 2: Under Ar, a mixture of compound 7 (3.26 g, 11.6 mmol), diamine compound 8 (1.22 g, 5.6 mmol) in 1,4-dioxane (25 mL) was stirred at refluxing for about 5 hours. Upon cooling to rt, the volatile was removed in vacuo and the residue was recrystallized from a mixture of ethyl acetate and methanol, leading to a yellow solid as the product (Compound 9 (Dye-115), 3.8 g, 91.8%). ¹H NMR, (500 MHz, CDCl₃), δ(ppm): 8.35-8.50 (m, br, 6H), 7.60 (m, br, 2H), 7.14 (m, br, 2H), 4.18 (tr, J=7.0 Hz, 24H), 3.40-3.54 (m, br, 12H), 3.19 (s, br, 8H), 1.94 (m, br, 4H), 1.80-1.90 (m, br, 8H), 1.66 (m, br, 4H).

### Example 4: Synthesis of Dye-161

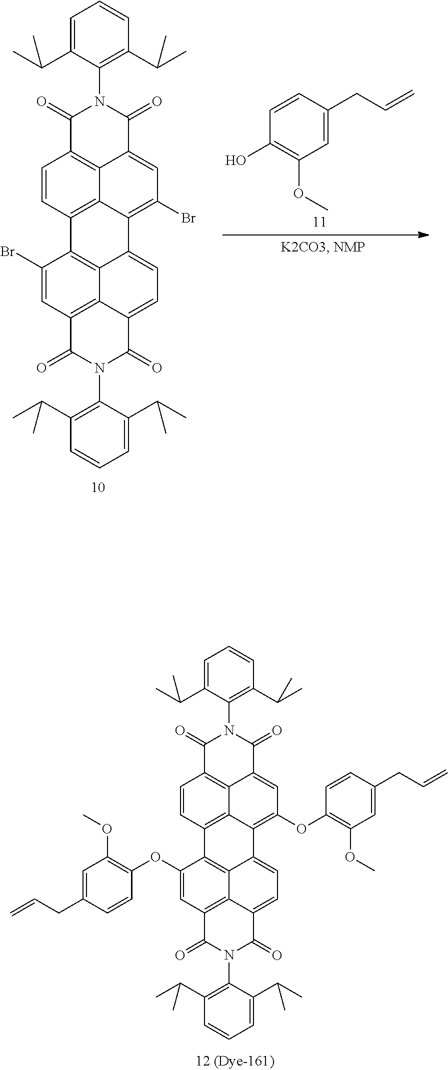 [SMILES: CC(C)c1cccc(C(C)C)c1N1C(=O)c2ccc3c4c(Br)cc5c6c(ccc(c7c(Br)cc(c2c37)C1=O)c64)C(=O)N(c1c(C(C)C)cccc1C(C)C)C5=O ; C=CCc1ccc(O)c(OC)c1 ; C=CCc1ccc(Oc2cc3c4c(ccc5c6c(Oc7ccc(CC=C)cc7OC)cc7c8c(ccc(c2c45)c86)C(=O)N(c2c(C(C)C)cccc2C(C)C)C7=O)C(=O)N(c2c(C(C)C)cccc2C(C)C)C3=O)c(OC)c1]

Under argon, a mixture of compound 10 (0.58 g, 0.66 mmol), phenol compound 11 (0.28 g, 1.71 mmol), and potassium carbonate (0.41 g, 2.97 mmol) in NMP was stirred at 40° C. for about 16 hours. Upon cooling to rt, the reaction mixture was poured into a 5% HCl solution (˜400 mL). The precipitates were collected by vacuum filtration, rinsed with water, and dried in vacuum. This crude was purified by column chromatography on silica gel with a mixture of dichloromethane/hexane=8/3 (v/v, up to neat dichloromethane) as eluent, leading to a dark red solid as the product (compound 12, Dye-161) (0.39 g, 56.9%). ¹H NMR, 500 MHz, (CDCl₃), δ(ppm) (the major 1,7-isomer of compound 10): 9.68 (d, J=8.5 Hz, 2H), 8.62 (d, J=8.5 Hz, 2H), 8.19 (s, 2H), 7.39 (m, br, 2H), 7.23-7.24 (d, J=80 Hz, 4H), 7.02 (d, J=8.5 Hz, 2H), 6.87 (d, J=2.0 Hz, 2H), 6.78-6.80 (dd, J=8.0 Hz, J=2.0 Hz, 2H), 5.95 (m, br 2H), 5.04-5.11 (m, br, 4H), 3.75 (s, 6H), 3.37 (d, J=6.5 Hz, 4H), 2.65 (m, br, 4H), 1.03-1.12 (m, br, 24H).

### Example 5: Synthesis of Dye-195

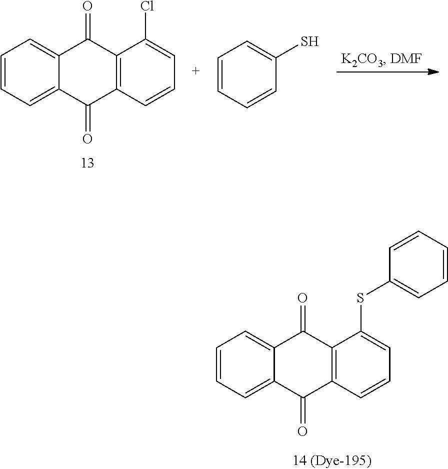

Under argon, a mixture of 1-chloroanthraquinone (compound 13) (2.02 g, 9.07 mmol), thiophenol (1.10 g, 9.98 mmol), and potassium carbonate (1.38 g, 9.98 mmol) in DMF was stirred at 80° C. for about 17 hours. Upon cooling to rt, the reaction mixture was filtered to remove the insoluble materials. The filtrate was mixed with methanol (˜100 mL) and the resulting mixture was stirred at rt for 15 mins. The precipitates were collected by vacuum filtration, rinsed with methanol, and dried in vacuum, leading to a yellow/orange solid as the product (compound 14, Dye-195) (2.0 g, 69.7%). ¹H NMR, 500 MHz, (CDCl₃), δ(ppm): 8.39 (d, J=7.0 Hz, 1H), 8.29 (d, J=7.0 Hz, 1H), 8.09 (d, J=7.5 Hz, 1H), 7.78-7.84 (m, br, 2H), 7.64 (m, br, 2H), 7.51 (m, br, 3H), 7.45 (m, br, 1H), 7.10 (d, J=8.0 Hz, 1H).

### Example 6: Synthesis of Dye-27

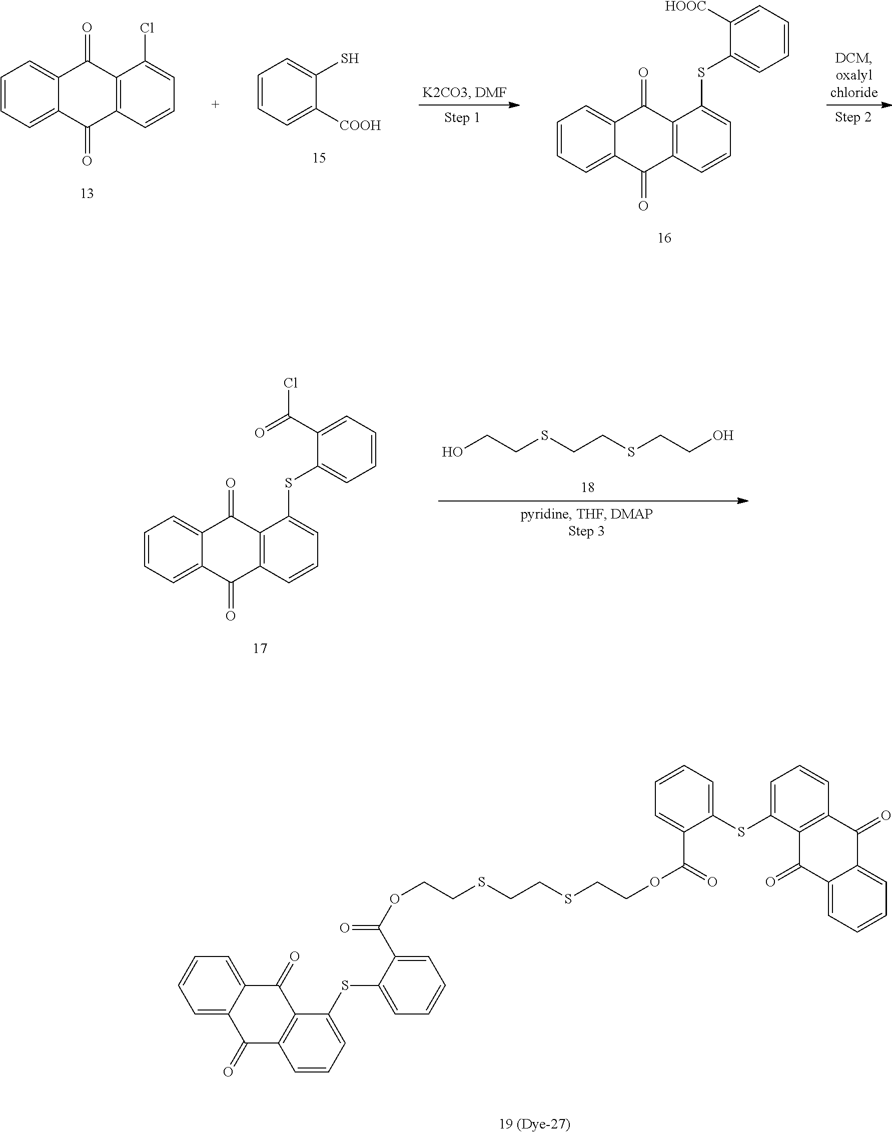 [SMILES: O=C1c2ccccc2C(=O)c2c(Cl)cccc21 ; O=C(O)c1ccccc1S ; O=C(O)c1ccccc1Sc1cccc2c1C(=O)c1ccccc1C2=O ; O=C(Cl)c1ccccc1Sc1cccc2c1C(=O)c1ccccc1C2=O ; OCCSCCSCCO ; O=C(OCCSCCSCCOC(=O)c1ccccc1Sc1cccc2c1C(=O)c1ccccc1C2=O)c1ccccc1Sc1cccc2c1C(=O)c1ccccc1C2=O]

Step 1: Under argon, a mixture of 1-chloroanthraquinone (compound 13) (12.1 g, 49.9 mmol), thiosalicylic acid 15 (7.7 g, 49.9 mmol), and potassium carbonate (7.0 g, 50.7 mmol) in DMF (100 mL) was stirred at 125° C. for about 6 hours. Upon cooling to rt, the reaction mixture was poured into water (˜200 mL), and the resulting mixture was stirred at rt for about 10 mins, before it was acidified by addition of acetic acid carefully (until pH˜5). The precipitates were collected by filtration, washed with warm water, and dried in vacuum, leading to a greenish-yellow solid as the product (compound 16) (16.8 g, 93.5%). ¹H NMR, 500 MHz, (DMSO-D6), δ(ppm): 8.25 (d, J=7.5 Hz, 1H), 8.20 (d, J=7.0 Hz, 1H), 7.90-8.05 (m, br, 3H), 7.81 (d, J=6.0 Hz, 1H), 7.55-7.70 (m, br, 4H), 7.06 (d, J=8.0 Hz, 1H).

Step 2: A mixture of compound 16 (2.3 g, 6.4 mmol) and oxalyl chloride (4 mL) in anhydrous DCM (100 mL) was stirred at rt for about 17 h, before all the volatiles were removed in vacuo. The residue was dried in vacuum, and it was then used directly for next step without further purification (Compound 17) (2.4 g, 99.2%). ¹H NMR, 500 MHz, (CD₂Cl₂), δ(ppm): 8.32 (dd, J=7.0 Hz, J=1.5 Hz, 1H), 8.26 (dd, J=7.5 Hz, J=1.5 Hz, 1H), 8.16 (m, br, 1H), 8.11 (dd, J=7.5 Hz, J=1.0 Hz, 1H), 7.78-7.86 (m, br, 2H), 7.74 (m, br, 1H), 7.63-7.70 (m, br, 2H), 7.48 (m, br, 1H), 7.02 (dd, J=8.0 Hz, J=10. Hz, 1H).

Step 3: Under nitrogen, diol 18 (0.46 g, 2.51 mmol) and DMAP (41.3 mg, 0.34 mmol) were placed in an oven-dried flask. Dry pyridine (8 mL) was then added, followed by addition of a mixture of acyl chloride 17 (2.4 g, 6.34 mmol) in dry THF (18 mL). The resulting mixture was stirred at rt for 16 hours, before it was quenched by addition of methanol (3 mL). The reaction was stirred at rt for additional 45 mins, before it was concentrated in vacuo. The residue was taken with ethyl acetate (200 mL), and the resulting mixture was washed with water (150 mL×2), dried over anhydrous sodium sulfate, and concentrated to about 20 mL in vacuo. This residue was precipitated in methanol (˜200 mL). The precipitates were collected by vacuum filtration, relished with methanol, and dried in vacuum, leading to brownish-yellow solid as the product (Compound 19, Dye-27) (1.6 g, 73.4%). ¹H NMR, 500 MHz, (CDCl₃), δ(ppm): 8.35 (d, J=7.0 Hz, 2H), 8.27 (d, J=7.0 Hz, 2H), 8.09 (d, J=7.5 Hz, 2H), 7.92 (m, br, 2H), 7.80 (m, br, 4H), 7.70 (m, br, 2H), 7.58 (m, br, 4H), 7.45 (m, br, 2H), 7.05 (d, J=8.0 Hz, 2H), 4.25 (t, J=7.0 Hz, 4H), 2.61 (t, J=7.0 Hz, 4H), 2.57 (s, 4H).

### Example 7: Synthesis of Dye-51

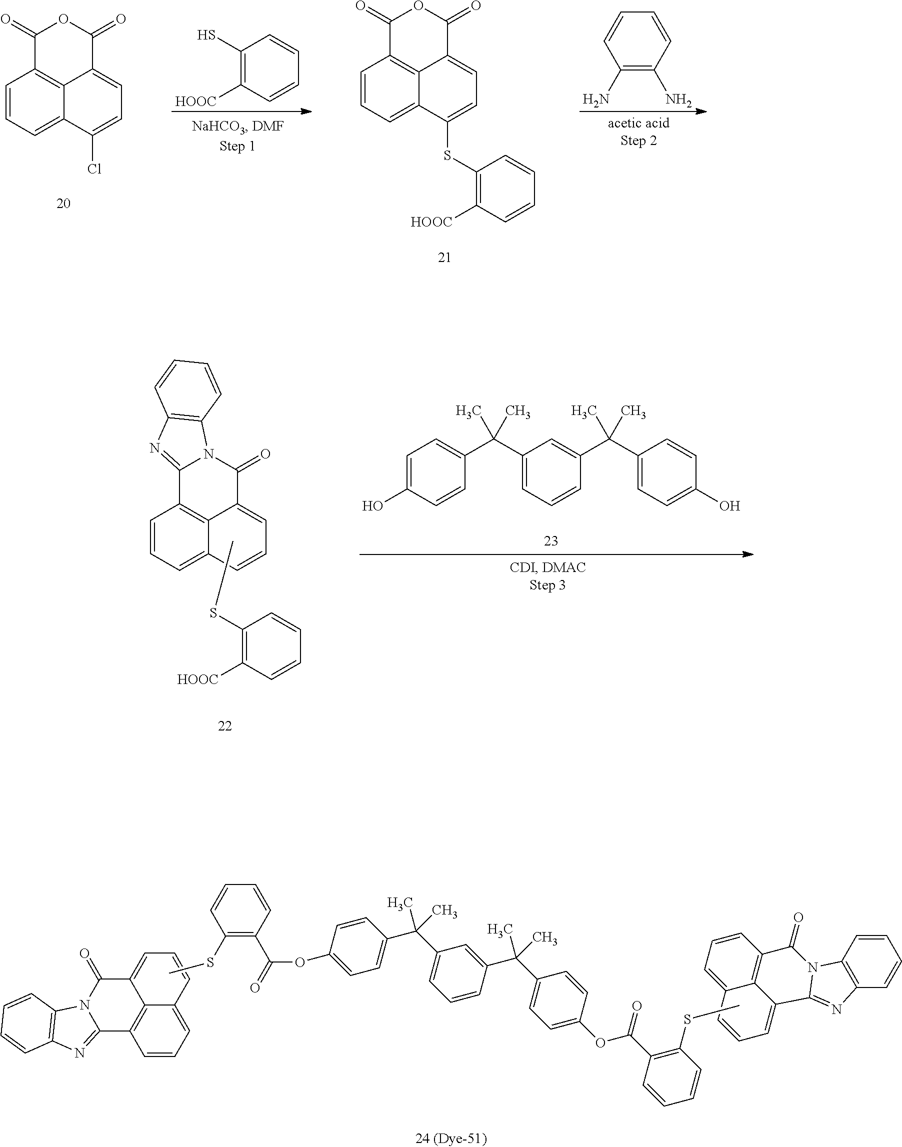

Step 1: Under argon, a mixture of compound 20 (12.7 g, 54.5 mmol), thiosalicylic acid 15 (12.6 g, 81.9 mmol), and sodium bicarbonate (4.92 g, 58.6 mmol) in DMF (150 mL) was stirred at 150-152° C. for about 6.5 hours. Upon cooling to rt, the reaction mixture was carefully acidified by adding 5% HCl solution. The resulting precipitates were collected by filtration, washed with water, and dried in vacuum, leading to a pale-yellow solid as the product (compound 21) (18.7 g, 97.9%). ¹H NMR, 500 MHz, (DMSO-D6), δ(ppm): 8.62 (dd, J=8.5 Hz, J=1.0 Hz, 1H), 8.58 (dd, J=7.0 Hz, J=1.0 Hz, 1H), 8.50 (d, J=7.5 Hz, 1H), 7.90-8.05 (m, br, 3H), 7.35 (m, br, 2H), 6.75 (m, br, 1H).

Step 2: A mixture of compound 21 (18.7 g, 53.4 mmol) and o-diaminobenzene (6.4 g, 58.7 mmol) in acetic acid (250 mL) was refluxed for about 7 h. Upon cooling to rt, the yellow solid was collected by vacuum filtration, rinsed with small portion of acetic acid and methanol, and dried in vacuum, leading to a yellow solid as the product (Compound 22 (two isomers not separated)) (18.7 g, 82.9%). ¹H NMR (mixture of two isomers), 500 MHz, (DMSO-D6), δ(ppm): 8.62-8.83 (m, br, 3H), 8.43-8.54 (m, br, 1H), 7.88-8.20 (m, br, 4H), 7.24-7.58 (m, br, 4H), 6.61-6.82 (m, br, 1H).

Step 3: Under nitrogen, a mixture of compound 22 (1.0 g, 2.4 mmol) and CDI (0.39 g, 2.4 mmol) in dry DMAc was stirred at 70° C. for about 3.5 h. Compound bisphenol M (23) (0.40 g, 1.15 mmol) was added via dry DMAc (6 mL). The resulting mixture was stirred at 70° C. for about 16 hours. Upon cooling to rt, the reaction mixture was precipitated in a mixture of methanol (400 mL) and water (50 mL). The precipitates were collected by vacuum filtration, rinsed with water and methanol, and dried in vacuum, leading a yellow solid the product (Compound 24, Dye-51) (0.18 g, 13.5%).

### Example 8: Synthesis of Dye-82

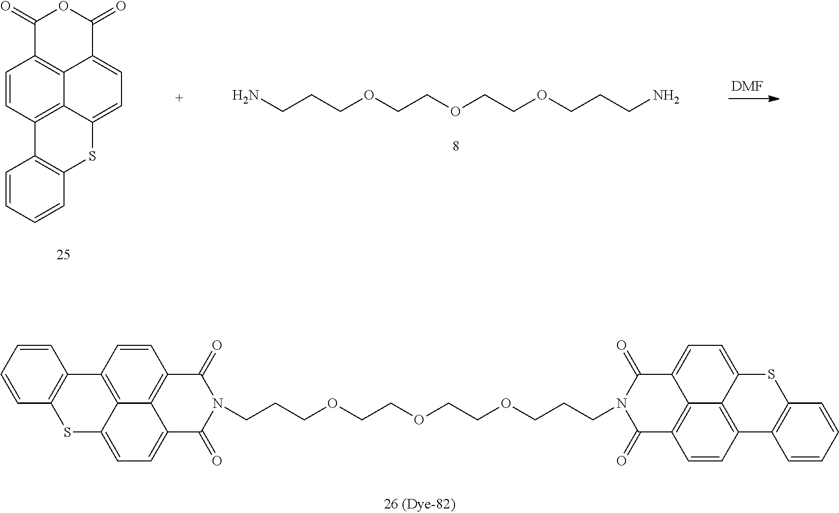

A solution of compound 25 (350 mg, 1.2 mmol) and 8 (121 mg, 0.5 mmol) in DMF (6 mL) was stirred at 100° C. under N₂ for 4 hours. The mixture was cooled to room temperature, precipitated into MeOH (30 mL), and collected by filtration. The solid was washed with MeOH (4×20 mL), EtOAc (4×20 mL) and then recrystallized from CHCl₃/EtOAc to give an orange solid as the product (Compound 26 (Dye-82)) (200 mg, 51%). ¹H NMR (500 MHz, CDCl₃), δ(ppm) 8.34 (d, 2H, J=8.18 Hz), 8.19 (d, 2H, J=8.0 Hz), 7.97 (m, 2H), 7.89 (d, 2H, J=8.33 Hz), 7.29 (m, 6H), 7.21 (m, 2H), 4.20 (t, 4H, J=7.35 Hz), 3.64 (m, 12H), 2.01 (m, 4H).

### Example 9: Synthesis of Dye-139

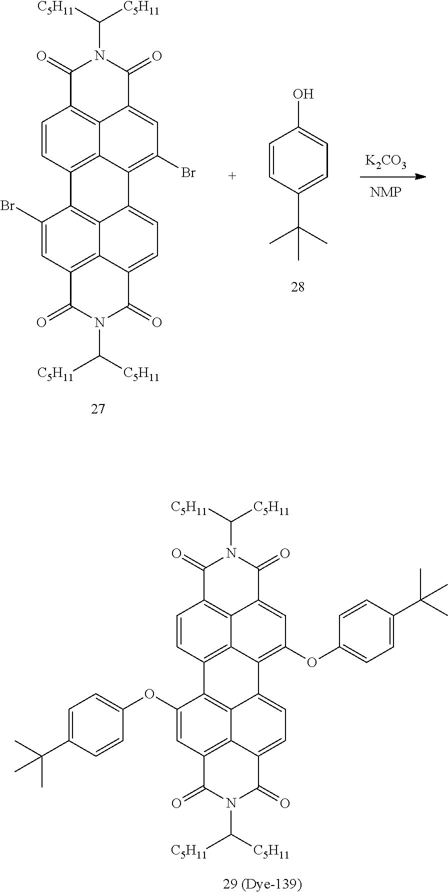

Under nitrogen, compounds 27 (180 mg, 0.2 mmol), phenol 28 (82 mg, 0.5 mmol) and potassium carbonate (180 mg, 1.3 mmol) were stirred in anhydrous NMP (5 mL) at 40° C. for about 3 h. Upon cooling to rt, the reaction solution was poured into 1 M HCl (200 mL) and the solid was collected by vacuum filtration. This crude was then purified by column chromatography on silica gel using a mixture of hexanes/DCM=2:1 (v/v) as eluent to give a red solid as the product (Compound 29, Dye-139) (170 mg, 81%). ¹H NMR (500 MHz, CDCl₃), δ(ppm): 9.61 (d, 2H, J=8.34 Hz), 8.58 (br, 2H), 8.35 (br, 2H), 7.47 (d, 4H, J=8.71 Hz), 7.11 (d, 4H, J=8.84 Hz), 5.12 (br, 2H), 2.18 (br, 4H), 1.80 (br, 4H), 1.38 (s, 18H) 1.24 (m, 24H), 0.81 (m, 12H).

### Example 10: Synthesis of Dye-49

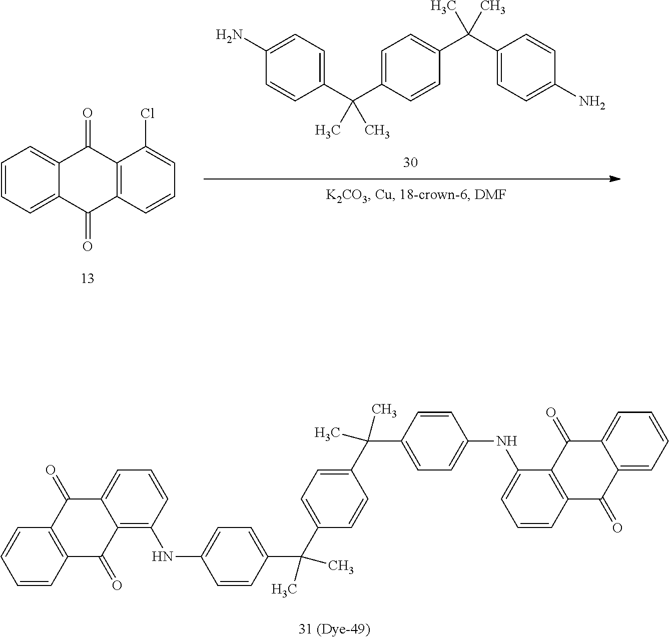 [SMILES: O=C1c2ccccc2C(=O)c2c(Cl)cccc21 ; CC(C)(c1ccc(N)cc1)c1ccc(C(C)(C)c2ccc(N)cc2)cc1 ; CC(C)(c1ccc(Nc2cccc3c2C(=O)c2ccccc2C3=O)cc1)c1ccc(C(C)(C)c2ccc(Nc3cccc4c3C(=O)c3ccccc3C4=O)cc2)cc1]

Under nitrogen, a mixture of compound 13 (12.5 g, 51.5 mmol), diamine compound 30 (4.45 g, 12.9 mmol), potassium carbonate (5.4 g, 39.1 mmol), copper (2.5 g, 39.3 mmol), 18-crown-6 (0.34 g, 1.3 mmol) in DMF (60 mL) was refluxed for about 20 hours. Upon cooling to rt, the insoluble material was filtered, and the filter cake was rinsed with small portion of DMF. The combined filtrate was precipitated in methanol (˜400 mL). The precipitates were collected by filtration, rinsed with water and methanol, dried in vacuum, leading to a red-purple solid as the product (Compound 31, (Dye-49)) (6.3 g, 64.4%). ¹H NMR, 500 MHz, (CDCl₃), δ(ppm): 11.4 (s, 2H), 8.39 (dd, J=8.5 Hz, J=2.0 Hz, 2H), 8.34 (dd, J=8.0 Hz, J=1.0 Hz, 2H), 7.76-7.88 (m, br, 6H), 7.58 (m, br, 4H), 7.27-7.39 (m, br, 12H), 1.78 (s, 12H).

### Example 11: Synthesis of Dye-119

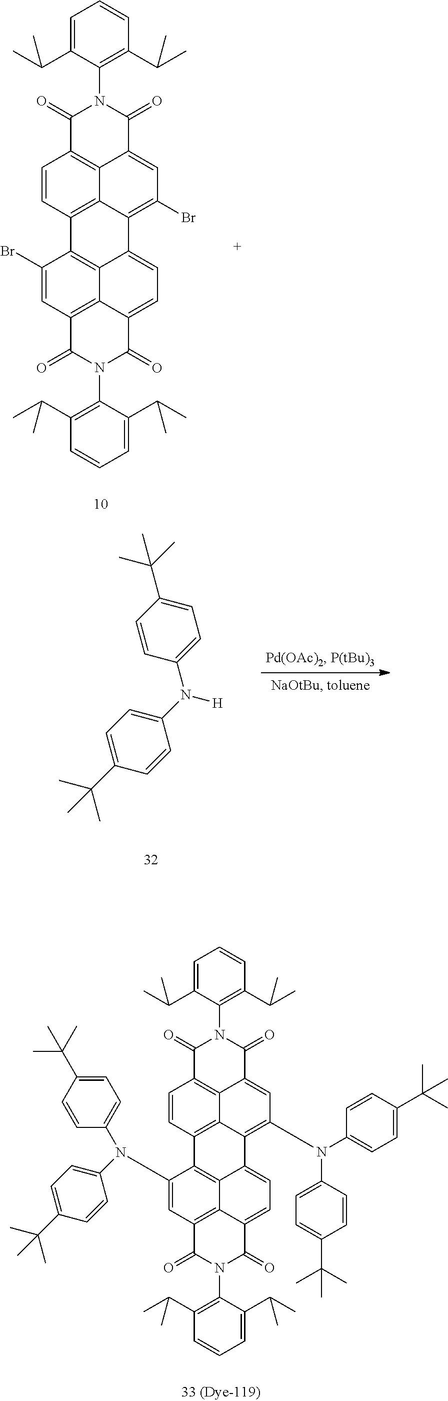

Under nitrogen, compound 10 (300 mg, 0.3 mmol) was added to a solution of 32 (233 mg, 0.8 mmol), palladium (II) acetate (31 mg, 0.1 mmol), tri-tertbutyl phosphine (56 mg, 0.3 mmol) and sodium tertbutoxide (518 mg, 5.4 mmol) in anhydrous toluene (15 mL). The resulting mixture was heated to 100° C. After stirring overnight, the mixture was cooled to room temperature and quenched with 1 M HCl (20 mL). The layers were separated, and the organic layer was washed with 1 M HCl (1×20 mL), dried over Na₂SO₄ and concentrated in vacuo. The crude was purified by column chromatography on silica gel using DCM as eluent to produce a bluish-green solid (Compound 33, Dye-119) (300 mg, 68%). ¹H NMR (500 MHz, CDCl₃), δ(ppm): 8.66 (d, 2H, J=8.18 Hz), 8.55 (s, 2H), 8.30 (d, 2H, J=8.09 Hz), 7.44 (m, 2H), 7.29 (m, 4H), 7.17 (d, 8H, J=8.77 Hz), 7.02 (d, 8H, J=8.84 Hz), 2.66 (m, 4H, J=6.46 Hz), 1.23 (br, 32H), 1.13 (m, 24H).

### Example 12: Synthesis of Dye-147

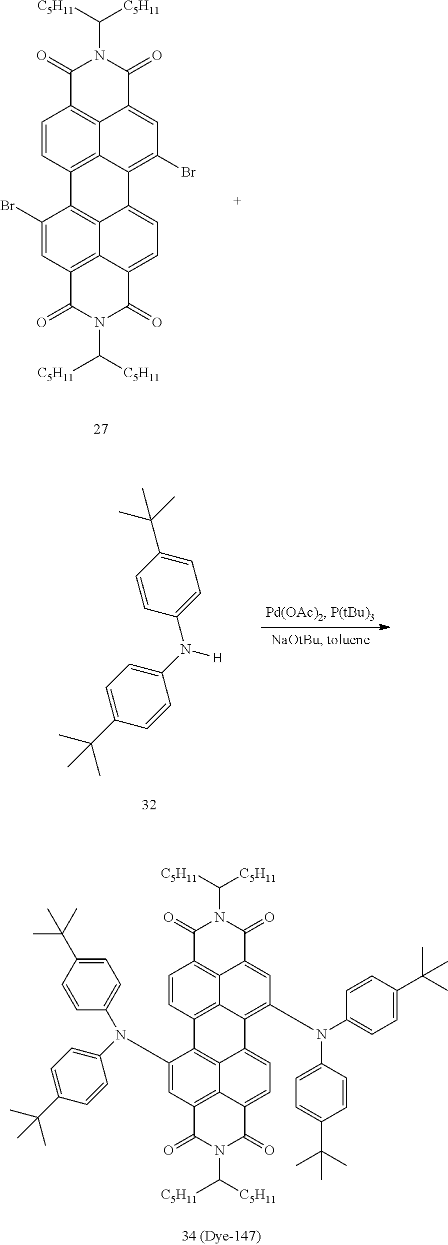

Under nitrogen, compound 27 (400 mg, 0.5 mmol) was added to a solution of compound 32 (315 mg, 1.1 mmol), palladium (II) acetate (42 mg, 0.2 mmol) tri-tertbutyl phosphine (76 mg, 0.4 mmol) and sodium tertbutoxide (700 mg, 7.3 mmol) in anhydrous toluene (25 mL). The resulting mixture was heated to 100° C. After stirring overnight, the mixture was cooled to room temperature and quenched with 1 M HCl (30 mL). The layers were separated, and the organic layer was washed with 1 M HCl (1×25 mL), dried over Na₂SO₄ and concentrated. The crude was purified by column chromatography on silica gel using DCM as eluent to produce a green solid (Compound 34, Dye-147) (230 mg, 39%). ¹H NMR (500 MHz, CDCl₃), δ(ppm): 8.66 (d, 2H, J=8.73 Hz), 8.47 (br, 2H), 8.21 (br, 2H), 7.15 (d, 2H, J=8.74 Hz), 6.97 (d, 2H, J=8.62 Hz), 5.06 (br, 2H), 2.11 (br, 4H), 1.79 (br, 4H), 1.24 (m, 64H), 0.82 (m, 12H).

### Example 13: Synthesis of PPS10 Polymeric Dye

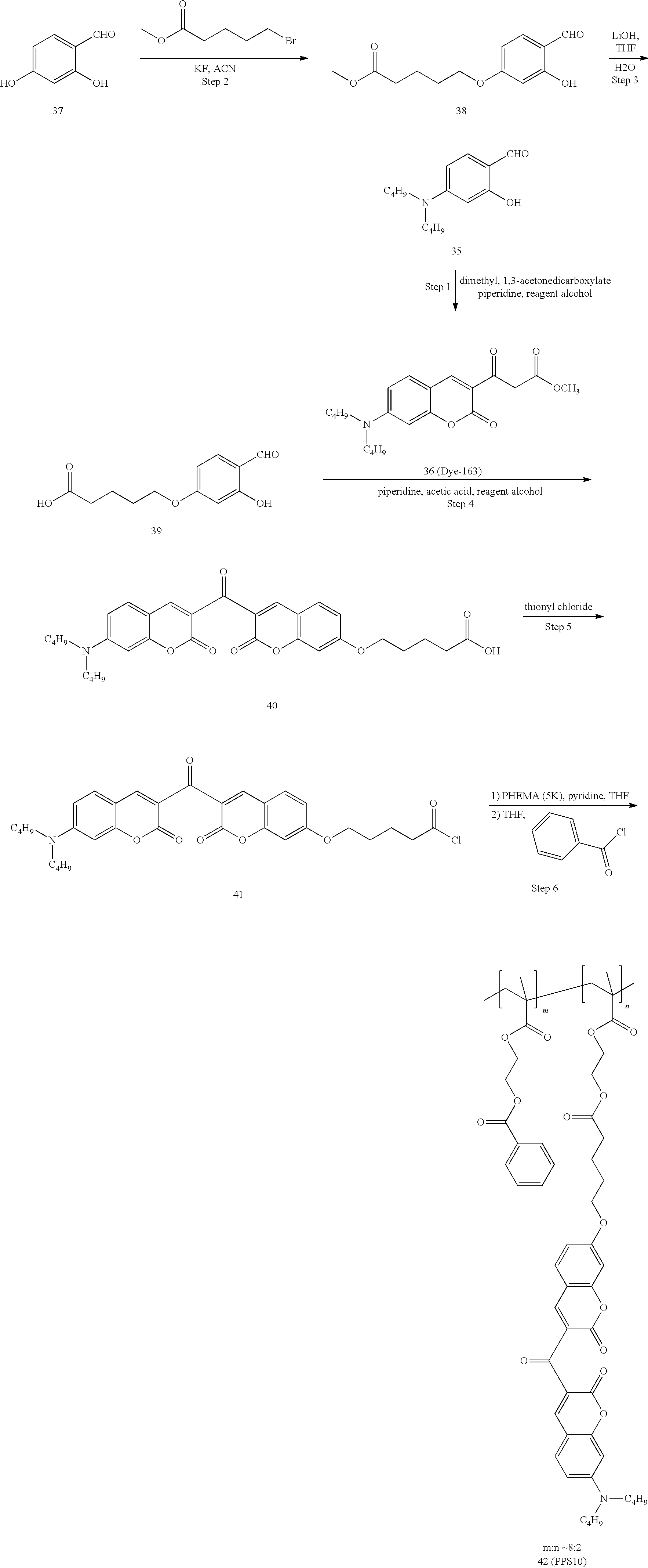

Step 1: Under argon, a mixture of compound 35 (25 g, 0.10 mol) and dimethyl-1,3-acetonedicarboxylate (40 mL, 0.28 mol) in reagent alcohol (120 mL) was warmed to about 50° C. Piperidine (6 mL) was then added, and the resulting mixture was heated to reflux and maintained at refluxing for 2 hours. Upon cooling to rt, the insoluble material was collected by filtration, rinsed with reagent alcohol, and dried in vacuum, leading to a yellow solid as the product 36 (Dye-163) (25.95 g, 69.3%). ¹H NMR (400 MHz, CDCl₃), δ(ppm): 8.49 (s, 1H), 7.39 (d, J=9.2 Hz, 1H), 6.58-6.62 (dd, J=8.8 Hz, J=2.4 Hz, 1H), 6.43 (d, J=2.4 Hz, 1H), 4.11 (s, 1H), 3.74 (s, 3H), 3.37 (t, J=8 Hz, 4H), 1.61 (m, br, 4H), 1.38 (m, br, 4H), 0.98 (t, J=7.2 Hz, 6H).

Step 2: Under argon, compound 37 (25.0 g, 0.18 mol), and potassium fluoride (21.0 g, 0.36 mol) was vigorously stirred in anhydrous acetonitrile (300 mL) at 60° C. After stirring for 25 mins, compound methyl 5-bromovalerate (75 mL, 0.52 mol) was added, and the resulting mixture was heated to reflux and maintained at refluxing for about 5 hours. Upon cooling to rt, most solvent was removed in vacuo, and the residue was poured into water (300 mL). The resulting mixture was extracted with ethyl acetate (250 mL). The separated organic layer was washed with water, dried over anhydrous magnesium sulfate, and concentrated in vacuo. The high boiling point residue was distilled off under vacuum. The residue was recrystallized from a mixture ethyl ether and hexane, leading to colorless crystals as product 38 (31.0 g, 67.8%). ¹H NMR (400 MHz, CDCl₃), δ(ppm): 11.47 (s, 1H), 9.71 (s, 1H), 7.42 (d, J=8.8 Hz, 1H), 6.50-6.54 (dd, J=8.8 Hz, J=2.4 Hz, 1H), 6.40 (d, J=2.4 Hz, 1H), 4.03 (t, J=6.0 Hz, 2H), 3.68 (s, 3H), 2.40 (t, J=6.8 Hz, 4H), 1.83 (m, br, 4H).

Step 3: Compound 38 (18.6 g, 73.6 mmol) was dissolved in 1,4-dioxane (150 mL) at rt, followed by addition of a solution of LiOH (3.5 g, 0.15 mol) in water (150 mL). The resulting mixture was stirred at rt overnight. Most of the organic solvent was removed in vacuo, and the residue was mixed with water (300 mL). This mixture was washed with methyl-t-butyl ether (200 mL×2). The aqueous layer was then acidified by concentrated HCl solution until pH˜2, before it was extracted with ethyl acetate (150 mL×4). The combined organic layer was dried over anhydrous magnesium sulfate, concentrated in vacuo, and dried in vacuum, leading to compound 39 (16.8 g, 96.3%). ¹H NMR (400 MHz, CDCl₃), δ(ppm): 11.47 (s, 1H), 9.71 (s, 1H), 7.42 (d, J=8.8 Hz, 1H), 6.50-6.54 (dd, J=8.8 Hz, J=2.4 Hz, 1H), 6.41 (d, J=2.4 Hz, 1H), 4.04 (t, J=6.0 Hz, 2H), 2.46 (t, J=6.8 Hz, 2H), 1.86 (m, br, 4H).

Step 4: Under argon, a mixture of compound 39 (8.56 g, 22.9 mmol), compound 36 (5.46 g, 22.9 mmol), piperidine (0.3 mL), and acetic acid (0.6 mL) in reagent alcohol (120 mL) was stirred at rt for 30 mins, before it was warmed to reflux and kept at refluxing for 4 hours. Upon cooling to rt, the reaction mixture was cooled in freezer overnight. Top supernatant was decanted, and the residue was washed with reagent alcohol (30 mL×3), before it was dried in vacuum, leading to light brown solid as the product 40 (9.87 g, 76.4%) ¹H NMR (400 MHz, CDCl₃), δ(ppm): 8.28 (s, 1H), 8.11 (s, 1H), 7.49 (d, J=8.8 Hz, 1H), 7.38 (d, J=8.8 Hz, 1H), 6.85 (m, br, 2H), 6.58 (m, br, 1H), 6.45 (m, br, 1H), 4.08 (m, br, 2H), 3.36 (m, br, 4H), 2.44 (t, J=6.8 Hz, 2H), 1.88 (m, br, 4H), 1.62 (m, br, 4H), 1.38 (m, br, 4H), 0.98 (t, J=7.2 Hz, 6H).

Step 5: Under argon, a mixture of compound 40 (9.87 g, 17.6 mmol) was stirred in thionyl chloride (160 mL) at rt for 3.5 hours. Most of volatile was removed in vacuo, and residue was dried in vacuum, leading to a green-ish/brown solid as the product 41 (10.54 g), which was used directly for next step without further purification.

Step 6: Under argon, PHEMA (M_{w}˜5K, 1.02 g, 7.82 mmol) was dissolved in dry pyridine (22 mL), and the resulting mixture was stirred at rt for 30 mins. A solution of compound 7 (1.38 g, 2.38 mmol) in dry THF (40 mL) was added slowly. This reaction mixture was stirred at rt for about 6.5 hours, before a solution of benzoyl chloride (0.88 g, 6.26 mmol) in dry THF (10 mL) was added slowly. The reaction was maintained at rt with stirring for additional 17 hours, before it was poured into methanol (300 mL). The precipitates were collected by filtration and washed with methanol. The crude was re-dissolved in THF (20 mL) and then precipitated in methanol (300 mL). The precipitates were collected by filtration, rinsed with methanol, and dried in vacuum, leading to a brownish yellow solid as product 42 (PPS-10) (1.16, 46.2%). ¹H NMR (400 MHz, CDCl₃), δ(ppm): 8.26 (m, br, 1H), 8.09 (m, br, 1H), 7.99 (m, br, 6H), 7.35-7.62 (m, br 12H), 6.81 (m, br, 2H), 6.56-6.60 (m, br, 1H), 6.43 (m, br, 1H), 3.95-4.60 (m, br, 21H), 3.35 (m, br, 4H), 2.39 (m, br, 2H), 0.80-2.15 (m, br, 64H).

### Example 14: Synthesis of PPS-11 Polymer

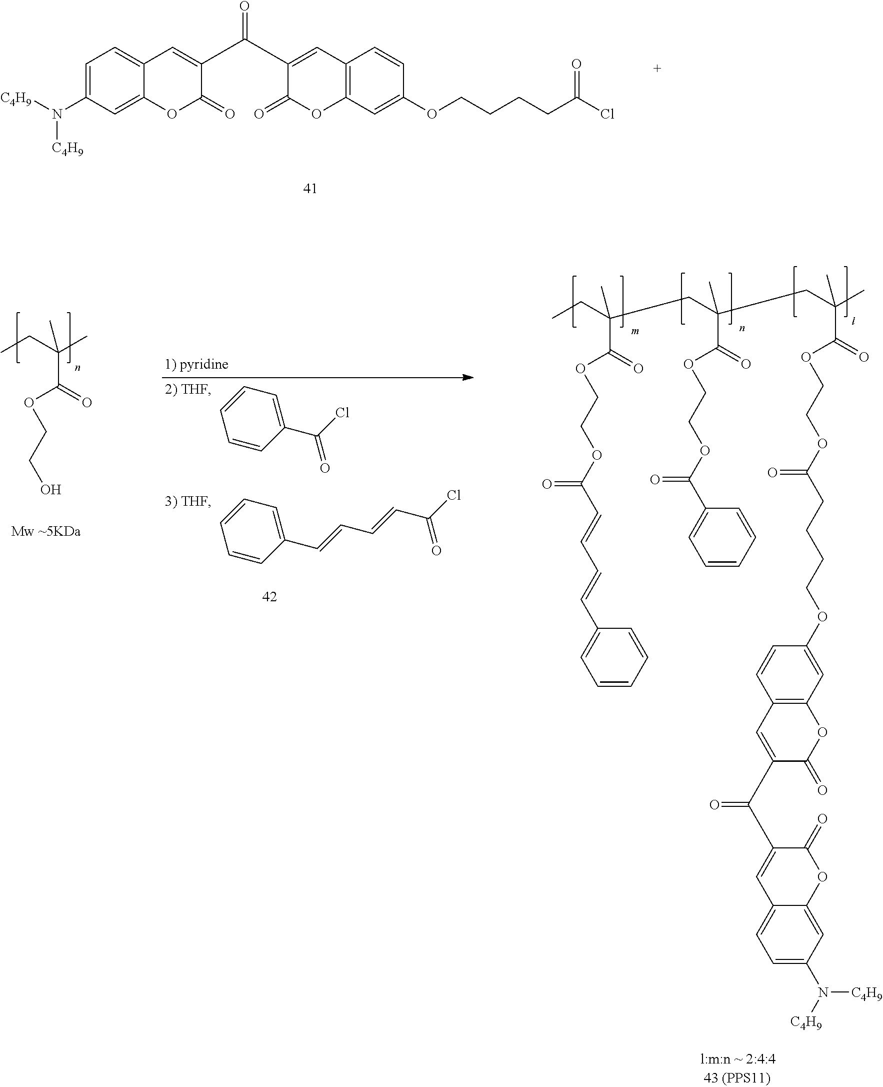

Under argon, PHEMA (M_{w}˜5K, 1.78 g, 13.65 mmol) was dissolved in dry pyridine (32 mL), and the resulting mixture was stirred at rt for 25 mins. A solution of compound 7 (2.23 g, 3.84 mmol) in dry THF (70 mL) was added slowly. This reaction mixture was stirred at rt for about 5 hours, before benzoyl chloride (0.91 g, 6.46 mmol) was added slowly. The reaction was maintained at rt with stirring for additional 15 hours. A solution of acyl chloride 42 (1.6 g, 8.31 mmol) in anhydrous THF (10 mL) was added. This reaction was stirred at rt for additional 20 hours, before it was poured into methanol (300 mL). The precipitates were collected by filtration and washed with methanol. The crude was re-dissolved in THF (50 mL) and then precipitated in methanol (300 mL). The precipitates were collected by filtration, rinsed with methanol, and dried in vacuum, leading to a brownish yellow solid as product 43 (PPS11) (2.0, 42.7%). ¹H NMR (400 MHz, CDCl₃), δ(ppm): 8.25 (m, br, 1H), 7.90-8.12 (m, br, 7H), 7.20-7.60 (m, br, 28H), 6.60-6.97 (m, br 8H), 6.58 (m, br, 1H), 6.44 (m, br, 1H), 5.98 (m, br, 2H), 3.95-4.60 (m, br, 33H), 3.35 (m, br, 4H), 2.40 (m, br, 2H), 0.75-2.20 (m, br, 77H).

### Example 15: Synthesis of PP2 Dye

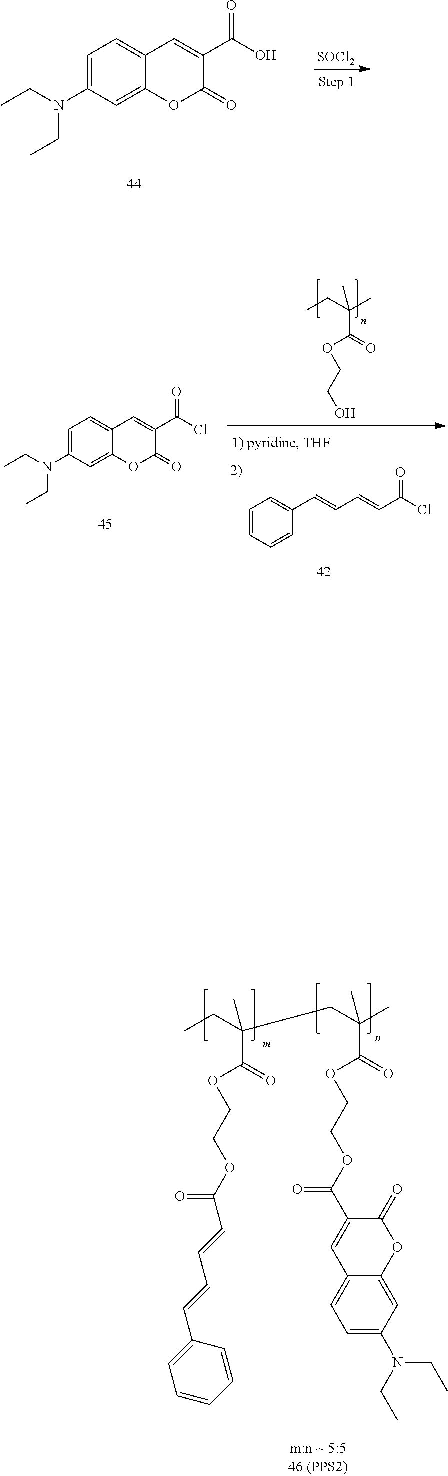

### Step 1:

Solid coumarin 44 (0.50 g, 1.9 mmol) was added in portions to thionyl chloride (8.20 g, 68.5 mmol) over 5 minutes. The mixture was stirred for 3 h then the solids were collected by vacuum filtration and washed with anhydrous diethyl ether (3×3 mL). Yellow solid (0.28 g, 53%) was obtained after drying under vacuum as product 45. ¹H NMR (400 MHz, CDCl₃): δ 8.68 (ppm): (s, 1H), 7.46 (d, J=9.0 Hz, 1H), 6.77 (dd, J=9.0 Hz, 2.5 Hz, 1H), 6.54 (d, J=2.5 Hz, 1H), 3.50 (q, J=7.4 Hz, 4H), 1.27 (t, J=7.3 Hz, 6H).

### Step 2:

A solution of 45 (0.40 g, 1.4 mmol) in anhydrous THF (10 mL) was added dropwise to a solution of PHEMA (M_{w}˜20K, 0.37 g, 2.8 mmol) in anhydrous pyridine (10 mL). The mixture was stirred overnight before a solution of acyl chloride 42 (0.25 g, 1.4 mmol) in THF (5 mL) was added dropwise and the reaction was continued overnight. The solution was precipitated into methanol (250 mL), yellow solid was collected by filtration and washed with methanol (3×40 mL). After drying, the solid was redissolved in stabilized THF (5 mL containing 400 ppm MEHQ) and slowly added to vigorously stirring methanol (200 mL). Yellow solid was collected by filtration and dried under vacuum as product 46 (PP2) (0.50 g). ¹H NMR (400 MHz, CDCl₃): δ(ppm): 8.31 (br, 1H), 7.32 (br, 7H), 6.84 (br 2), 6.53 (br, 1H), 6.30 (br, 1H), 5.94 (br, 1H), 4.23 (br, 8H), 3.37 (br, 4H), 1.90 (br, 2H), 1.20 (br, 8H), 0.98 (br, 6H).

This dye can also be used in the constructions described herein.

### Example 16: Synthesis of PPS9M

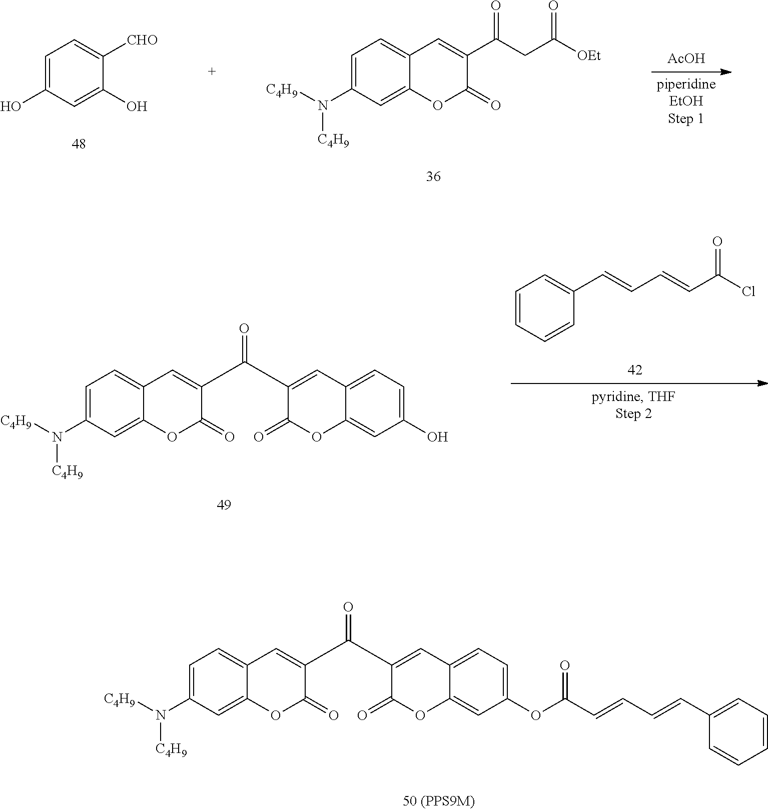

Step 1: Compounds 48 (0.24 g, 1.7 mmol) and 36 (0.51 g, 1.3 mmol) were stirred in ethanol (10 mL) containing piperidine (0.03 mL) and acetic acid (0.06 mL) at 70° C. under N₂ for 9 h. The solution was cooled to rt then chilled in a −35° C. freezer for 2 h. Solvent was decanted, the precipitated solid was washed with ethanol (2×5 mL) and dried under vacuum to yield 400 mg (63%) orange solid as product 49. ¹H NMR (400 MHz, CDCl₃), δ(ppm): 8.27 (s, 1H), 8.11 (s, 1H), 7.39 (d, J=9.0 Hz, 1H), 7.11 (d, J=9.0 Hz, 1H), 6.78 (dd, J=8.6 Hz, 2.1 Hz, 1H), 6.72 (d, J=2.1 Hz, 1H), 6.61 (dd, J=9.0 Hz, 2.4 Hz, 1H), 6.45 (d, J=2.2 Hz, 1H), 3.36, (t, J=7.9 Hz, 4H), 1.62 (m, 4H), 1.38 (m, 4H), 0.98 (t, J=7.3 Hz, 6H).

Step 2: Compound 42 (0.05 g, 0.3 mmol) in THF (3 mL) was added to compound 49 (0.10 g, 0.2 mmol) in pyridine (3 mL) and the reaction was stirred under N₂ overnight. Methanol (100 mL) was added, and the solution was chilled in a −35° C. freezer for 1.25 h. Orange solid was collected by filtration as product 50 (PPS9m) (0.06 g, 47%). ¹H NMR (400 MHz, CDCl₃), δ(ppm): 8.34 (s, 1H), 8.08 (s, 1H), 7.68 (dd, J=15 Hz, 10 Hz, 1H) 7.60 (d, J=8.4, 1H), 7.51 (m, 2H), 7.40 (m, 2H), 7.36 (m, 2H), 7.23 (d, J=2.1 Hz, 1H), 7.16 (dd, J=8.5 Hz, 2.1 Hz, 1H), 7.01 (m, 2H), 6.60 (dd, J=9.0 Hz, 2.2 Hz, 1H), 6.46, (d, J=2.2 Hz, 1H), 6.18 (d, J=15 Hz, 1H), 3.37 (t, J=7.8 Hz, 4H), 1.62 (m, 4H), 1.39 (m, 4H), 0.99 (t, J=7.4 Hz, 6H).

### Example 17: Synthesis of Dye-200

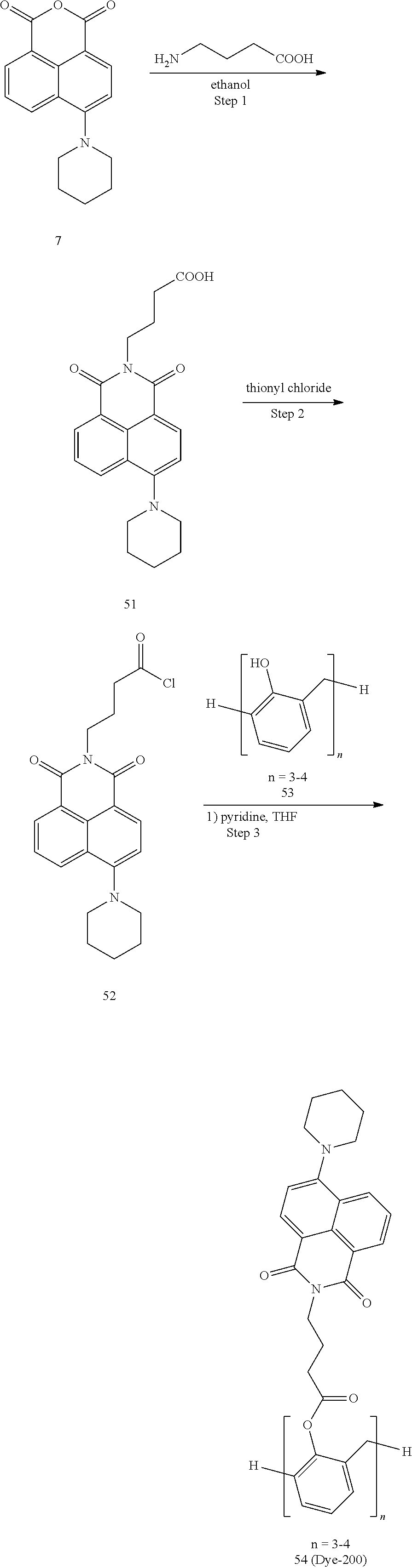

Step 1: Under argon, a mixture of compound 7 (1.40 g, 4.98 mmol), and γ-aminobutyric acid (1.03 g, 9.99 mmol), in ethanol (50 mL) was stirred at refluxing for about 20 hours. Upon cooling to rt, most of solvent was removed in vacuo, and the residue was treated with DCM (40 mL). The insoluble material was filtered off, and filter cake was rinsed with DCM. The combined filtrate was purified by column chromatography on silica gel with a mixture of DCM:methanol=9:1 (v/v) as eluent, leading to a yellow solid as the product 51 (1.30 g, 71.4%). ¹H NMR, 500 MHz, (CDCl₃), δ(ppm): 8.50-8.72 (m, br, 3H), 7.76 (m, br, 1H), 7.36 (m, br, 1H), 4.26 (m, br, 2H), 3.37 (s, br, 4H), 2.48 (m, br, 2H), 1.85-2.18 (m, br 6H), 1.78 (m, br, 2H).

Step 2: Under argon, a mixture of compound 51 (662.1 mg, 1.81 mmol) in thionyl chloride (20 mL) was stirred at rt for 4 h. Most of the volatiles were removed in vacuo, and the residue was dried in vacuum. This crude (52) was directly used for next step without further purification (701.3 mg).

Step 3: Under nitrogen, phenolic reside 53 (153.7 mg, 1.45 mmol) was dissolved in anhydrous pyridine (10 mL), followed by addition of DMAP (5.3 mg, 0.043 mmol). Acyl chloride 52 (701.3 mg) in dry THF (10 mL) was then added via syringe. The resulting mixture was stirred at rt for about 5 hours, before it was poured into methanol (100 mL). The precipitates were collected by vacuum filtration, rinsed with methanol, and dried in vacuum, leading a yellow solid the product (54, Dye-138) (0.39 g, 59.2%). ¹H NMR, 500 MHz, (CDCl₃), δ(ppm): 8.00-8.65 (m, br, 3H), 7.64 (m, br, 1H), 6.30-7.40 (m, br, 4H), 3.00-4.40 (m, br, 6H), 1.40-2.70 (m, br, 12H).

### Example 18: Synthesis of Dye-757

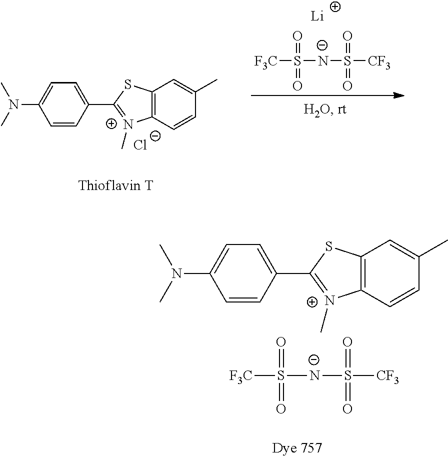

To the mixture of thioflavin T (319 mg, 1 mmol) in water (15 ml), a solution of lithium bis(trifluoromethane)sulfonimide (316 mg, 1.1 mmol) in water (1 ml) was added dropwise. After overnight stirring, the suspension was filtered and dried to afford dye 757 as a yellow solid (358 mg, yield 63%). 1H NMR (500 MHz, CDCl3), δ(ppm) 7.83 (d, 1H, J=8.7 Hz), 7.78 (s, 1H), 7.71 (d, 2H, J=9.0 Hz), 7.62 (d, 1H, J=8.7 Hz), 6.88 (d, 2H, J=9.0 Hz), 4.33 (s, 3H), 3.17 (s, 6H), 2.58 (s, 3H).

### Example 19: Synthesis of Dye-6G

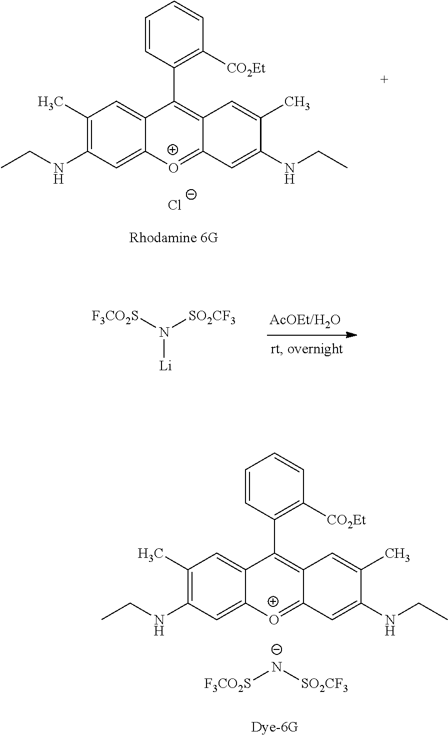

A mixture of lithium bis(trifluoromethanesulfonyl)imide (2.30 g, 8.01 mmol) and rhodamine 6G (3.30 g, 6.89 mmol) in ethyl acetate (33 mL) and water (33 mL) was vigorously stirred for 6 hours. The reaction mixture was transferred to a separation funnel with assistance of additional ethyl acetate (˜80 mL), and it was phase-separated. The organic layer was washed with water (50 mL×2), dried, and concentrated to about 30 mL. This residue solution was then precipitated in heptane (˜150 mL). The precipitate was collected by vacuum filtration and dried under vacuum, leading to the product Dye-6G as a red solid (4.49 g, 90%). 1H NMR (500 MHz, CD2Cl2), δ(ppm): 8.34 (m, 1H), 7.82 (m, 1H) 7.78 (m, 1H), 7.30 (m, 1H), 6.91, (m, 2H), 6.82 (m, 2H), 5.45 (m, 2H), 4.00 (q, J=7.1 Hz, 2H), 3.51 (t, 4H), 2.14 (s, 6H), 1.43 (t, J=7.1 Hz, 6H), 0.99 (t, J=7.0 Hz, 3H).

### Example 20: Synthesis of Dye-Bu26

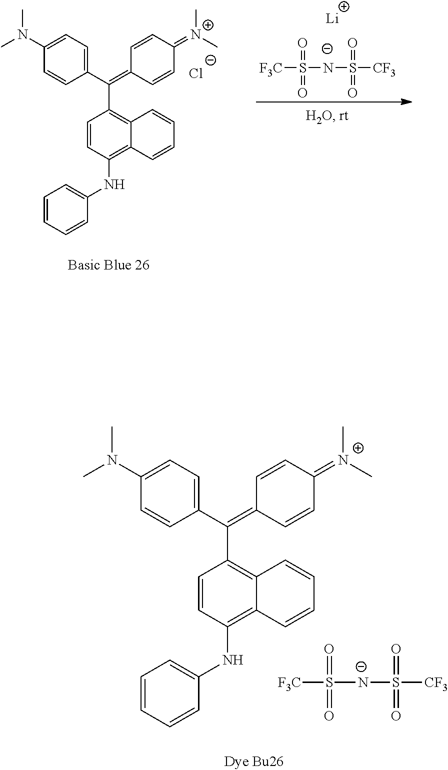

The synthesis of Dye-Bu26 was carried out according to the literature: Sci. Rep. 2017, 7, 46178.

### Example 21: Preparation of Colored Dielectric Polymer Materials

Various dyes were synthesis as described in the above Examples, or purchased from commercial sources. Polymers were prepared as described above or in the references cited herein.

The dye formulations (F's) were prepared by dissolving the polymer and the dye in a solvent with vigorous stirring at room temperature for about 2-12 hours. After dissolution, the formulation was filtered through a 0.2-1 micron filter before use.

Formulations are described in Tables 2-5 below. FY, FR, FG, and FB indicate formulations with yellow, red, green, and black coloration, respectively. PS is Polysulfone (i.e., polyether of alternating bis(1,4-phenylene)sulfone residues and bisphenol A residues). PPS is Polyphenylsulfone. POP is Poly(oxy-1,4-phenylenesulfonyl-14-phenylene). PEI is Polyetherimide. PBE is Poly(Bisphenol A-co-epichlorohydrin).

PGMEA is propylene glycol methyl ether acetate. CHN is cyclohexanone. TOE is 1,1,2,2-tetrachloroethane. BMP is 2,2-Bis[4-(4-maleimidophenoxy)phenyl]propane. OTT is Di trimethylolpropane tetraacrylate. TPO is Diphenyl(2,4,6-trimethylbenzoyl)phosphine oxide. TGE is Trimethylolpropane triglycidyl ether. NIT is N-Hydroxynaphthalimide triflate. DPH is dipentaerythritol hexaacrylate.

TABLE 2
Formulation of Yellow Dyes

| | Polymer | Dye | Solvent | Additive |
|---|---|---|---|---|
| Name | (mg) | (mg) | (mg) | (mg) |
| FY-10 | PS (67) | CDIAC (10) | CHN (947) | none |
| FY-18 | PS (67) | DATC (10) | CHN (947) | none |
| FY-20 | PS (67) | Dye-115 (15) | CHN (947) | none |
| FY-21 | PS (67) | Dye-117 (52.5) | CHN (947) | none |
| FY-24 | PS (67) | Dye-126 (37) | Anisole (995) | none |
| FY-25 | PS (67) | Dye-94 (30) | Anisole (995) | none |
| FY-26 | PS (67) | Dye-115 (40) | CHN (947) | DTT (17), |
| | | | | TPO(4.2) |
| FY-27 | PS (67) | Dye-145 (40) | CHN (947) | TGE (58) |
| | | | | NIT (2.5) |
| FY-38 | PS (67) | Dye-117 (50) | CHN (947) | none |
| FY-100 | PS (67) | Dye-117 (34) | CHN (947) | DPH (17), |
| | | | | TPO (4.2) |
| FY-101 | PS (67) | Dye-115 (26) | Anisole (398), | BMP (35) |
| | | | CHN (568) | |
| FY-102 | PES (80) | Dye-757 (14.4) | Anisole (199), | BMP (36) |
| | | | ε-Caprolactone | |
| | | | (824) | |

TABLE 3
Formulation of red dyes

| | Polymer | Dye | Solvent | Additive |
|---|---|---|---|---|
| Name | (mg) | (mg) | (mg) | (mg) |
| FR-4 | PS (67) | PDI2HD (3) | CHN (947) | none |
| FR-5 | PS (67) | RP (3.5) | CHN (947) | none |
| FR-6 | PS (67) | BSR (2.5) | CHN (947) | none |
| FR-7 | PS (67) | LB (10) | CHN (947) | none |
| FR-8 | PS (67) | AzoF1 (10) | CHN (947) | none |
| FR-9 | PS (67) | SR111 (10) | CHN (947) | none |
| FR-10 | PS (67) | LB (40) | CHN (947) | none |
| FR-11 | PS (67) | Dye-133 (40) | CHN (947) | none |
| FR-19 | PS (67) | Dye-161 (26) | Anisole (995) | BMP (30) |
| FR-101 | PPS (60) | Dye-161 (26) | TCE (1250) | BMP (40) |
| FR-102 | PPS (60) | Dye-161 (26) | TCE (1250) | BMP (40), |
| | | | | TPO (4.2) |
| FR-103 | POP (60) | Dye-161 (26) | TCE (1250) | BMP (40) |
| FR-104 | POP (60) | Dye-161 (26) | TCE (1250) | BMP (40), |
| | | | | TPO (4.2) |
| FR-105 | PPS (60) | Dye-161 (22) | TCE (1250) | DPH (26) |
| FR-106 | PPS (60) | Dye-161 (22) | TCE (1250) | DPH (26), |
| | | | | TPO (8.2) |
| FR-107 | PEI (67) | Dye-161 (26) | Anisole (995) | BMP (40) |
| FR-108 | PEI (67) | Dye-161 (26) | Anisole (995) | BMP (40), |
| | | | | TPO (4.2) |
| FR-109 | PBE (100) | Dye-161 (26) | CHN (947) | DPH (25.4), |
| | | | | TPO (8.1) |
| FR-110 | PS (67) | Dye-6G (10) | Anisole (398), | BMP (30) |
| | | | CHN (568) | |

TABLE 4
Formulation of Green and Blue Dyes

| | Polymer | Dye | Solvent | Additive |
|---|---|---|---|---|
| Name | (mg) | (mg) | (mg) | (mg) |
| FG-100 | PS (67) | Dye-165 (26) | Anisole (398), | BMP (35) |
| | | | CHN (568) | |
| FG-101 | PS (67) | Dye-147 (26) | Anisole (398), | BMP (35) |
| | | | CHN (568) | |
| FBu-100 | PS(67) | Dye-B26 (25) | Anisole (398), | BMP (30) |
| | | | CHN (568) | |

TABLE 5
Formulation of Black Dyes

| | Polymer | Dye | Solvent | Additive |
|---|---|---|---|---|
| Name | (mg) | (mg) | (mg) | (mg) |
| FB-1 | PS (67) | Solvent black 27 (40) | CHN (947) | DPH (17), |
| | | | | TPO (4.2) |
| FB-2 | PS (67) | Solvent black 27 (60), | CHN (947) | DPH (17), |
| | | | | TPO (4.2) |
| | | Dye-115 (10), | | |
| | | Dye-161 (10) | | |
| FB-14 | PS (67) | Solvent black 27 (50), | Anisole (995) | BMP (50) |
| | | Dye-147 (40) | | |
| FB-100 | PS (67) | Solvent black 27 (50), | Anisole (398), | BMP (96) |
| | | Solvent green 28 (17), | CHN (568) | |
| | | Dye-182 (22) | | |
| FB-101 | PS (67) | Solvent black 27 (50), | Anisole (398), | BMP (96) |
| | | Solvent green 28 (17) | CHN (568) | |
| FB-102 | PS (67) | Solvent black 27 (100) | Anisole (398), | BMP (96) |
| | | | CHN (568) | |

TABLE 6
Dye materials used in Tables 2-5

| Dye | Purported |
|---|---|
| name/ID | Structure |
| CDIAC | 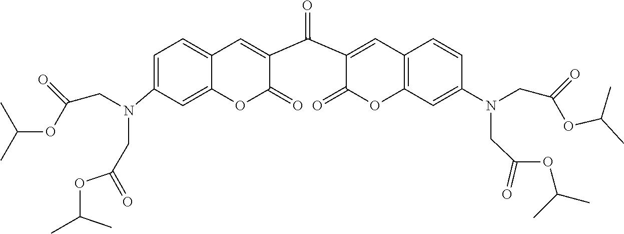 [SMILES: CC(C)OC(=O)CN(CC(=O)OC(C)C)c1ccc2cc(C(=O)c3cc4ccc(N(CC(=O)OC(C)C)CC(=O)OC(C)C)cc4oc3=O)c(=O)oc2c1] |
| DATC | 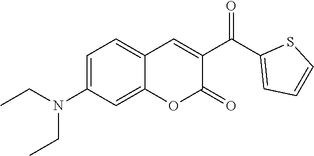 [SMILES: CCN(CC)c1ccc2cc(C(=O)c3cccs3)c(=O)oc2c1] |
| Dye-115 | 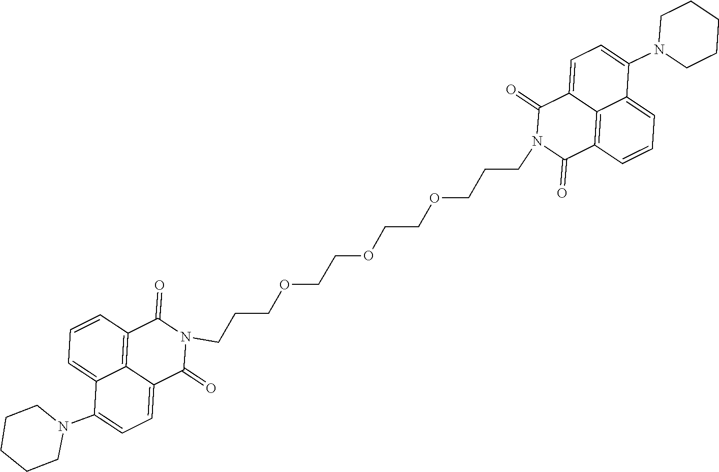 [SMILES: O=C1c2cccc3c(N4CCCCC4)ccc(c23)C(=O)N1CCCOCCOCCOCCCN1C(=O)c2cccc3c(N4CCCCC4)ccc(c23)C1=O] |
| Dye-117 | 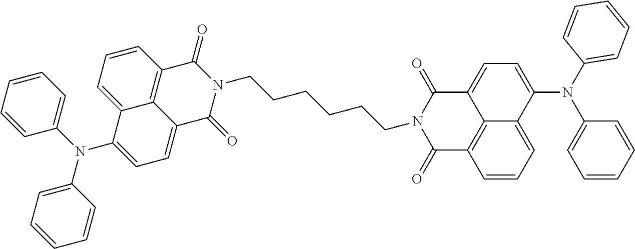 [SMILES: O=C1c2cccc3c(N(c4ccccc4)c4ccccc4)ccc(c23)C(=O)N1CCCCCCN1C(=O)c2cccc3c(N(c4ccccc4)c4ccccc4)ccc(c23)C1=O] |
| Dye-126 | 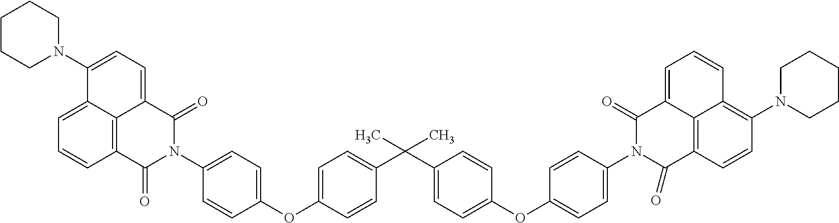 [SMILES: CC(C)(c1ccc(Oc2ccc(N3C(=O)c4cccc5c(N6CCCCC6)ccc(c45)C3=O)cc2)cc1)c1ccc(Oc2ccc(N3C(=O)c4cccc5c(N6CCCCC6)ccc(c45)C3=O)cc2)cc1] |
| Dye-94 | 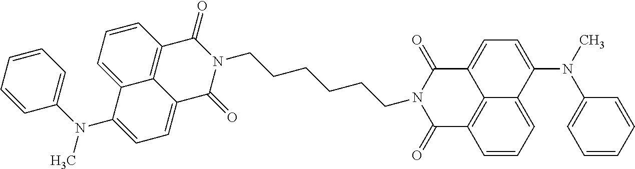 [SMILES: CN(c1ccccc1)c1ccc2c3c(cccc13)C(=O)N(CCCCCCN1C(=O)c3cccc4c(N(C)c5ccccc5)ccc(c34)C1=O)C2=O] |
| Dye-145 | 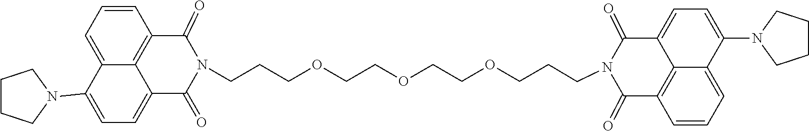 [SMILES: O=C1c2cccc3c(N4CCCC4)ccc(c23)C(=O)N1CCCOCCOCCOCCCN1C(=O)c2cccc3c(N4CCCC4)ccc(c23)C1=O] |
| Dye-133 | 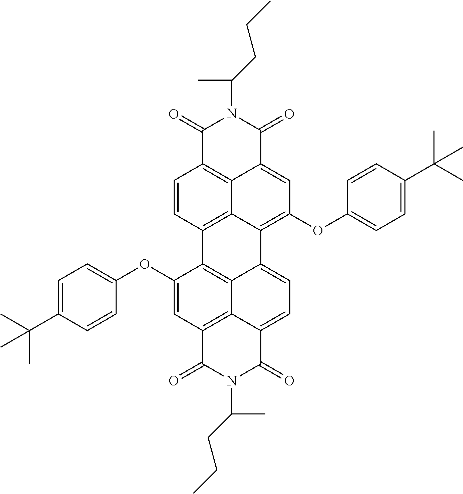 [SMILES: CCCC(C)N1C(=O)c2ccc3c4c(Oc5ccc(C(C)(C)C)cc5)cc5c6c(ccc(c7c(Oc8ccc(C(C)(C)C)cc8)cc(c2c37)C1=O)c64)C(=O)N(C(C)CCC)C5=O] |
| PDI2HD | 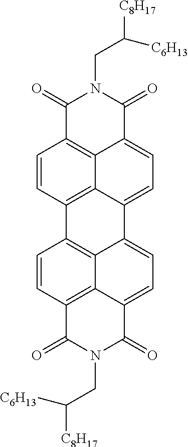 |
| RP | 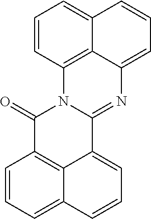 |
| BSR | 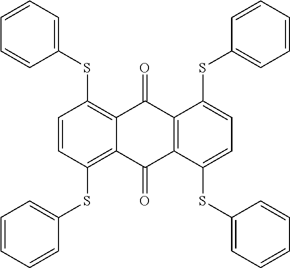 [SMILES: O=C1c2c(Sc3ccccc3)ccc(Sc3ccccc3)c2C(=O)c2c(Sc3ccccc3)ccc(Sc3ccccc3)c21] |
| LB | 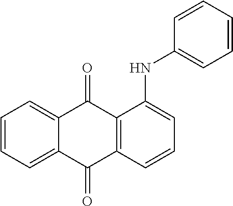 [SMILES: O=C1c2ccccc2C(=O)c2c(Nc3ccccc3)cccc21] |
| AzoF1 | 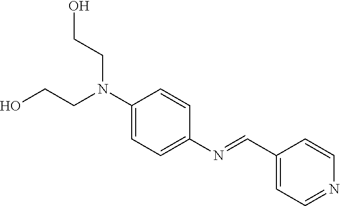 [SMILES: OCCN(CCO)c1ccc(/N=C/c2ccncc2)cc1] |
| SR111 | 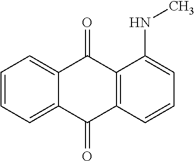 [SMILES: CNc1cccc2c1C(=O)c1ccccc1C2=O] |
| Dye-165 | 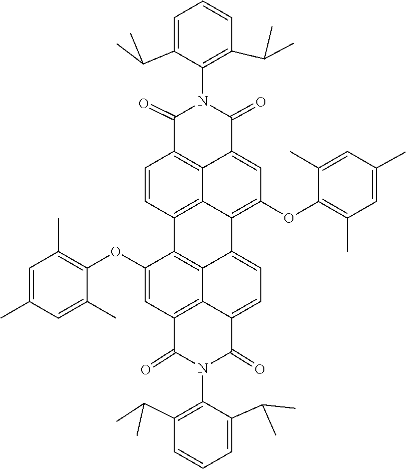 |
| Dye-161 | 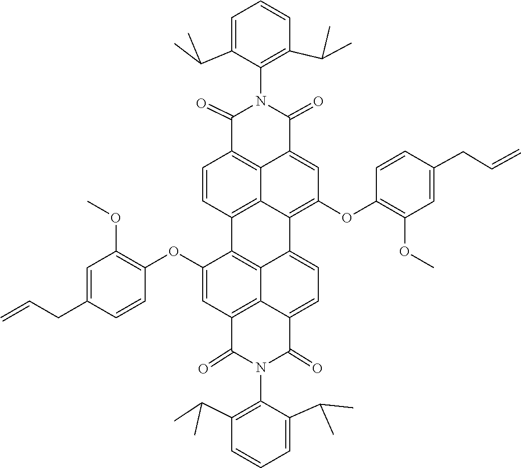 [SMILES: C=CCc1ccc(Oc2cc3c4c(ccc5c6c(Oc7ccc(CC=C)cc7OC)cc7c8c(ccc(c2c45)c86)C(=O)N(c2c(C(C)C)cccc2C(C)C)C7=O)C(=O)N(c2c(C(C)C)cccc2C(C)C)C3=O)c(OC)c1] |
| Dye-147 | 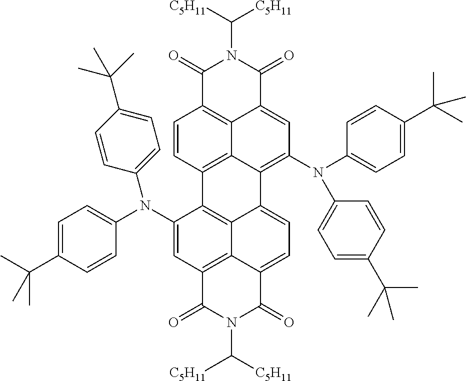 |
| Dye-182 | 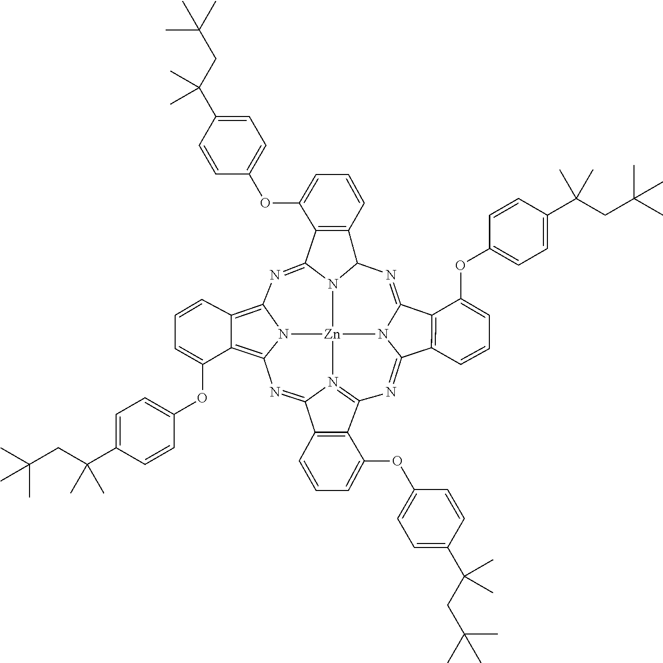 |
| Solvent Black 27 | 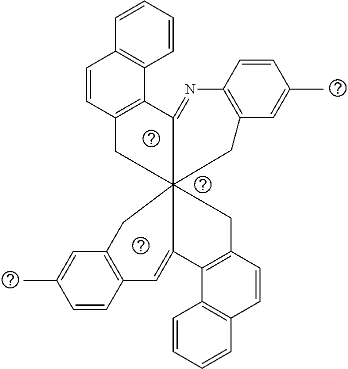 |
| Solvent Green 28 | 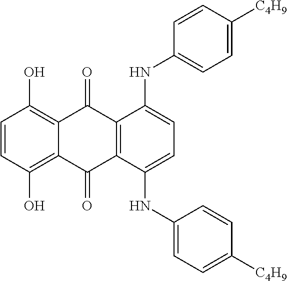 |
| Dye 757 | 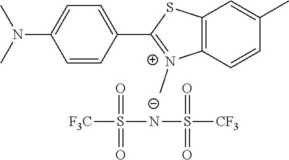 |
| Dye 6G | 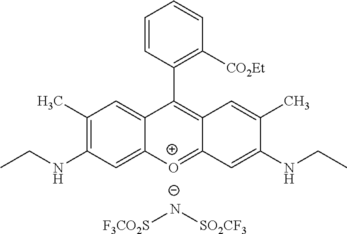 |
| Dye B26 | 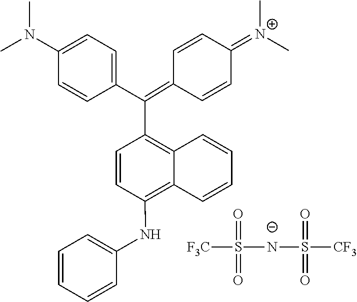 |

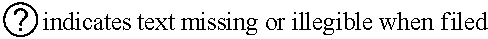

TABLE 7
Chemical structure of polymers used in Tables 2-5

| | Chemical |
|---|---|
| Polymer name/ID | Structure |
| POP | 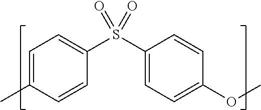 |
| PPS | 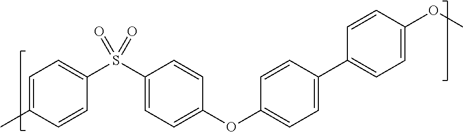 |
| PEI | 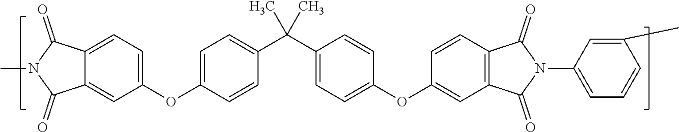 |
| PBE | 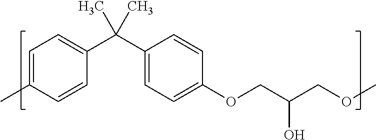 |
| PS | 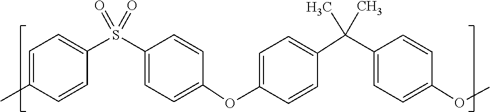 |
| PES | 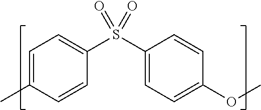 |

### Example 22: Thin Film Preparation

Spin-coating: Thin films (TF's) were fabricated on Corning EAGLE glass or plastic (PEN) substrates. The substrate was cleaned with acetone, soap water and IPA and exposed to air plasma prior to deposition. The formulation was spun-coated (400-2000 rpm) onto the substrate to afford, after a soft bake (80˜120° C., 1-5 mins) on a hotplate, ˜500-3500 nm-thick films.

Slot-die coating: Thin films were fabricated on Corning EAGLE glass or plastic (PEN) substrates. The substrate was cleaned with acetone, soap water and IPA and exposed to air plasma prior to deposition. The formulation was coated using an Ossilia slot-die coater (coating gap 100-500 um, coating rate 1-500 mm/s) onto the substrate to afford, after a soft bake (80˜120° C., 1-5 mins) on a hotplate, ˜500-3500 nm-thick films.

Cure (UV-T-C): Thin films were cured under flood UV light (High-pressure mercury lamp ˜0.3-5 J/cm²) to initiate the crosslinking through radiation, followed by annealing in oven at 200-250° C. for 5-60 mins to thermally crosslink the films.

Thicknesses of the thin films were measured using Dektek 150 profilometer. UV-Vis spectrum of the dye thin films were measured in air using Cary 50 UV-vis spectrophotometer.

Detail of the thin films (TF's) are collected in Tables 8-11, separated by color. TFY, TFR, TFG, and TFB are thin films with yellow, red, green, and black coloration, respectively.

TABLE 8
Thin films of yellow dyes on glass substrate.

| | | | | | | | Transmittance | |
|---|---|---|---|---|---|---|---|---|
| Name | Substrate | Method | Formulation | Curing | Thickness | | (@ xx nm) | |
| TFY-10 | glass | spin | FY-10 | No | 560 | nm | 23% | (433 nm) |
| TFY-18 | glass | spin | FY-18 | No | 539 | nm | 15% | (427 nm) |
| TFY-20 | glass | spin | FY-20 | No | 542 | nm | 48% | (408 nm) |
| TFY-21 | glass | spin | FY-21 | No | 685 | nm | 17% | (454 nm) |
| TFY-24 | glass | spin | FY-24 | No | 762 | nm | 20% | (410 nm) |
| TFY-25 | glass | spin | FY-25 | No | 675 | nm | 32% | (445 nm) |
| TFY-26 | glass | spin | FY-26 | UV-T-C | 1.25 | μm | 4% | (408 nm) |
| TFY-27 | glass | spin | FY-27 | UV-T-C | 1.04 | μm | 3% | (447 nm) |
| TFY-38 | glass | spin | FY-23 | No | 980 | nm | 9% | (410 nm) |
| TFY-100 | glass | spin | FY-100 | UV-T-C | 740 | nm | 12% | (455 nm) |
| TFY-101 | glass | spin | FY-101 | UV-T-C | 1.620 | μm | 10% | (412 nm) |
| TFY-102 | Glass | Spin | FY-102 | UV-T-C | 1.0 | μm | 15% | (429 nm) |

TABLE 9
Thin films of red dyes on glass substrate

| | | | | | | | Transmittance | |
|---|---|---|---|---|---|---|---|---|
| Name | Substrate | Method | Formulation | Curing | Thickness | | (@ xx nm) | |
| TFR-4 | glass | spin | FR-4 | No | 459 | nm | 78% | (551 nm) |
| TFR-5 | glass | spin | FR-5 | No | 466 | nm | 83% | (476 nm) |
| TFR-6 | glass | spin | FR-6 | No | 465 | nm | 88% | (554 nm) |
| TFR-7 | glass | spin | FR-7 | No | 490 | nm | 65% | (507 nm) |
| TFR-8 | glass | spin | FR-8 | No | 487 | nm | 21% | (447 nm) |
| TFR-9 | glass | spin | FR-9 | No | 497 | nm | 63% | (507 nm) |
| TFR-10 | glass | spin | FR-10 | No | 1.4 | μm | 7% | (511 nm) |
| TFR-11 | glass | spin | FR-11 | No | 692 | nm | 11% | (504 nm) |
| TFR-19 | glass | spin | FR-19 | UV-T-C | 1.22 | μm | 5% | (559 nm) |
| TFR-101 | glass | spin | FR-101 | UV-T-C | 1.58 | μm | 1.6% | (555 nm) |
| TFR-102 | glass | spin | FR-102 | UV-T-C | 1.56 | μm | 2.4% | (558 nm) |
| TFR-103 | glass | spin | FR-103 | UV-T-C | 1.38 | μm | 3.7% | (555 nm) |
| TFR-104 | glass | spin | FR-104 | UV-T-C | 1.33 | μm | 4.3% | (555 nm) |
| TFR-105 | glass | spin | FR-105 | UV-T-C | 1.23 | μm | 5.5% | (560 nm) |
| TFR-106 | glass | spin | FR-106 | UV-T-C | 1.24 | μm | 3.6% | (554 nm) |
| TFR-107 | glass | spin | FR-107 | UV-T-C | 1.29 | μm | 4.1% | (554 nm) |
| TFR-108 | glass | spin | FR-108 | UV-T-C | 1.29 | μm | 4.6% | (554 nm) |
| TFR-109 | glass | spin | FR-109 | UV-T-C | 1.77 | μm | 0.2% | (561 nm) |
| TFR-110 | glass | spin | FR-110 | UV-T-C | 0.4 | μm | 25% | (542 nm) |

TABLE 10
Thin films of green/blue dyes on glass substrate

| | | | | | | Transmittance | |
|---|---|---|---|---|---|---|---|
| Name | Substrate | Method | Formulation | Curing | Thickness | (@ xx nm) | |
| TFG-100 | glass | spin | FG-100 | UV-T-C | 1.59 μm | 33% | (664 nm), |
| | | | | | | 20% | (417 nm) |
| TFG-101 | glass | spin | FG-101 | UV-T-C | 1.57 μm | 37% | (713 nm), |
| | | | | | | 30% | (486 nm) |
| TFBu-100 | glass | spin | FBu-100 | UV-T-C | 1.31 μm | 20% | (530 nm), |
| | | | | | | 10% | (680 nm) |

TABLE 11
Thin films of black dyes on glass substrate

| | | | | | | | Transmittance |
|---|---|---|---|---|---|---|---|
| Name | Substrate | Method | Formulation | Curing | Thickness | | (300~650 nm) |
| TFB-1 | glass | spin | FB-1 | UV-T-C | 930 | nm | <22% |
| TFB-2 | glass | spin | FB-2 | UV-T-C | 1.92 | μm | <2% |
| TFB-14 | glass | spin | FB-14 | UV-T-C | 3.11 | μm | <3.2% |
| TFB-100 | glass | spin | FB-100 | UV-T-C | 3.69 | μm | <1% |
| TFB-101 | glass | spin | FB-101 | UV-T-C | 3.66 | μm | <1% |
| TFB-102 | glass | spin | FB-102 | UV-T-C | 1.98 | μm | <1% |

### Example 23: Characterization of Thin Films, Photolithography Resistance

Photolithography resistance: The AZ650 (AZ) photoresist solution was spun coated (2000 rpm, 120 mins) on the crosslinked thin films of the dyes and soft baked at 800 1 mins, followed by standard light exposure (GH-line, 30 Mj/cm²), development (TMAH 2.38%, 1 m 0), Ar and O₂ dry etching and stripping (N300 at 800 for 2 min.) processes to define via holes in the color films. The transmittance spectra were measured and compared before and after the photolithographic process. Table 11 collects representative data.

TABLE 11
Stability to the AZ photolithographic process (PLP)
of the indicated thin films on glass substrate.

| | Transmittance (%) | Transmittance (%) |
|---|---|---|
| Film | before PLP | after PLP |
| TFY-100 | 12% (@ 455 nm) | 17% (@ 455 nm) |
| TFY-101 | 10% (@ 412 nm) | 11% (@ 412 nm) |
| TFR-19 | 5% (@ 555 nm) | 5% (@ 555 nm) |
| TFR-101 | 1.6% (@ 555 nm) | 1.6% (@ 555 nm) |
| TFR-102 | 2.4% (@ 558 nm) | 2.4% (@ 558 nm) |
| TFR-103 | 3.7% (@ 555 nm) | 3.8% (@ 555 nm) |
| TFR-104 | 4.3% (@ 555 nm) | 4.4% (@ 555 nm) |
| TFR-105 | 5.5% (@ 560 nm) | 5.6% (@ 560 nm) |
| TFR-106 | 3.6% (@ 554 nm) | 4% (@ 554 nm) |
| TFR-107 | 4.1% (@ 554 nm) | 4.2% (@ 554 nm) |
| TFR-108 | 4.6% (@ 554 nm) | 4.6% (@ 554 nm) |
| TFR-109 | 0.2% (@ 561 nm) | 0.2% (@ 561 nm) |
| TFG-100 | 33% (@ 664 nm), | 33% (@ 664 nm), |
| | 20% (@ 417 nm) | 20% (@ 417 nm) |
| TFG-101 | 37% (@ 713 nm), | 50% (@ 713 nm), |
| | 30% (@ 486 nm) | 40% (@ 486 nm) |
| TFB-100 | <1% (@ 300~650 nm) | <1% (@ 300~650 nm) |
| TFB-101 | <1% (@ 300~650 nm) | <1% (@ 300~650 nm) |
| TFB-102 | <1% (@ 300~650 nm) | <1% (@ 300~650 nm) |

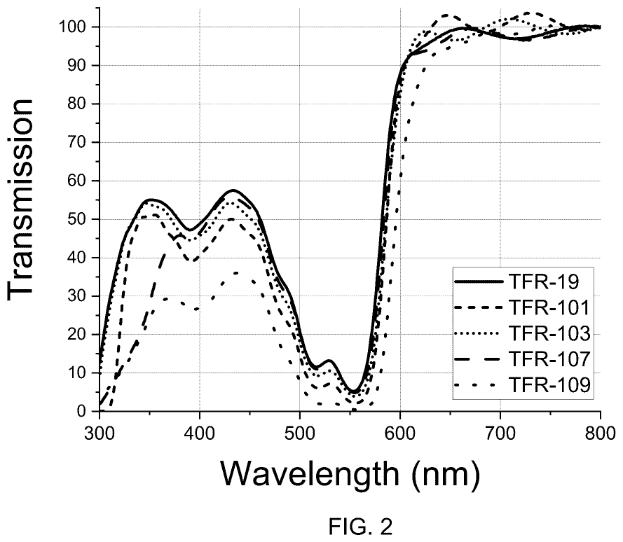

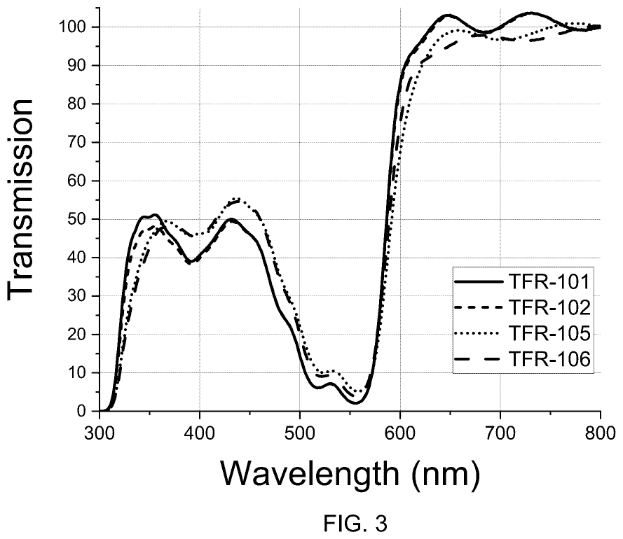

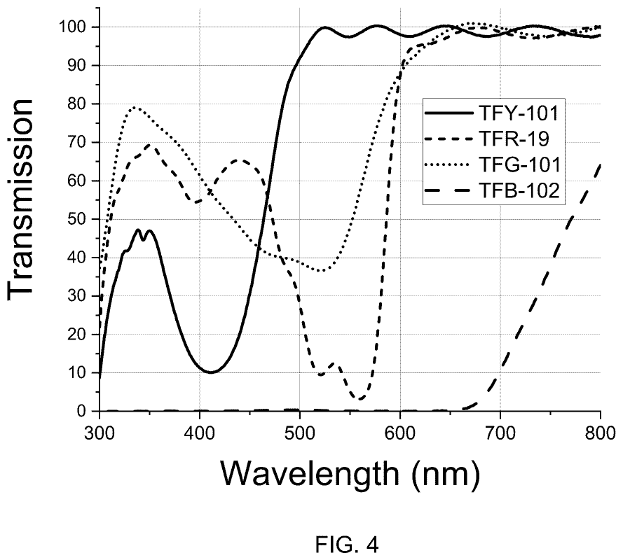

FIG. 2 displays UV-Vis spectra of thin films (TFR-19, TFR-101, TFR-103, TFR-107, TFR-109) comprised of same red dye Dye-161 in different polymer matrixes as shown in Table 7 below. FIG. 3 displays UV-Vis spectra of thin films (TFR-101, TFR-102, TFR-105, TFR-106) comprised of same red dye Dye-161 in same polymer matrix (PPS) but with different additives. It is evident that both the sulfone-related functional group and BPA-related functional group can be efficiently crosslinked with a variety of additives, resulted in negligible film transmittance change after the PLP process as illustrated in Table 11. FIG. 4 displayers UV-Vis spectra of thin films (TFY-101, TFR-19, TFG-101, TFB-102) comprised of different color dyes (Dye-115, Dye-161, Dye-149, Solvent black 27, respectively) in same polymer matrix and additive and all the films were efficiently crosslinked resulted in in negligible film transmittance change after the PLP process as illustrated in Table 11, which further demonstrated the generality of the present teaching.

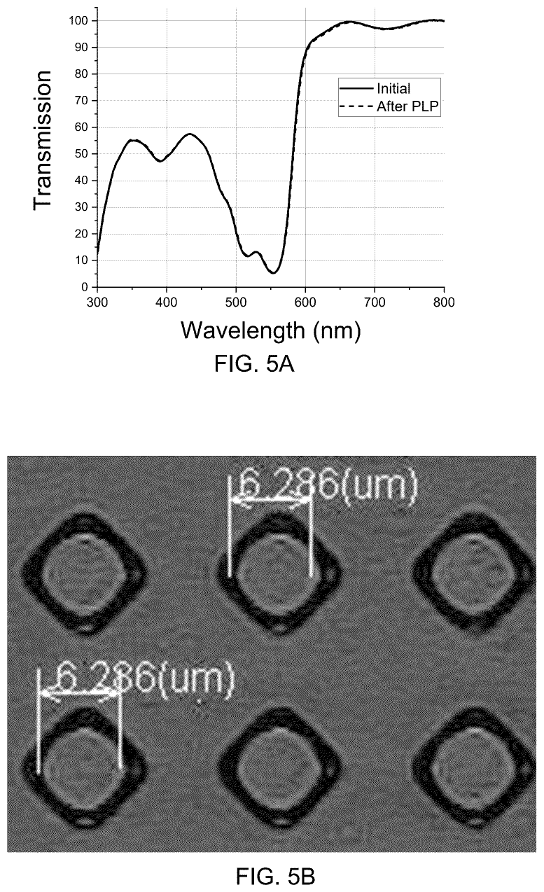

FIG. 5A displays UV-Vis spectra of a typical patterned film (Film TFR-19) before and after AZ photolithographic process (PLP); and FIG. 5B is a picture of a hole-patterned TFR-19 film with hole dimensions ˜6 μm.

Comparative Example: Thin films (TFY-20, TFR-10, TFY-100, TFR-101, TFG-100, TFB-100) were fabricated as indicated in Example 6 but without the crosslinking step. The AZ650 photoresist solution was spun coated (2000 rpm, 120 mins) on the thin films of the dyes and soft baked at 80 C 1 mins, followed by standard light exposure (GH-line, 30 mJ/cm²), development (TMAH 2.38%, 1 min), Ar and 02 dry etching and stripping (N300 at 80 C for 2 min.) processes. These films do not survive the photolithographic process (no film remained on the substrate).

### Example 24: Characterization of Thin Films, Thermal Resistance

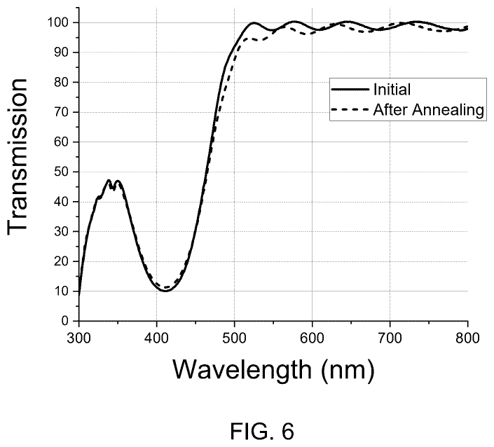

Thermal resistance: After crosslinking, the thin films were annealed at 230° C. for 30 mins. The transmittance spectra were measured and compared before and after thermal annealing. Table 13 collects representative data. FIG. 6 display UV-Vis spectra of a typical crosslinked thin films (Film TFY101), before and after thermal annealing.

TABLE 13
Thermal stability of the indicated thin films on glass substrate

| | Transmittance (%) | Transmittance (%) |
|---|---|---|
| Film | before annealing | after annealing |
| TFY-101 | 10% (@ 412 nm) | 11% (@ 412 nm) |
| TFR-19 | 5% (@ 559 nm) | 6% (@ 552 nm) |
| TFG-100 | 33% (664 nm), | 35% (664 nm), |
| | 20% (417 nm) | 18% (417 nm) |
| TFB-102 | <1% (@ 300~650 nm) | <1% (@ 300~650 nm) |

### Example 25: Characterization of Thin Films, ITO Fabrication Stability

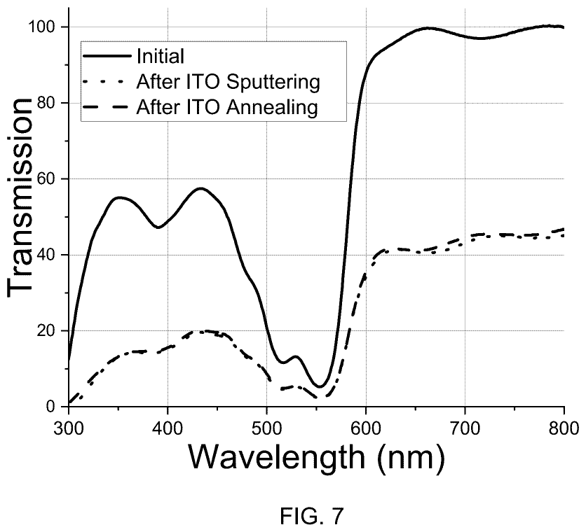

Stability to ITO fabrication process. The ITO film was deposited by sputtering (thickness 20-120 nm) followed by annealing in a N₂ oven at 230° C. for 30 mins. The films remained smooth after the annealing. The transmittance spectra were measured and compared before and after the ITO fabrication process. Table 14 collects representative data. FIG. 7 displays UV-Vis spectra of a typical film (Film TFR-19) before and after ITO fabrication process

TABLE 14
Stability to the ITO fabrication process (ITO-FP)
of the indicated thin films on glass substrate.

| | Transmittance (%) | Transmittance (%) |
|---|---|---|
| Film | before ITO-FP | after ITO-FP |
| TFR-19 | 5% (@559 nm) | 3% (@559 nm) |
| TFB-102 | <1% (@ 300~650 nm) | <1% (@ 300~650 nm) |

Comparative Example: Thin films (TFY-21, TFR-11, TFR-19, TFB-102) were fabricated as indicated in Example 6 but without the crosslinking step. The ITO film was deposited by sputtering (thickness 20-120 nm) followed by annealing in a N₂ oven at 230° C. for 30 mins. Significant film deformations and topological irregularities were observed after the ITO annealing process.

### Example 26: Characterization of Thin Films, Stability to Light Exposure

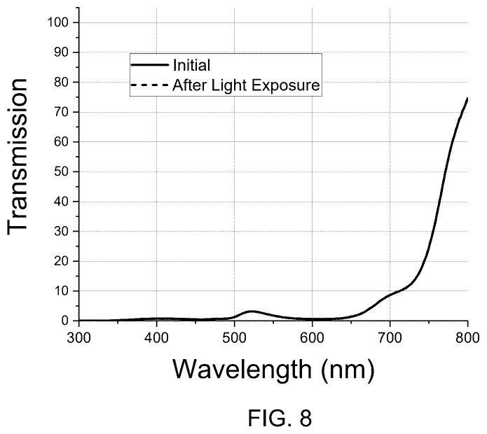

Light fastness: The thin films were exposed to artificial sun light (Newport Solar Simulator 91160, 274W) for 2 hr and the transmittance spectra were recorded and compared before and after light irradiation. Table 15 collects representative data. FIG. 8 displays UV-Vis spectra of a typical crosslinked thin films (Film TFB-14) before and after solar light exposure (SLE).

TABLE 15
Stability to solar light exposure (SLE) of the
indicated thin films on glass substrate.

| | Transmittance (%) | Transmittance (%) |
|---|---|---|
| Film | before SLE | after SLE |
| TFG-101 | 37% (@ 713 nm), | 40% (@ 710 nm), |
| | 30% (@ 486 nm) | 31% (@ 486 nm) |
| TFB-14 | <3.2% (@ 300~650 nm) | <3.2% (@ 300~650 nm) |

### Example 27: Characterization of Thin Films Dielectric Strength

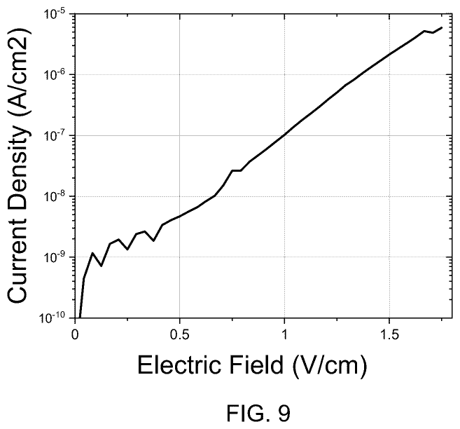

Dielectric strength measurements. Metal-Insulator-Metal (MIM) devices were used to investigate the dielectric strength of the thin films. The MIM bottom electrodes were fabricated by sputtering of Ag (100 nm) on a glass substrate and patterned by photolithography to yield circle-shaped electrodes with diameters of 100-500 um. Thin films were deposited as describe in Example 19 affording ˜500-3500 nm films. The top electrodes were fabricated by sputtering of Ag (100 nm) on the thin film and patterned by photolithography to yield circle-shaped electrodes with diameters of 100-500 um. Leakage current and breakdown voltages were measured using a probe station and a Keithley 4200 electrometer. Table 16 collects representative data. FIG. 9 displays the leakage current measured from a typical crosslinked thin film (Film TFR-19).

TABLE 16
Dielectric strength of the indicated thin films on glass substrate.

| | Leakage current | Dielectric Strength | Dielectric |
|---|---|---|---|
| | (A/cm², @ | (Breakdown Field, | Constant |
| Film | 1 MV/cm) | MV/cm) | (k) |
| TFR-19 | <10⁻⁷ | >1.5 | 3.2 |

Comparative Examples: Thin films (TFR-19) were fabricated on a bottom electrode (sputtered of Ag˜100 nm on a glass substrate and patterned by photolithography to yield circle-shaped electrodes with diameters of 100-500 um) as indicated in Example 24 but without the crosslinking step. The top electrodes were fabricated by sputtering of Ag (100 nm) on the thin film and patterned by photolithography to yield circle-shaped electrodes with diameters of 100-500 um. The thin films were destroyed by the top electrode photolithography process (no film remained on the substrate).

As can be seen by the foregoing examples, the crosslinked thin films fabricated according to the present disclosure possess excellent process stability while maintaining good coloration characteristics and dielectric properties, while the non-crosslinked thin films cannot survive critical fabrication steps,

Various exemplary embodiments of the disclosure include, but are not limited to, the enumerated embodiments of the claims as listed below, which can be combined in any number and in any combination that is not technically or logically inconsistent.

The particulars shown herein are by way of example and for purposes of illustrative discussion of certain embodiments of the present disclosure only and are presented in the cause of providing what is believed to be the most useful and readily understood description of the principles and conceptual aspects of various embodiments of the disclosure. In this regard, no attempt is made to show details associated with the methods of the disclosure in more detail than is necessary for the fundamental understanding of the methods described herein, the description taken with the examples making apparent to those skilled in the art how the several forms of the methods of the disclosure may be embodied in practice. Thus, before the disclosed processes and devices are described, it is to be understood that the aspects described herein are not limited to specific embodiments, apparatus, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the methods of the disclosure (especially in the context of the following embodiments and claims) are to be construed to cover both the singular and the plural, unless otherwise indicated herein or clearly contradicted by context.

All methods described herein can be performed in any suitable order of steps unless otherwise indicated herein or otherwise clearly contradicted by context. The use of any and all examples, or exemplary language (e.g., “such as”) provided herein is intended merely to better illuminate the methods of the disclosure and does not pose a limitation on the scope of the disclosure. No language in the specification should be construed as indicating any non-claimed element essential to the practice of the methods of the disclosure.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

All percentages, ratios and proportions herein are by weight, unless otherwise specified.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the disclosure are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of various aspects of the disclosure are described herein, including the best mode known to the inventors for carrying out the methods described herein. Of course, variations on these described embodiments will become apparent to those of ordinary skill in the art upon reading the foregoing description. The skilled artisan will employ such variations as appropriate, and as such the methods of the disclosure can be practiced otherwise than specifically described herein. Accordingly, the scope of the disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The phrase “at least a portion” as used herein is used to signify that, at least, a fractional amount is required, up to the entire possible amount.

In closing, it is to be understood that the various embodiments herein are illustrative of the methods of the disclosures. Other modifications that may be employed are within the scope of the disclosure. Thus, by way of example, but not of limitation, alternative configurations of the methods may be utilized in accordance with the teachings herein. Accordingly, the methods of the present disclosure are not limited to that precisely as shown and described.

### EMBODIMENTS

Embodiment 1. A colored dielectric polymer material comprising a crosslinked polymer and a dye dispersed in the crosslinked polymer, wherein the crosslinked polymer comprises a crosslinking product of crosslinkable composition including a first polymer having bis(phenylene)sulfone residues and/or bisphenol A residues.

Embodiment 2. A colored dielectric polymer material according to embodiment 1, wherein the first polymer has bis(phenylene)sulfone residues.

Embodiment 3. A colored dielectric polymer material according to embodiment 1, wherein the first polymer has a concentration of bis(phenylene)sulfone residues of at least 5 wt %, e.g., at least 10 wt %, or at least 20 wt %, or at least 40 wt %.

Embodiment 4. A colored dielectric polymer material according to any of embodiments 1-3, wherein the first polymer has a weight-average molecular weight (M_{w}) ranging from about 1,000 g/mol to about 200,000 g/mol.

Embodiment 5. A colored dielectric polymer material according to embodiment 2 or embodiment 3, wherein the first polymer has repeating units of structural formula

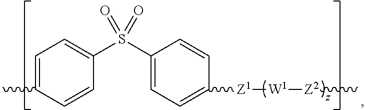

wherein
z is 0 or 1;
each W¹ is independently —Ar[—Y—Ar]_{q}—, wherein:
Ar, at each occurrence, is independently a divalent C₆₋₁₈ arylene group;
Y, at each occurrence, is independently selected from the group consisting of —O—, —S—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
q is selected from the group consisting of 0, 1, 2, 3, 4, 5, 6, 7, 8, 9 and 10; and
each Z¹ and Z² is independently selected from the group consisting of —O—, —S—, —Se—; —C(O)O—, —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl; or
when z is 0, Z¹ is

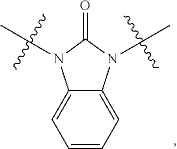 [SMILES: *n1c(=O)n(*)c2ccccc21]

wherein the first polymer has a weight-average molecular weight (M_{w}) ranging from about 1,000 to about 200,000.

Embodiment 6. A colored dielectric polymer material according to embodiment 5, wherein z is 1.

Embodiment 7. A colored dielectric polymer material according to embodiment 5, wherein z is 0.

Embodiment 8. A colored dielectric polymer material according to any of embodiments 5-7, wherein each Z¹ and Z² is 0 or S.

Embodiment 9. A colored dielectric polymer material according to any of embodiments 5-7, wherein each Z¹ and Z² is 0.

Embodiment 10. A colored dielectric polymer according to embodiment 5, wherein z is 0 and Z¹ is —O— or —O—(CHR⁵CHR⁵—O)ₐ—.

Embodiment 11. A colored dielectric polymer according to embodiment 5, wherein z is 0 and Z¹ is —O— or —O—CHR⁵CHR⁵—Si(R⁶)₂—CHR⁵CHR⁵—O—.

Embodiment 12. A colored dielectric polymer according to embodiment 5, wherein z is 1 and Z¹ is —O—CH₂— and Z² is —CH₂—O—.

Embodiment 13. A colored dielectric polymer material according to any of embodiments 5-12, wherein each Ar is phenylene, naphthylene, and oxadiazolylene, an 1,3-dihydro-2H-benzo[d]imidazol-2-onediyl, or an lisoindoline-1,3-dionediyl, e.g., phenylene or naphthylene.

Embodiment 14. A colored dielectric polymer according to any of embodiments 5-13, wherein each Ar is substituted by one or more substituents selected from methyl, ethyl, trifluoromethyl and fluoro.

Embodiment 15. A colored dielectric polymer material according to any of embodiments 5-14, wherein each Y is —O—, a covalent bond or —(CR¹R²)ᵣ—.

Embodiment 16. A colored dielectric polymer material according to any of embodiments 5-15, wherein each r is one, e.g., each Y is —C(CH₃)₂— or —C(CF₃)₂—.

Embodiment 17. A colored dielectric polymer material according to any of embodiments 5-16, wherein each q is 0.

Embodiment 18. A colored dielectric polymer material according to any of embodiments 5-16, wherein each q is 1, 2 or 3, e.g., 1.

Embodiment 19. A colored dielectric polymer according to any of embodiments 1-16, wherein the first polymer includes a repeating unit selected from

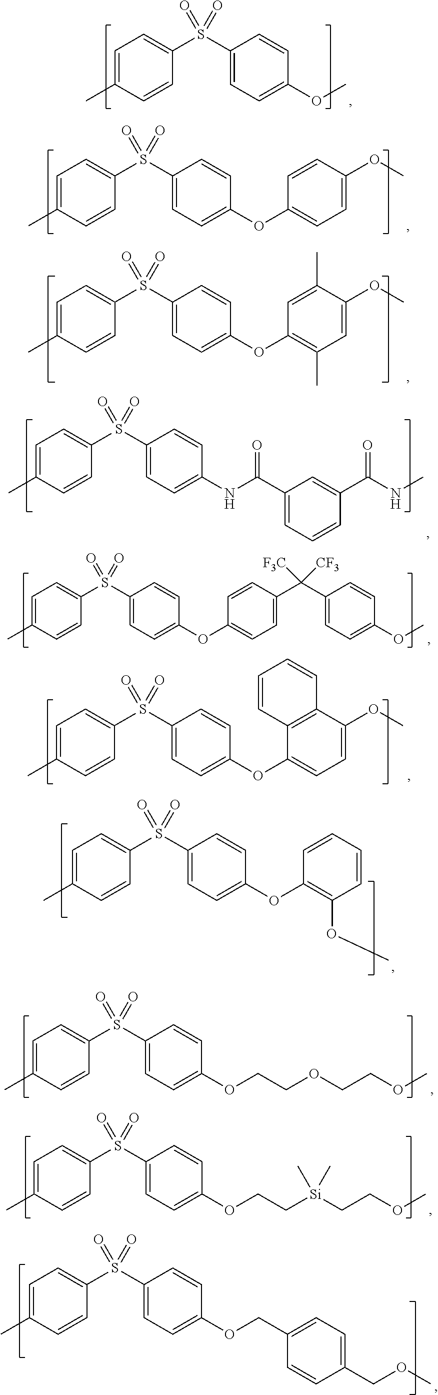

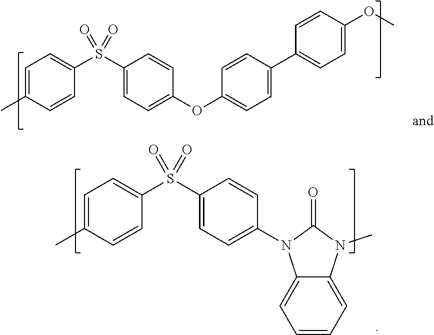

Embodiment 20. A colored dielectric polymer material according to any of embodiments 1-19, wherein the first polymer has bisphenol A residues.

Embodiment 21. A colored dielectric polymer material according to any of embodiments 1-20, wherein the first polymer has a concentration of bisphenol A residues of at least 5 wt %, e.g., at least 10 wt %, or at least 20 wt %, or at least 35 wt %.

Embodiment 22. A colored dielectric polymer according to any of embodiments 121, wherein the first polymer has repeating units of structural formula

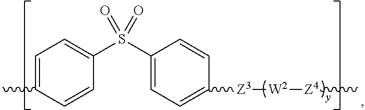

wherein
y is 0 or 1;
each W² is independently —Ar[—Y—Ar]_{q}—, wherein:
Ar, at each occurrence, is independently a divalent C₆₋₁₈ arylene group;
Y, at each occurrence, is independently selected from the group consisting of —O—, —S—, —S(O)—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
q is selected from the group consisting of 0, 1, 2, 3, 4, 5, 6, 7, 8, 9 and 10; and
each Z³ and Z⁴ is independently selected from the group consisting of —O—, —S—, —Se—, —NR⁴—, —C(O)O—, —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl,
wherein the first polymer has a weight-average molecular weight (M_{w}) ranging from about 1,000 to about 200,000.

Embodiment 23. A colored dielectric polymer material according to embodiment 22, wherein y is 1.

Embodiment 24. A colored dielectric polymer material according to embodiment 22, wherein y is 0.

Embodiment 25. A colored dielectric polymer material according to any of embodiments 22-24, wherein each Z³ and Z⁴ is 0 or S.

Embodiment 26. A colored dielectric polymer material according to any of embodiments 22-24, wherein each Z³ and Z⁴ is 0.

Embodiment 27. A colored dielectric polymer according to embodiment 22, wherein y is 0 and Z³ is —O— or —O—(CHR⁵CHR⁵—O)ₐ—.

Embodiment 28. A colored dielectric polymer according to embodiment 22, wherein y is 0 and Z³ is —O— or —O—CHR⁵CHR⁵—Si(R⁶)₂—CHR⁵CHR⁵—O—.

Embodiment 29. A colored dielectric polymer according to embodiment 22, wherein y is 1 and Z³ is —O—CH₂— and Z⁴ is —CH₂—O—.

Embodiment 30. A colored dielectric polymer according to embodiment 22, wherein y is 1 and Z³ is —OC(O)— or —NR⁴C(O)— and Z⁴ is —C(O)O— or —C(O)NR⁴—.

Embodiment 31. A colored dielectric polymer material according to any of embodiments 22-30, wherein each Ar is phenylene, naphthylene, and oxadiazolylene, a 1,3-dihydro-2H-benzo[d]imidazol-2-onediyl, or an lisoindoline-1,3-dionediyl, e.g., phenylene or naphthylene.

Embodiment 32. A colored dielectric polymer according to any of embodiments 22-31, wherein each Ar is substituted by one or more substituents selected from methyl, ethyl, trifluoromethyl and fluoro.

Embodiment 33. A colored dielectric polymer material according to any of embodiments 22-32, wherein each Y is —O—, a covalent bond or —(CR¹R²)—.

Embodiment 34. A colored dielectric polymer material according to any of embodiments 22-33, wherein each r is one, e.g., each Y is —C(CH₃)₂— or —C(CF₃)₂—.

Embodiment 35. A colored dielectric polymer material according to any of embodiments 22-34, wherein each q is 0.

Embodiment 36. A colored dielectric polymer material according to any of embodiments 22-35, wherein each q is 1, 2 or 3, e.g., 1.

Embodiment 37. A colored dielectric polymer according to any of embodiments 1-36, wherein the first polymer includes a repeating unit selected from

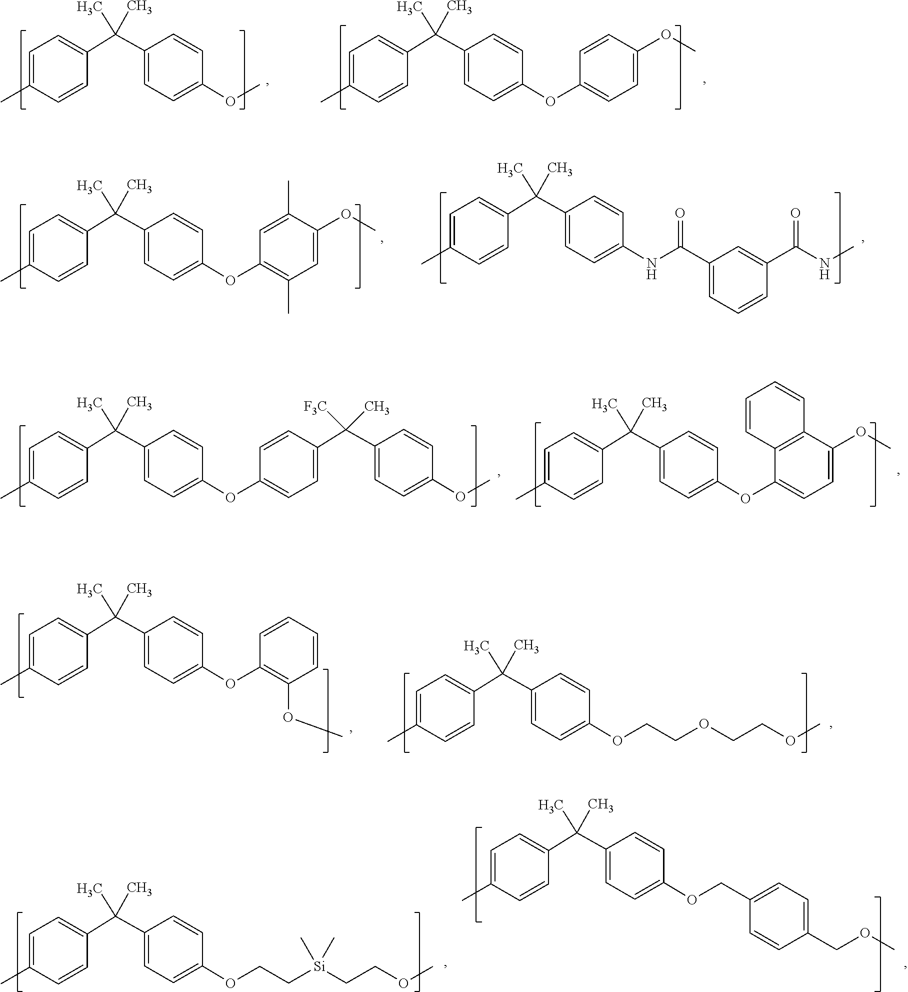

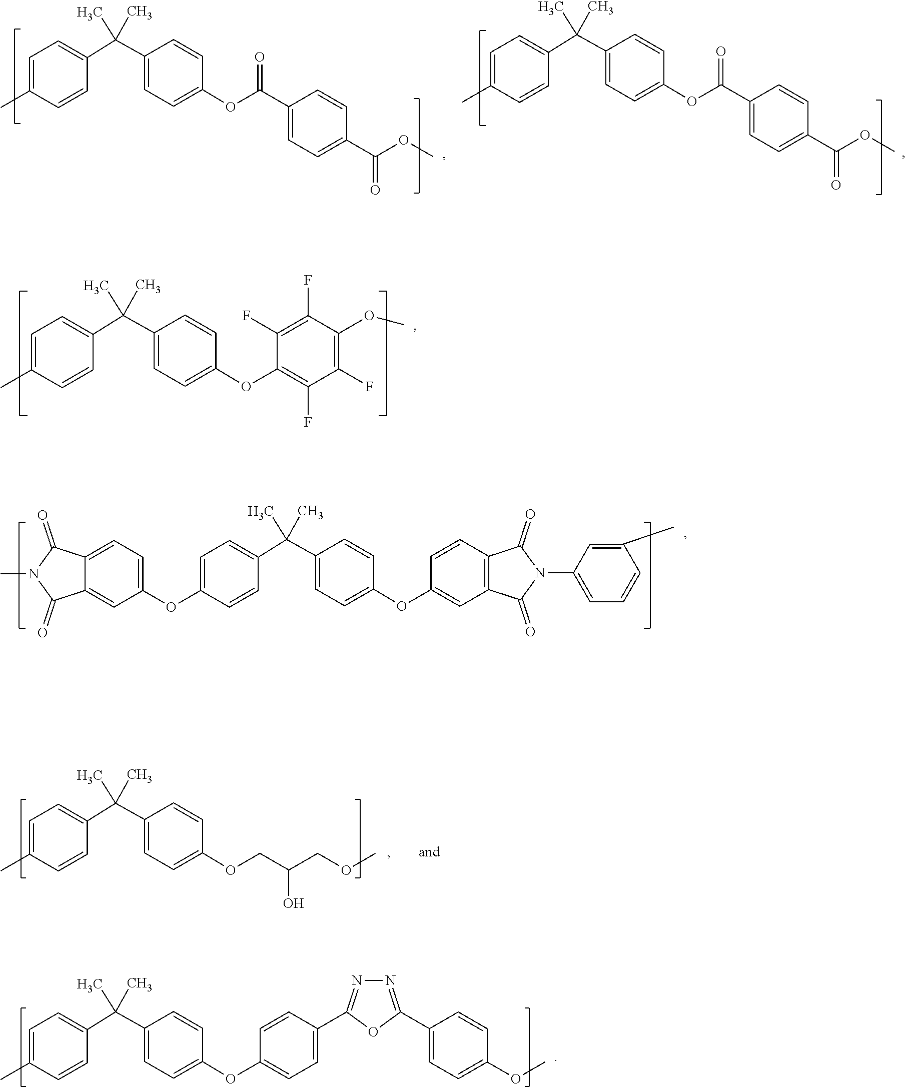

Embodiment 38. A colored dielectric polymer material according to any of embodiments 1-37, wherein the first polymer has both bis(phenylene)sulfone residues and bisphenol A residues.

Embodiment 39. A colored dielectric polymer material according to embodiment 38, wherein the first polymer has a concentration of bis(phenylene)sulfone residues of at least 5 wt %, e.g., at least 10 wt %, and a concentration of bisphenol A residues of at least 5 wt %, e.g., at least 10 wt %.

Embodiment 40. A colored dielectric polymer material according to embodiment 38, wherein the first polymer has a concentration of bis(phenylene)sulfone residues of at least 20 wt %, e.g., at least 35 wt %, and a concentration of bisphenol A residues of at least 20 wt %, e.g., at least 35 wt %.

Embodiment 41. A colored dielectric polymer according to any of embodiments 1-40, wherein the first polymer has a structural formula

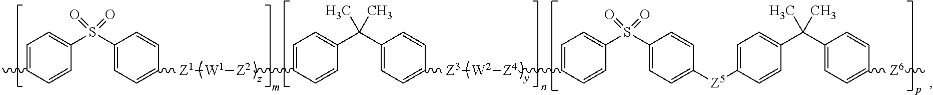

wherein
z is 0 or 1;
each W¹ is independently —Ar[—Y—Ar]_{q}—, wherein:
Ar, at each occurrence, is independently a divalent C₆₋₁₈ arylene group;
Y, at each occurrence, is independently selected from the group consisting of —O—, —S—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
q is selected from the group consisting of 0, 1, 2, 3, 4, 5, 6, 7, 8, 9 and 10; and
each Z¹ and Z² is independently selected from the group consisting of —O—, —S—, —Se—, —NR⁴—, —CH₂—O—, —O—CH₂—, —C(O)O—, —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl, provided that W¹ is not a bisphenol A residue;
y is 0 or 1;
each W² is independently —Ar[—Y—Ar]_{q}—, wherein:
Ar, at each occurrence, is independently a divalent C₆₋₁₈ arylene group;
Y, at each occurrence, is independently selected from the group consisting of —O—, —S—, —S(O)₂—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
q is selected from the group consisting of 0, 1, 2, 3, 4, 5, 6, 7, 8, 9 and 10; and
each Z³ and Z⁴ is independently selected from the group consisting of —O—, —S—, —Se—, —NR⁴— —C(O)O— —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl,
each Z⁵ and Z⁶ is independently selected from the group consisting of —O—, —S—, —Se—, —NR⁴— —C(O)O— —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl,
wherein the first polymer has a weight-average molecular weight (M_{w}) ranging from about 1,000 to about 200,000.

Embodiment 42. A colored dielectric polymer material according to embodiment 41, wherein m+n+p=1.

Embodiment 43. A colored dielectric polymer material according to any of embodiments 1-42, having repeating units of structural formula (IV):

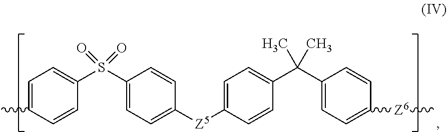

in which each Z⁵ and Z⁶ is independently selected from the group consisting of —O—, —S—, —Se—, —NR⁴—, —C(O)O—, —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR⁵—Si(R⁶)₂—CHR⁵CHR⁵—O—, wherein a is 1-5 and each R⁴, R⁵, and R⁶ is independently H or methyl.

Embodiment 44. A colored dielectric polymer material according to any of embodiments 41-43, wherein each Z⁵ and Z⁶ is 0.

Embodiment 45. A colored dielectric polymer according to any of embodiments 1 and 38-44, wherein the first polymer includes a repeating unit selected from

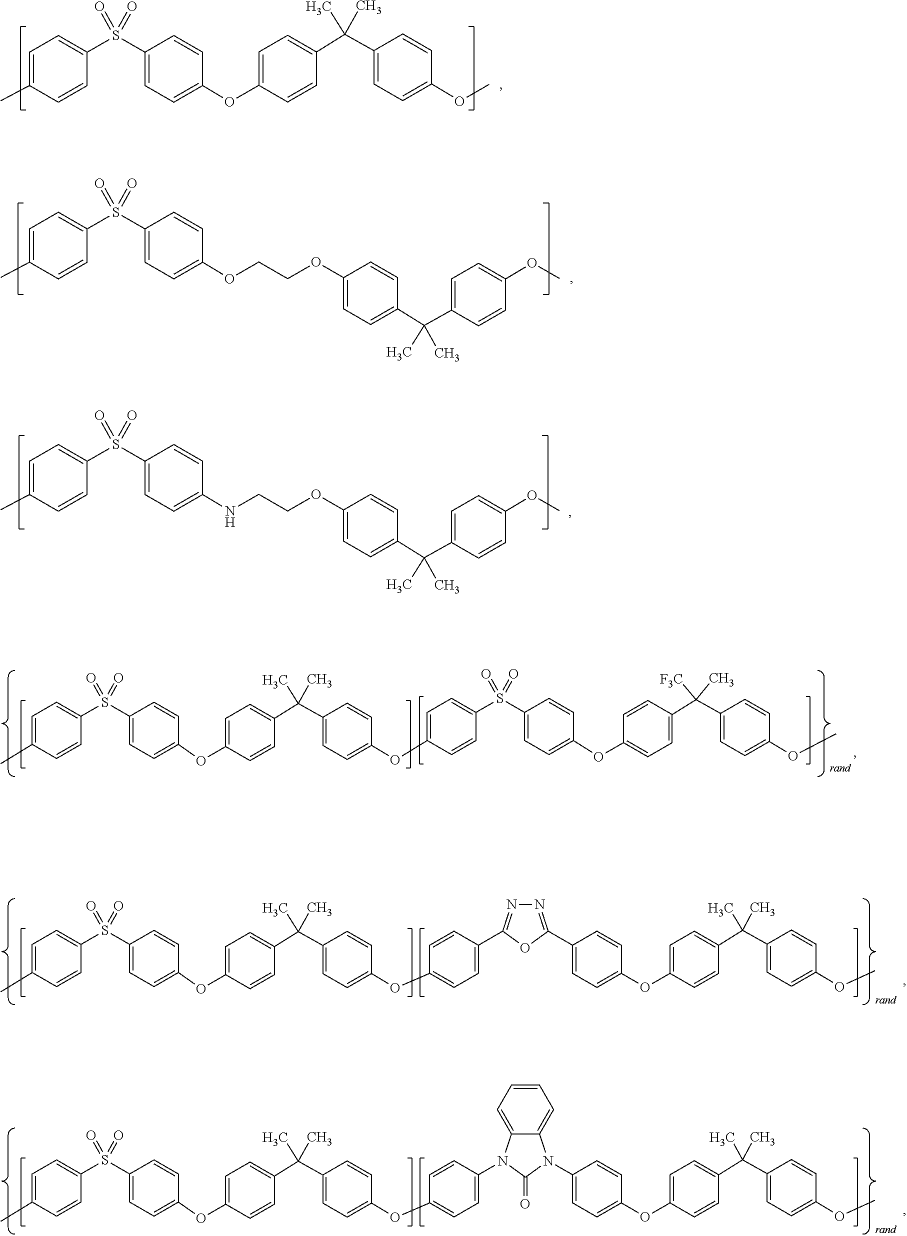

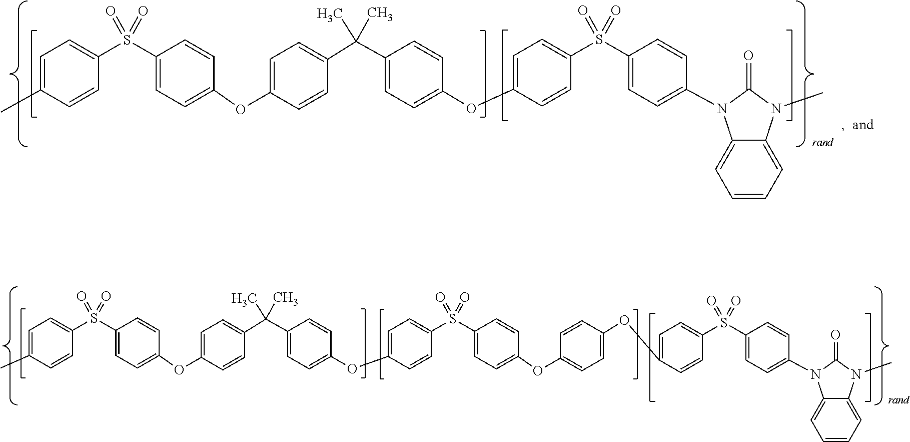

Embodiment 46. A colored dielectric polymer material according to any of embodiments 1-45, wherein the crosslinkable composition includes a polyfunctional crosslinker, e.g., selected from polyfunctional (meth)acrylates, polyfunctional maleimides and polyfunctional epoxides.

Embodiment 47. A colored dielectric polymer material according to any of embodiments 1-45, wherein the crosslinkable composition includes a polyfunctional epoxide.

Embodiment 48. A colored dielectric polymer material according to any of embodiments 1-45, wherein the crosslinkable composition includes a polyfunctional (meth)acrylate, e.g., a polyfunctional acrylate.

Embodiment 49. A colored dielectric polymer material according to any of embodiments 1-45, wherein the crosslinkable composition includes a polyfunctional maleimide.

Embodiment 50. A colored dielectric polymer material according to any of embodiments 1-49, wherein the crosslinkable composition includes a photoinitiator.

Embodiment 51. A colored dielectric polymer material according to any of embodiments 1-50, wherein the crosslinked polymer has a dielectric constant in the range of 2 to 8 (e.g., in the range of 2 to 7, or 2 to 6, or 2 to 5, or 2.5 to 8, or 2.5 to 7, or 2.5 to 6, or 2.5 to 5, or 3 to 8, or 3 to 7, or 3 to 6, or 3 to 5), at 1 MHz.

Embodiment 52. The colored dielectric polymer material of any of embodiments 1-51, wherein the dye comprises one or more dyes selected from perylene diimide dyes, naphthalene diimide dyes, naphthalene monoimide dyes, perylene dyes, anthraquinone dyes, quinone dyes, phenazine dyes, azo dyes, triarylmethane dyes, transition metal coordination complex dyes, cyanine dyes, phenoxazine dyes, indole dyes, xanthene dyes, coumarin dyes, nitro dyes, indene dyes, porphyrin dyes, phthalocyanine dyes, and metal complex dyes.

Embodiment 53. The colored dielectric polymer material of any of embodiments 1-52, wherein the dye comprises an ionic dye, for example, wherein the ionic dye is Dye 757, Dye-6G, or Dye Bu26.

Embodiment 54. The colored dielectric polymer material of any of embodiments 1-53, wherein the dye is present in the colored dielectric polymer material in an amount of at least 1 wt %, e.g., at least 3 wt %, at least 10 wt %, or at least 50 wt %.

Embodiment 55. The colored dielectric polymer material of any of embodiments 1-53, wherein the dye is present in the colored dielectric polymer material in an amount in the range of 1-80 wt % e.g., 1-80 wt %, or 1-50 wt %, or 1-20 wt %, or 3-80 wt %, or 3-50 wt %, or 3-20 wt %, or 3-10 wt %, or 5-80 wt %, or 5-50 wt %, or 5-30 wt %, or 5-20 wt %, or 10-80 wt %, or 10-50 wt %, or 20-80 wt %, or 20-50 wt %.

Embodiment 56. The colored dielectric polymer material of any of embodiments 1-55, wherein the material is provided as a body (e.g., a film) having a transmittance maximum of at least 50% (e.g., at least 75%, at least 90%) at one or more wavelengths in the range of 380-450 nm (violet); 450-495 nm (blue); 495-570 nm (green); 570-590 nm (yellow); 590-620 nm (orange); or 620-750 nm (red).

Embodiment 57. The colored dielectric polymer material of embodiment 56, wherein the body has a transmittance minimum of no more than 20% (e.g., no more than 10%, or no more than 5%) at one or more wavelengths in the range of 380-450 nm (violet); 450-495 nm (blue); 495-570 nm (green); 570-590 nm (yellow); 590-620 nm (orange); or 620-750 nm (red).

Embodiment 58. The colored dielectric polymer material of any of embodiments 1-57, wherein the material is provided as a body (e.g., a film) having a total transmittance of light in wavelength range 380-750 nm of no more than 20%, for example, no more than 10%, no more than 5%, or even no more than 1%.

Embodiment 59. The colored dielectric polymer material of any of embodiments 55-57, wherein the body is no more than 1 mm in thickness, e.g., no more than 100 microns, no more than 50 microns, or even no more than 10 microns in thickness.

Embodiment 60. The colored dielectric polymer material of any of embodiments 55-57, wherein the body has a thickness in the range of 0.05-100 microns, e.g., 0.05-50 microns, or 0.05-10 microns, or 0.05-5 microns, or 0.05-2 microns, or 0.05-1 micron, or 0.1-100 microns, or 0.1-50 microns, or 0.1-10 microns, or 0.1-5 microns, or 0.1-2 microns, or 0.1-1 micron, or 0.2-100 microns, or 0.2-50 microns, or 0.2-10 microns, or 0.2-5 microns, or 0.2-2 microns, or 0.2-1 micron.

Embodiment 61. The colored dielectric polymer material of any of embodiments 1-60, wherein the dye has a molar absorptivity of at least 8,000 M⁻¹cm⁻¹ at least one wavelength within the 380-750 nm wavelength range.

Embodiment 62. The colored dielectric polymer material of any of embodiments 1-61, wherein the material does not comprise a pigment.

Embodiment 63. The colored dielectric polymer material of any of embodiments 1-62, having a dielectric constant of 6 or less, e.g., 5 or less, or 4 or less, or 3 or less.

Embodiment 64. The colored dielectric polymer material of any of embodiments 1-63, having a dielectric constant in the range of 2-6, e.g., 2-5, or 2-4, or 2-3 at 1 MHz.

Embodiment 65. The colored dielectric polymer material of any of embodiments 1-64, wherein the colored dielectric polymer material has a dielectric strength (breakdown field) no less than 1 MV/cm (e.g., at least 1 MV/cm, or 1.5 MV/cm, or 2 MV/cm, or 2.5 MV/cm, or 3 MV/cm).

Embodiment 66. The colored dielectric polymer material of any of embodiments 1-65, in the form of a film having a thickness of no more than 4 μm (e.g., no more than 3.5 μm, or no more than 3 μm, or no more than 2.5 μm, or no more than 2 μm, or no more than 1.5 μm).

Embodiment 67. The colored dielectric polymer material of any of embodiments 1-66, in the form of a film having a thickness of at least 50 nm (e.g., at least 100 nm, at least 200 nm, or at least 500 nm).

Embodiment 68. The colored dielectric polymer material of any of embodiments 1-67, in the form of a film having a thickness in the range of 0.05-100 microns, e.g., 0.05-50 microns, or 0.05-10 microns, or 0.05-5 microns, or 0.05-2 microns, or 0.05-1 micron, or 0.1-100 microns, or 0.1-50 microns, or 0.1-10 microns, or 0.1-5 microns, or 0.1-2 microns, or 0.1-1 micron, or 0.2-100 microns, or 0.2-50 microns, or 0.2-10 microns, or 0.2-5 microns, or 0.2-2 microns, or 0.2-1 micron.

Embodiment 69. A colored dielectric polymer material according to any of embodiments 1-68, wherein the crosslinked polymer has a leakage current density of no more than 1×10⁻⁸ A/cm² at an electric field of 1.0 MV/cm.

Embodiment 70. A device comprising a film of the colored dielectric polymer material of any of embodiments 1-69, optionally in contact with a transparent conducting oxide film.

Embodiment 71. The device of embodiment 70, wherein the colored dielectric polymer material is present as a film having a thickness of no more than 4 μm (e.g., no more than 3.5 μm, or no more than 3 μm, or no more than 2.5 μm, or no more than 2 μm, or no more than 1.5 μm).

Embodiment 72. The device of embodiment 69 or embodiment 71, wherein the colored dielectric polymer material is present as a film having a thickness of at least 50 nm (e.g., at least 100 nm, or at least 200 nm, or at least 500 nm).

Embodiment 73. The device of any of embodiments 70-72, wherein the film of the colored dielectric polymer material is prepared through spin-coating, slit-coating, slot-die, or blade coating followed by crosslinking with radiation or thermal exposure.

Embodiment 74. The device of any of embodiments 70-73, wherein the transparent conducting oxide electrode is deposited on the colored dielectric polymer material film through spluttering followed by annealing.

Embodiment 75. The device of embodiment 74, wherein the maximum transmittance of the colored dielectric polymer material after sputtering and annealing is within 20% of the maximum transmittance prior to sputtering and annealing.

Embodiment 76. The device of any of embodiments 70-75, in the form of a liquid crystal cell, the liquid crystal cell comprising:
a first cell plate having a top surface, the first cell plate comprising
a first transparent substrate,
disposed on the first transparent substrate, the colored dielectric polymer material; and
disposed on the colored dielectric polymer material, a first transparent conducting oxide film, the transparent conducing oxide being within 100 nm of the top surface of the first cell plate;
a second cell plate having a top surface, the second cell plate comprising
a second transparent substrate,
disposed on the second transparent substrate, a second transparent conducting oxide film, the transparent conducing oxide being within 100 nm of the top surface of the second cell plate;
one or more spacers disposed between the top surface of the first cell plate and the top surface of the second cell plate, the one or more spacers defining lateral edges of the liquid crystal cell; and
a liquid crystal material disposed in a volume defined by the top surface of the first cell plate, the top surface of the second cell plate, and the one or more spacers.

Embodiment 77. The device of any of embodiments 70-75, in the form of a device configured to provide colored light, the device comprising the colored dielectric polymer material operatively coupled to a light source, configured to filter light emanating from the light source in a display direction.

Embodiment 78. A method of making a device according of any of embodiments 70-77, comprising:
forming a film of the colored dielectric polymer material;
depositing a transparent conducting oxide electrode adjacent the film through sputtering; and
annealing at a temperature of at least 200° C. for a time of at least 10 minutes (e.g., up to 24 hours).

1. A colored dielectric polymer material comprising a crosslinked polymer and a dye dispersed in the crosslinked polymer, wherein the crosslinked polymer comprises a crosslinking product of crosslinkable composition including a first polymer having bis(phenylene)sulfone residues and/or bisphenol A residues.

2. The colored dielectric polymer material according to claim 1, wherein the first polymer has a concentration of bis(phenylene)sulfone residues of at least 5 wt %.

3. The colored dielectric polymer material according to claim 2, wherein the first polymer has a weight-average molecular weight (M_{w}) ranging from about 1,000 g/mol to about 200,000 g/mol.

4. The colored dielectric polymer material according to claim 2, wherein the first polymer has repeating units of structural formula 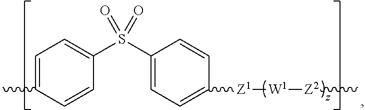
wherein
z is 0 or 1;
each W¹ is independently —Ar[—Y—Ar]_{q}—, wherein:
Ar, at each occurrence, is independently a divalent C₆₋₁₈ arylene group;
Y, at each occurrence, is independently selected from the group consisting of —O—, —S—, —(CR¹R²)ᵣ—, —NR³—, —C(O)—, and a covalent bond, wherein R¹ and R², at each occurrence, independently is selected from the group consisting of H, a halogen, CN, a C₁₋₁₀ alkyl group, and a C₁₋₁₀ haloalkyl group; each R³ is selected from the group consisting of H, a C₁₋₁₀ alkyl group, and a C₁₋₁₀ haloalkyl group and each r is selected from the group consisting of 1, 2, 3, 4, 5, 6, 7, 8, 9 and 10;
q is selected from the group consisting of 0, 1, 2, 3, 4, 5, 6, 7, 8, 9 and 10; and
each Z¹ and Z² is independently selected from the group consisting of —O—, —S—, —Se—;
—C(O)O—, —OC(O)—, NR⁴—C(O)—, —C(O)—NR⁴—, O—(CHR⁵CHR⁵—O)ₐ—, —OCH₂CH(OH)CH₂—O—, and —O—CHR⁵CHR₅—Si(R⁶)₂—CHR⁵CHR⁵—O—, wherein a is 1-5 and each R⁴, R⁵, and R⁶ is independently H or methyl; or
when z is 0, Z¹ is 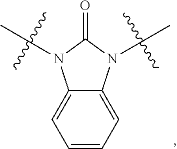 [SMILES: *n1c(=O)n(*)c2ccccc21]
wherein the first polymer has a weight-average molecular weight (M_{w}) ranging from about 1,000 to about 200,000.

5. The colored dielectric polymer according to claim 1, wherein the first polymer includes a repeating unit selected from

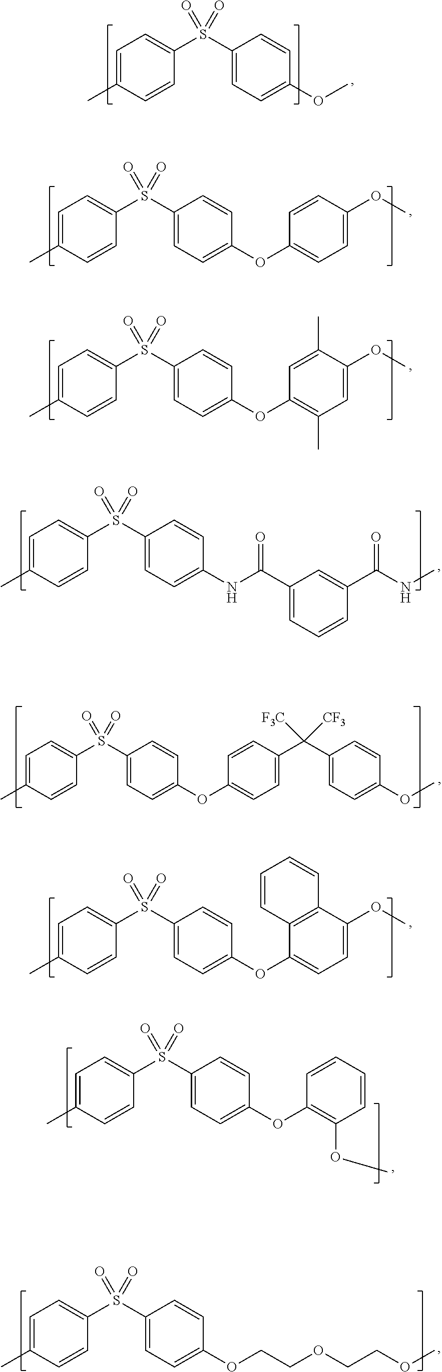

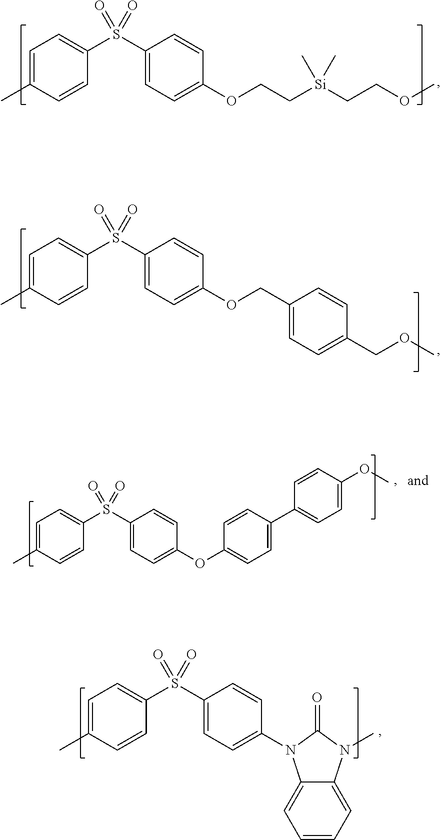

6. The colored dielectric polymer material according to claim 1, wherein the first polymer has a concentration of bisphenol A residues of at least 5 wt %.

7. The colored dielectric polymer according to claim 1, wherein the first polymer includes a repeating unit selected from

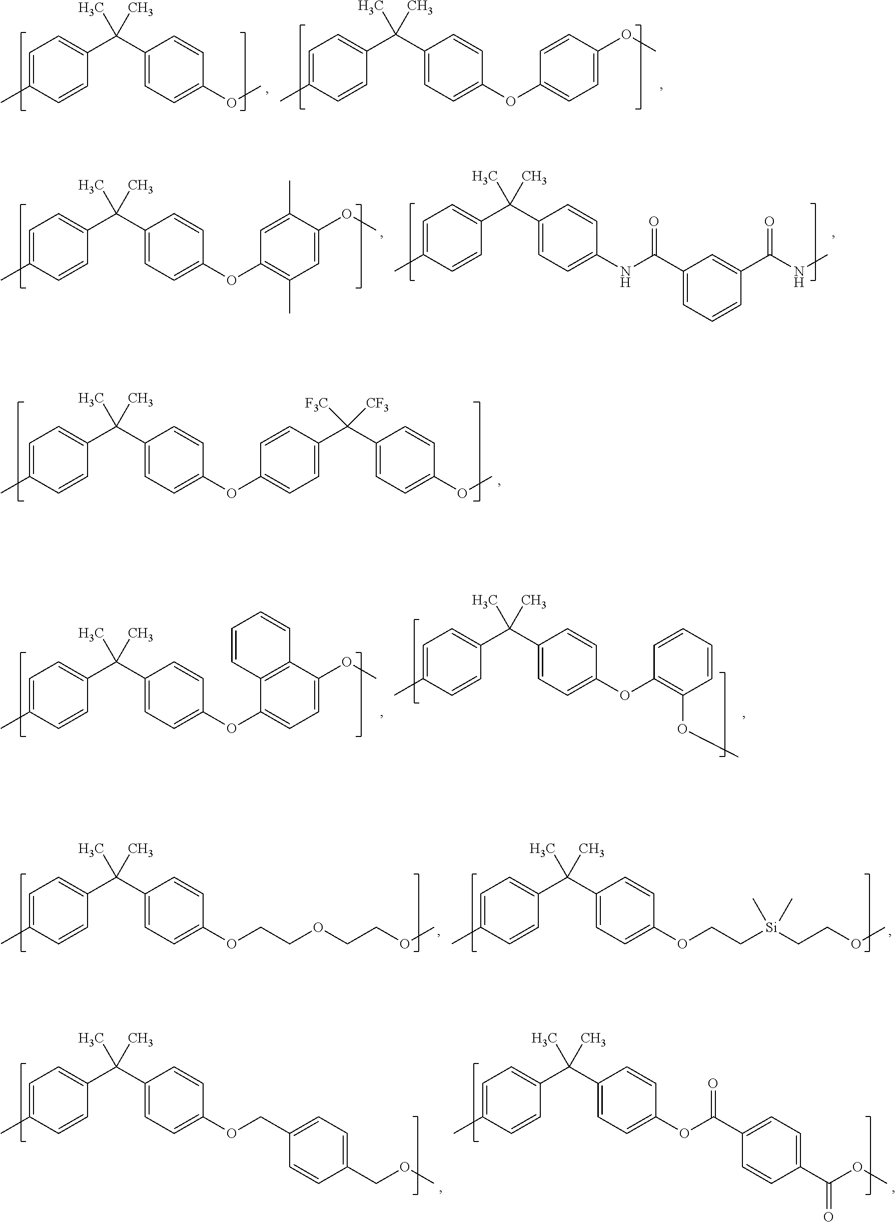

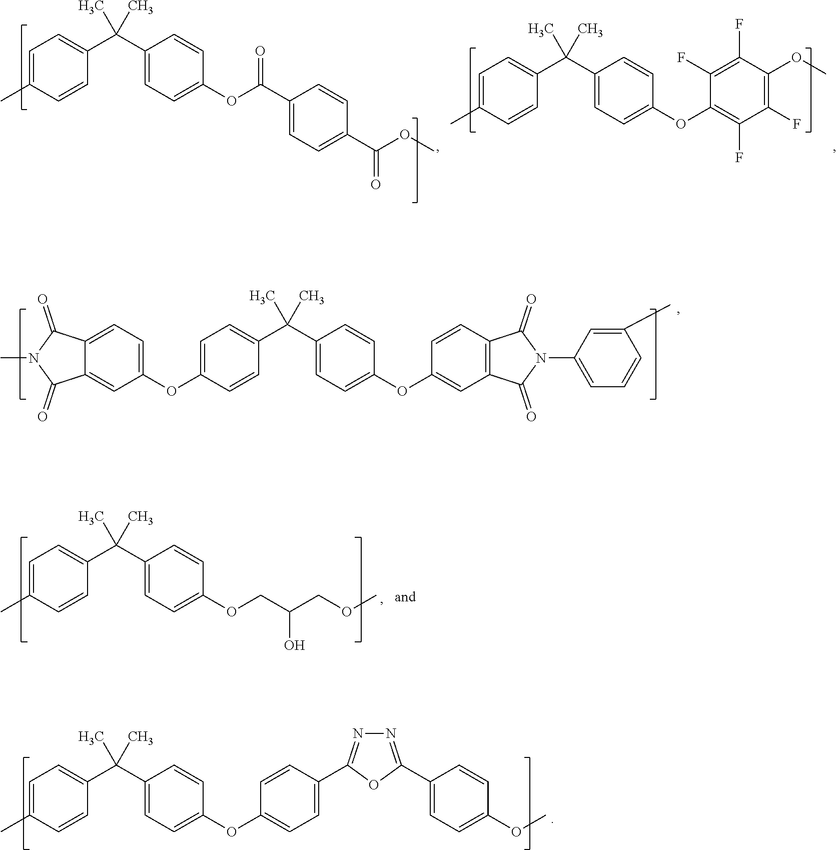

8. The colored dielectric polymer material according to claim 7, wherein the first polymer has a concentration of bis(phenylene)sulfone residues of at least 5 wt %, and a concentration of bisphenol A residues of at least 5 wt %.

9. The colored dielectric polymer according to claim 1, wherein the first polymer includes a repeating unit selected from

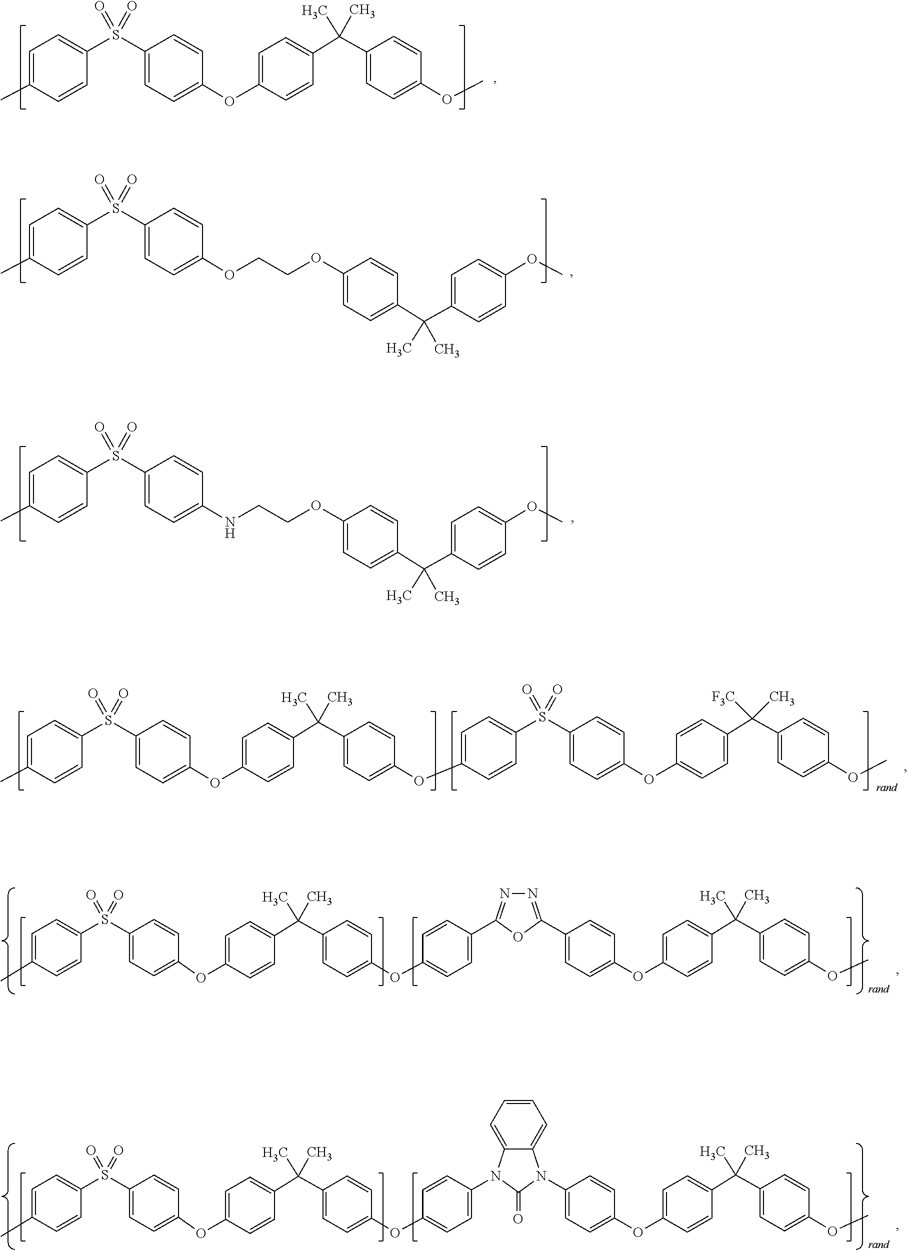

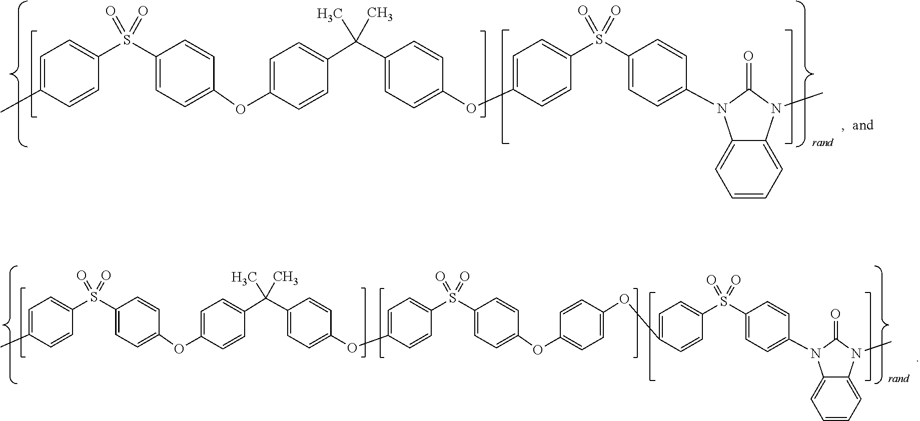

10. The colored dielectric polymer material according to claim 1, wherein the crosslinkable composition includes a polyfunctional crosslinker selected from polyfunctional (meth)acrylates, polyfunctional maleimides and polyfunctional epoxides.

11. The colored dielectric polymer material according to claim 1, wherein the crosslinkable composition includes a photoinitiator.

12. The colored dielectric polymer material according to claim 1, wherein the crosslinked polymer has a dielectric constant in the range of 2 to 8 at 1 MHz.

13. The colored dielectric polymer material of claim 1, wherein the dye comprises one or more dyes selected from perylene diimide dyes, naphthalene diimide dyes, naphthalene monoimide dyes, perylene dyes, anthraquinone dyes, quinone dyes, phenazine dyes, azo dyes, triarylmethane dyes, transition metal coordination complex dyes, cyanine dyes, phenoxazine dyes, indole dyes, xanthene dyes, coumarin dyes, nitro dyes, indene dyes, porphyrin dyes, phthalocyanine dyes, and metal complex dyes.

14. The colored dielectric polymer material of claim 1, wherein the dye comprises an ionic dye, for example, wherein the ionic dye is Dye 757, Dye-6G, or Dye Bu26.

15. The colored dielectric polymer material of claim 1, wherein the dye is present in the colored dielectric polymer material in an amount of at least 1 wt %.

16. The colored dielectric polymer material of claim 1, wherein the material is provided as a body having a transmittance maximum of at least 50% at one or more wavelengths in the range of 380-450 nm (violet); 450-495 nm (blue); 495-570 nm (green); 570-590 nm (yellow); 590-620 nm (orange); or 620-750 nm (red).

17. The colored dielectric polymer material of claim 16, wherein the body has a transmittance minimum of no more than 20% at one or more wavelengths in the range of 380-450 nm (violet); 450-495 nm (blue); 495-570 nm (green); 570-590 nm (yellow); 590-620 nm (orange); or 620-750 nm (red).

18. The colored dielectric polymer material of claim 1, wherein the dye has a molar absorptivity of at least 8,000 M⁻¹ cm⁻¹ at least one wavelength within the 380-750 nm wavelength range.

19. The colored dielectric polymer material of claim 1, wherein the colored dielectric polymer material has a dielectric strength (breakdown field) no less than 1 MV/cm.

20. The colored dielectric polymer material of claim 1, in the form of a film having a thickness of no more than 4 μm.

21. A device comprising a film of the colored dielectric polymer material of claim 1.

22. The device of claim 21, wherein the maximum transmittance of the colored dielectric polymer material after sputtering and annealing is within 20% of the maximum transmittance prior to sputtering and annealing.

23. The device of claim 21, in the form of a liquid crystal cell, the liquid crystal cell comprising:
a first cell plate having a top surface, the first cell plate comprising a first transparent substrate,
disposed on the first transparent substrate, the colored dielectric polymer material; and
disposed on the colored dielectric polymer material, a first transparent conducting oxide film, the transparent conducing oxide being within 100 nm of the top surface of the first cell plate;
a second cell plate having a top surface, the second cell plate comprising
a second transparent substrate,
disposed on the second transparent substrate, a second transparent conducting oxide film, the transparent conducing oxide being within 100 nm of the top surface of the second cell plate;
one or more spacers disposed between the top surface of the first cell plate and the top surface of the second cell plate, the one or more spacers defining lateral edges of the liquid crystal cell; and
a liquid crystal material disposed in a volume defined by the top surface of the first cell plate, the top surface of the second cell plate, and the one or more spacers.
